(19) United States
(12) Patent Application Publication
(10) Pub. No.: US 2011/0010352 A1
(43) Pub. Date: Jan. 13, 2011

(54) METHOD AND SYSTEM OF PROVIDING SEARCH TOOLS

(75) Inventors: Jeffrey JOCKISCH, Westfield, IN (US); Joshua James Hudson, Carmel, IN (US); Scott A. Jones, Carmel, IN (US)

Correspondence Address: Staas & Halsey LLP, 1201 New York Ave N.W. Suite 700, Washington, DC, 20005, US

(73) Assignee: ChaCha Search, Inc., Carmel, IN (US)

(21) Appl. No.: 12/831,598

(22) Filed: Jul. 7, 2010

Related U.S. Application Data
(60) Provisional application No. 61/223,642, filed on Jul. 7, 2009.
(60) Provisional application No. 61/231,593, filed on Aug. 5, 2009.

(51) Int. Cl. G06F 17/30

(52) U.S. Cl. 707/706; 707/740; 707/748; 707/E17.014; 707/E17.108

(57) ABSTRACT

A system and method of providing information to improve efficiency of human searchers obtaining information on behalf of users is described. A set of resources and tools which is optimized to locate a search result is described. Custom search tools, custom rendering, multiple query submission, and caching of results are used to assist a guide. A system and method of selecting an offer and delivering the offer to a user along with a verification code is provided.

### CROSS-REFERENCE TO RELATED APPLICATIONS

This disclosure is related to and claims the benefit of U.S. patent application Ser. No. 12/275,864, inventor Scott A. Jones, et. al., entitled “METHOD AND SYSTEM FOR IMPROVING UTILIZATION OF HUMAN SEARCHERS”, filed Nov. 21, 2008, U.S. patent application Ser. No. 12/568,293, inventor Thomas E. Cooper, entitled “METHOD AND SYSTEM FOR MANAGING USER INTERACTION”, filed Sep. 28, 2009, and claims priority to U.S. Provisional Application Ser. No. 61/223,642, inventor Jeff Jockisch, et. al., entitled “METHOD AND SYSTEM OF PROVIDING SEARCH TOOLS”, filed Jul. 7, 2009, and U.S. Provisional Application Ser. No. 61/231,593, inventor Scott A. Jones, entitled “METHOD AND SYSTEM OF PROVIDING COUPON SERVICES”, filed Aug. 5, 2009, the contents of all which are incorporated herein by reference in their entirety.

### BACKGROUND

1. Field of the Invention

Various embodiments described herein relate to search engine technologies and more specifically to human-assisted search engines. A method and system of providing tool(s) for human searcher(s) is described.

2. Description of the Related Art

Search systems have traditionally been built around a user seeking information on behalf of the user. For this reason, the user interfaces and tools have been designed to use a single landing page on a browser which may allow a user to enter a generalized query which may produce a good result, as described by Sergey Brin and Lawrence Page in The Anatomy of a Large-Scale Hypertextual Web Search Engine'. Such a system has been found to be suitable for a typical user and has enjoyed significant commercial success for companies such as Google® and Yahoo!®.

Human-powered search engines have gained acceptance in situations in which a user may have limited user interface, limited experience, and/or limited time. In particular SMS based search has found application in the mobile search environment. Many users have adopted services such as the ChaCha® mobile search service due to features such as a natural language interface and commonality of devices which can use the service. Likewise, chat interfaces have become a common method for customer service with companies such as AT&T, etc.

However, in a system wherein a searcher is seeking information on behalf of a user, the conventional search experience may be inefficient. In particular, a guide or human searcher who is seeking information on behalf of a user would prefer to be able to locate the needed information more rapidly. This is particularly difficult when using a conventional interface, as each link activated may open a new tab in a browser, which may cause information relevant to a user query to be lost or obscured. Further, a guide may determine that a different query than that provided by a user is likely to produce a result, which requires cutting and pasting parts of a query into a search box in another browser tab. Context information which may be valuable in interpreting a request is not available when a guide is searching using conventional search tools, which may cause a loss of speed and/or accuracy. A guide may be tasked with seeking a precise or direct answer to a request, which may require significant searching within a resource and/or web page, again resulting in lost time as text or other elements of an answer are pasted, cut and otherwise manipulated in order to present an answer. While making available a set of resources, which are associated or linked with a category of a query, may improve speed and quality of answers, if a query is not correctly categorized, a guide may lose time correcting the categorization and resubmitting the query to resources associated with the correct categorization.

The longer it takes a guide to obtain a result, the more frustrating the guide task may be, and the lower the net earnings rate for the guide when paid on a task basis. This may cause high turnover and low morale for a guide, as well as a loss of answer quality. A guide will try to select a first answer available, which may not be reliable or the best answer. Response time is reflected in user perception of the search service, so a shorter search time will produce a more positive image.

For these and other reasons, a set of tools for improving performance of a search activity conducted on behalf of a user would be greatly appreciated.

### SUMMARY

A system and method of processing information in relation to a request are provided herein. The method includes receiving the request, providing a search tool associated with a category of the request to a human searcher registered for the category, performing a search using a resource selected for the category responsive to activation of the search tool, and automatically formatting a response chosen by the human searcher.

A system and method of selecting an offer and delivering the offer to a user are provided herein. The method includes distributing information of the offer to a business and verifying a user with respect to the offer.

Additional aspects and/or advantages will be set forth in part in the description which follows and, in part, will be apparent from the description, or may be learned by practice of the invention.

These together with other aspects and advantages which will be subsequently apparent, reside in the details of construction and operation as more fully hereinafter described, reference being had to the accompanying drawings forming a part hereof, wherein like numerals refer to like parts throughout.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database record for a category.

FIG. 3 illustrates a database record for a request.

FIG. 4 illustrates a database record for a guide.

FIG. 5 illustrates a database record for a user.

FIG. 6 illustrates a database record for a profile.

FIG. 7 is flowchart of processing a request from a system perspective.

FIG. 8 is a flowchart of processing a request by a search server.

FIG. 9A is a flowchart of processing a request from a searcher system perspective.

FIG. 9B is a flowchart of providing search tools from a search tool server perspective.

FIG. 10 illustrates a graphical user interface (GUI) for processing a request associated with a category.

FIG. 11 illustrates a GUI for re-categorizing a request.

FIG. 12 illustrates a GUI for processing a request associated with a modified category.

FIG. 13 illustrates a GUI for processing a request using an alternate search engine.

FIG. 14 illustrates a GUI for processing a request using a mapping interface.

FIG. 15 illustrates a GUI for processing a request using a default display criteria.

FIG. 16 illustrates a GUI for processing a request using a modified display criteria.

FIG. 17 illustrates a GUI for a guide initiating a search.

FIG. 18 illustrates a GUI for reviewing search results.

FIG. 19 illustrates a GUI for selecting a search result.

FIG. 20 illustrates a GUI for formatting a search result.

FIGS. 21A and 21B illustrate messaging for guide(s).

FIG. 22 is a block diagram of an exemplary system embodiment.

FIG. 23 is a block diagram of an exemplary coupon printing device.

FIG. 24 illustrates a database for a user.

FIG. 25 illustrates a database for an advertiser.

FIG. 26 illustrates a database for an advertisement.

FIG. 27 illustrates a database for a coupon device.

FIG. 28 is a flowchart of delivering an electronic coupon.

FIG. 29 is a flowchart of delivering a printed coupon responsive to a request.

FIG. 30 illustrates an exemplary sequence of messages and transactions.

FIG. 31 illustrates a product description of a GSM control terminal in an embodiment of a coupon printing device.

FIG. 32 illustrates a product specification of a GSM control terminal in an embodiment of a coupon printing device.

FIG. 33 illustrates a product description of a printer component in an embodiment of a coupon printing device.

FIG. 34 illustrates a product specification of a printer component in an embodiment of a coupon printing device.

### DETAILED DESCRIPTION OF THE PREFERRED EMBODIMENTS

Reference will now be made in detail to the present embodiments discussed herein, examples of which are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein words importing the singular shall include the plural and vice versa unless specifically counter indicated.

A system is provided whereby a query may be submitted to a search service by a user and a response provided. A query may be initially processed automatically. If a response or search result can not be provided automatically, a query or request may be processed with the aide of a human assistant or guide. A query may be modified to be associated with a standardized or succinct query. A query may be associated with information such as a category, location, user characteristics, etc. which may be used to provide information to a searcher. If a search result is not found based on a processing of the query by the guide, information of the processed query is provided to a searcher. The searcher may be selected based on information associated with the processed query.

A search tool set provided to a selected searcher may include an extension which assists in searching of content and transcribing a search result. A search tool set may include controls for providing rapid submission of elements of a query to search engines. A search tool set may include links to a plurality of resources associated with information such as a category, location, profile, etc., and a control for modifying any of that information and resubmitting a query based on the modification. A search tool set may provide user history and formatting assistance in order that a response or result may be delivered to a user with reduced effort by a searcher. A search tool server system may be provided which delivers content of the search tools to a guide system.

A system is provided which allows a user to submit a query to a search system and receive a response. A search system server analyzes a request or query to determine if a matching query exists in a database of previous queries. If a matching query is found, the query and/or an answer associated with the query may be provided to a user. If a matching query is not located, a vetting process may be applied to a query, which may include categorization, modification of the content of a query, association with a location, and/or other information, and other forms of processing. A vetting process may be performed automatically and/or using the assistance of a number of guide(s). In at least one embodiment, a matching operation may be performed on a processed request or ‘vetted query’ which may result in a query and/or a search result being provided to a user.

If it is determined that a guide is needed to perform a search responsive to a query, a search system may notify a number of guides of the request, and may provide information of the request to a guide system which acknowledges the request. A guide may be required to be logged in to the search system in order to receive a notification. If a guide accepts a request, information of the request may be provided to the guide in a browser of a guide system.

A browser tool may be designed to minimize the need to jump between tabs, to cut and paste information, and/or to otherwise open multiple tabs within a browser. If a searcher accepts a request, relevant information associated with the request is provided in a web page to the searcher. An initial rendering of information provided to a searcher may include search resource(s) which are associated with a categorization of the query, search result(s) produced by a number of Custom Search engines associated with a category which have already been provided with content of a request, a search appliance which may allow a searcher to modify a categorization and resubmit a request, modify content of a request, and/or submit the request to any number of search engines, which may include selected search engines. Any or all of the linked pages presented may be cached and/or indexed in the search system server, and/or a guide system. If a resource or a page is selected, a guide may be directed to a number of words included in a request based on an indexing of a page. Historical query information of a user may be provided to a searcher in order that context can be inferred. Messages associated with previous queries and/or previous results may be provided within the GUI in order that a searcher may utilize text from previous queries and/or answers in a search.

As a result is associated with a source, it is beneficial that a source URL may be easily associated with a search result. As a guide navigates to a web page and selects a search result, a URL associated with the search result is tracked using an extension such as a toolbar which may record a current URL of a page being rendered. A URL associated with a search result may be automatically associated with a search result which is obtained by selecting an object from the associated resource. In some instances, a guide may be seeking a particular type of search result, such as text in the case of an SMS response, an image, audio, etc. As many websites may include graphics, images, and media of various types which are not of interest to a searcher seeking information of a specific type, some or all unwanted types of media may not be rendered in a processed page which is presented to a guide. In at least one embodiment, a pointer to a location in a cached page may be provided to the search system which may provide the URL to a user as a search result. As part of a GUI provided to a guide, information associated with a search resource may be provided. For example, if a pointer ‘hovers’ over a search resource, information regarding use of a search resource may be provided.

A searcher may be provided with a capability to pass a search query directly to a search resource from the search tool. For example, if a searcher determines that location is relevant to a query, the guide may pass the query and location information of a query to a location-based search tool. Similarly, a guide may select and/or augment elements of a query, which may be provided in a search tool. For example, if a resource does not accept natural language queries, a searcher may select one or more keywords of a query which may be passed to a search resource with a single action. This may reduce a number of actions required to obtain a result. A library of interfaces may be maintained which is associated with search resources provided to guides in order that this functionality may be provided.

A system is provided whereby a human searcher or “guide” may more efficiently locate a search result. A request is received by a search system, which may determine whether a guide is required to perform an information search responsive to the request. Information may be associated with a request by a search system using automated and/or human assisted methods. Guides registered with a search service are ranked based at least in part on information associated with a request, and a highest ranked guide is notified of the request. In addition to receiving a request, a selected guide is provided with search resources which may be used to locate a search result.

A guide may be provided with query selection controls that allow the guide to select elements of a request which may be submitted to a resource without activation of a triggering control. A guide may add or remove elements of a query using simple motions or commands such as a mouse click. Elements of a query may be obtained from sources such as a location indicator, a historical request and result indicator, a profile indicator, and other information associated with a request. In at least one embodiment, a persistent window of previous queries and answers associated with a user associated with a request is provided to a guide.

A guide may be provided with a geographic search option. For example, a named entity in an historical request may be transferred to a query field which activates a mapping function to allow a guide who may have relevant domain expertise to rapidly obtain context from previous requests.

A guide may be provided with assistance regarding a search resource. For example, if a new search resource has been added, a descriptive help text may be provided to a guide when a search resource is selected and/or pointed at by the guide. Such a facility may be provided by a search system in order to minimize time required to determine if a resource is valuable for a particular request. Items such as a type of format that a search resource or resource accepts such as Boolean, structures, natural language, etc., may be described in order that a searcher unfamiliar with the resource may utilize the resource efficiently.

A guide may be provided with a customized rendering of a search resource. For example, a web page returned by a search resource may be received by a server associated with a search tool and may be modified in order to assist a guide in locating a search result more rapidly. A search tool system may suppress items such as graphics, sponsored results, banners, etc., which may be a distraction to a guide. A resource may be presented in a pre-processed manner. For example, a search for keywords of a query might be performed on a web page, and highlighting or other forms of pointing to relevant occurrences of the search targets might be provided to a guide assigned to find a text result. Resources associated with other types of media might be similarly processed to assist a guide in locating a search result. For example, tags associated with photographs, metadata of audio and video clips, etc., might be examined and filtering applied.

A guide may be provided with the ability to automatically include information of a resource used to obtain a search result with the result. It is often required for reasons of attribution, business reasons, credibility, quality assurance, etc., that a search result be associated with a source. As a consequence, a guide may spend precious time cutting and pasting URL's, etc., into a response. A guide tool may provide this capability by a simple action such as a ‘right click’, selection of a control in an extension, etc.

A query formulated by a guide may be passed to a resource automatically, which may allow multiple resources to be selected to process a request without requiring a guide to open each resource, enter a query, examine the results, etc. A library of formats for submitting a query may be maintained in order to support a one-click submission of a search query. A server may be provided by a search system in order to host web pages associated with guide tools. A guide tools server may execute queries based on information obtained from a guide without the need to update multiple pages displayed on a guide system. Such an embodiment may reduce the bandwidth required by a guide device for processing a query.

A system and method is provided which allows a user or InfoSeeker™, who may be any person, to submit a search request or search query or request to a search service and receive a response to the search request. A search system which allows communication to occur between a user, a searcher or guide, a resource, a search tool server and/or the search system allows queries to be processed. A database comprising information regarding a user, a guide, a resource, an advertisement, a category, a keyword, a tag, content, a request, a search method, and/or other information is provided.

A search request, submitted by a user may include a keyword, a category, a fully formed question, a statement, any type of media, implicit data such as information associated with a user identifier and/or device. A query may receive a response which is produced automatically and/or utilizing the assistance of one or more guides or providers. In at least one embodiment a request submitted by a user is compared to a database of requests in order to determine if a matching request is found in the database. If a matching request is found, a result associated with the matching request may be presented to a user responsive to the request.

If multiple search results are associated with a request, the results may be ranked to determine an order in which the result will be presented to a user. A ranking of a result may be based on any type of information associated with the result. A request is identified and may be assigned a unique identifier. Information such as a category, geographic information and/or a profile may be selected to be associated with the request. A request and/or any information associated with the request may be presented to a guide. An indicator of items such as a category, keyword, geographic information, time information, previous activities and/or other information associated with a request may be provided to a guide selected to respond to a request. A guide may be selected based on association of a guide with any or all information associated with any item which is to be processed or “reference item”. A guide may be provided with information one or more types of items, such as a category, a keyword, a tag, an advertisement, a profile, or any sort of content, which a guide may elect to associate with a request and/or to transmit to a user. An interest or keyword is any type of information which may be associated with a request and/or other information for the purposes of this disclosure. While text-based searching may use words, phrases or other text elements, other forms of information might also be utilized in a search. For example, if a request indicated visual, audio, or other types of media which may be compared to any elements of a resource, such elements or ‘atoms’ might be used individually and/or in combination to rank and/or rate an item which may be utilized to respond to the request.

A guide, who may be any person, may be associated with one or more keywords, topics or categories. A guide may be associated with any information required by a search system in order that a guide may be identified and may be associated with keywords, categories, or topics. In at least one embodiment, a guide may be required to establish a login account and/or provide information which may be used to establish communication with the guide. A guide who is associated with a category may be provided with access to a resource which may include content and/or other information which may be indexed in order that it may be searched to obtain a search result utilizing a resource. Content and/or resource indicated in a database associated with a category may be compared to keywords and/or other information associated with a request in order to rank a category which may be presented to a user and/or a guide in order to assist in obtaining a search result. Likewise, content associated with a request may be used to determine whether a matching request exists, which may be presented to a user and/or may be used to provide a result to the user.

A database of information associated with a category or topic and/or a keyword may be created using various methods. A database may be created and/or modified by a human editor or taxonomist, who may be able to create associations between categories. A database of information associated with a category may be created and/or modified based on information obtained from a database such as DMOZ, and/or any database which may include and/or indicate resources which may be included in the database. A database of information associated with a category may be created and/or modified based on information indicated in a search session log such as that described herein. A guide and/or a user may be able to associate information with a category. For example, a ‘wiki’ of any sort may be associated with a category. A guide and/or user may have various rights to add, remove, and/or review information which may be associated with a category or node defined within a database. Rights associated with a guide and/or user may be based on information associated with a guide and/or user such as rating or ranking information.

A search facility may be associated with a category. For example, a custom search engine (CSE) may be associated with a category which may be customized by a person, who may be a guide, which may be used to locate information related to the category. A search facility may be dynamically updated in order to search any or all information associated with any or all categories indicated in a database. A database may be created and/or modified which may be used to modify the performance of a custom search tool.

A user request is received and may be compared to a database of queries. If an exact match and/or an indexed exact match is identified, a result associated with the matching query may be returned to a user. If a suitable match is not identified, a guide may be selected. Any or all information associated with a query may be compared to information associated with an index. For example, keywords of a request may be compared to keywords or ‘interests’ associated with an index of categories. Likewise, geographic information associated with a request, such as an area code, zip code, street address, or GPS coordinates, etc., may be compared to a database of locations which may include names of places which are ranked according to proximity to the information. If there is not a suitable match to information associated with a query with information in a selection index, and in at least one embodiment universally, a search may be conducted of resources in order to obtain information of a keyword such as a rating or ranking and/or other information which may be associated with the index.

A “user” is any person or entity which may submit a request or search request. A “request” or “search request” or “query” is any request for information which may be originated by a person and/or a device or system. A user may be referred to as a “requester”, information seeker or InfoSeeker™.

A “guide” is any person who may be compensated and/or may be a volunteer who may respond to and/or assist with a request. An “expediter” or “ambassador” is a guide who may perform processing of a request and/or a search result. A “searcher” is a guide who may perform an information search responsive to a request. A “transcriber” who may also be a guide may convert a spoken portion of a request into text, and/or may otherwise convert information of a request from one form to another. A guide may be referred to as a “human assistant” or “human searcher” or “searcher”. As used herein a searcher or “specialist” is a guide whom may perform a search for information and return a search result. As used herein, a search result, result, response or answer may be any information which is determined to be a suitable response to a request. As used herein, a “provider” is any person and/or system which may provide a response or result. A guide may perform any type of task. Any guide may act in any defined guide role. However, a human assistant who performs a task and a guide who conducts a search may not necessarily be the same. For example, a human assistant may perform a task to facilitate a search which is conducted by another person who is registered as a guide.

An “identifier” or ID may include character, number and/or other type of information which may be used to identify an item including item of a database. Items may include but are not limited to a guide, a user, a resource, an advertisement, a keyword, a category, a search result, a search request, a query, a rating, ranking, a message and/or a profile. As used herein an “item” may be a real or virtual object which may be represented in a database. A “guided request” is a request which uses the assistance of one or more guide

A “result” or “search result” or “answer” is any information which may be provided responsive to a request. A result includes, but is not limited to, any of an advertisement, a link to a web page, a message of any sort, image, audio, text, games, interactive media and/or software of any sort.

A “search resource” or “resource” is any source of information which may be used to obtain a search result. A search resource includes automated and/or human-assisted systems, any repository of information, and any type of media and/or systems which may provide information. A resource may be a provider or source of item and/or service. For example, a resource might provide an item such as a ringtone, a media file (e.g., audio, video, images, games, etc.), information such as news, lyrics, song titles, translations or any other type of information. A resource may be automated, and/or may utilize the assistance of a person.

A “profile” is one or more characteristics which may be associated with a person. Profile characteristics include but are not limited to demographic, geographic, personality, affiliations, areas of interest, historical actions, preferences, memberships, associations, etc.

An “advertisement” is any information which may be delivered to a user including to promote a provider, a product, a service, etc. An advertisement may include text, links, audio, video, images, printed materials, interactive media such as a game, or other forms of media which may be provided to a user device.

A “category” or “taxonomy branch” or “categorization” or “class” is a unique node within an index which may be associated with any number of items. If a request is associated with a category, items associated with the category may be more likely to be selected responsive to the request. For example, a hierarchical index might include nodes associated with broad classes of information, which might be used to index search resources, advertisements, search results, guides, etc.

The terms voice and speech are used interchangeably herein. A user, a resource, and/or a guide may establish a communication session using a voice service, a messaging service such as Short Messaging Service (SMS), Enhanced Messaging Service (EMS), Multi-media Messaging Service (MMS), Instant Messaging (IM), email, an Internet portal or web page, regular mail or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session. A landline phone, a specialized communication terminal, or any other communication device might be used to establish a communication session.

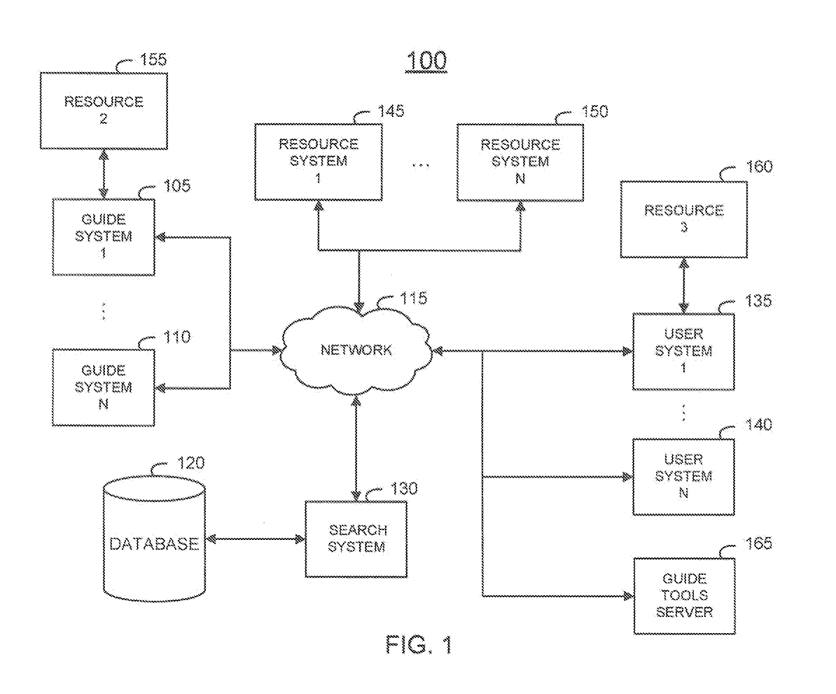

Communication between a guide, a user, a resource and/or a search system may include conversion of text to speech and speech to text. Any type of conversion and/or other processing of information which may facilitate communication between a user, a guide, a resource and/or a search system may be performed by an element of the system 100 (FIG. 1). Any type of media which can be sent and/or received using a communication system may be part of a communication session. A communication session may be conducted using any or all communication service associated with a user, a resource and/or a guide. Any communication session may include communication via multiple service and/or device. For example, a request may be submitted as a voice query, which might indicate an image located on a resource accessible to a user and/or a guide, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions between a user, a guide and/or a search system. A resource, a guide, and/or an advertisement may be rated. Rating information may be obtained from a user, a guide, a resource and/or a search system. Rating information may be used to select a resource, a guide, an advertisement and/or any item based on information associated with an item indicated in a database. A search service may be compensated by advertising revenue. Advertising or content may be delivered to a user, and/or guide using any service associated with a user and/or guide.

As illustrated in FIG. 1, system 100 includes guide systems 105, 110, a network 115 such as the Internet, a search system 130, user systems 135, 140, a database 120 which may comprise various records, resource systems 145, 150, resources 155, 160, and a guide tools server 165.

While only a limited number of systems associated with a guide (resource, user, guide tools server, and a search system) are depicted in FIG. 1, it is within the scope of the disclosure for multiple systems for guides, resources, users, guide tools and search systems to be utilized.

Any user system (e.g., the user systems 135, 140) can be operated by an information seeker, who may be any person, to submit a request to the search system 130 and/or receive a result and/or other information. Any guide system (e.g., the guide systems 105, 110) can be operated by a guide to obtain a result responsive to a request which may have been submitted by a user located at a user system (e.g., the user systems 135, 140). Any resource system (e.g., the resource systems 145, 150) may be operated by a human provider of information and/or may be an automated system which may provide a result and/or other information to a guide and/or a user. A resource may be a search engine, a database, a local information source of a guide system such as a disk or removable memory, etc. A resource may not be accessible using the network 115. For example, a resource such as the ‘Resource 2’ resource 155 may be accessible to a guide operating a guide system such as the guide system 105, or a resource such as the ‘Resource 3’ resource 160 may be accessible to a user operating the user system 135. A resource might include printed materials, images, video, and/or audio information, a software application, any information accessible to a guide, a user, a database, a system, and/or any combination thereof.

The network 115 (FIG. 1) may be a global public network of networks (the Internet) and/or consist in whole or in part of one or more private networks and communicatively couples the guide systems 105, 110, the resource systems 145, 150, the user systems 135, 140, with the other components of the system such as the search system 130 and the database 120. The network 115 may include one or more wireless networks which may enable wireless communication between the various elements of the system 100. For example, a mobile phone carrier network might be used to connect a user device to the search system 130.

The search system 130 allows interaction to occur among the guide systems 105, 110, the resource systems 145, 150 and the user systems 135, 140. For example, an information search query can be transmitted from the user systems 135, 140, to the search system 130, where a search query can be accessed by the guide systems 105, 110, and/or the resource systems 145, 150. Similarly, a response produced from the resource systems 145, 150, using the guide systems 105, 110, in response to a query submitted by the user systems 135, 140, may be transmitted to the search system 130, where it may be stored by the search system 130 and/or may be transmitted to the user systems 135, 140. Any type of communication between a user, a guide, and a resource may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entire database 120.

The user systems 135, 140, the guide systems 105, 110, the search system 130 and the resource systems 145, 150, may include equipment, software, systems and personnel required to send and/or receive messages between a user system, a guide system, a resource system and/or the search system using the network 115. The database 120 includes information which may allow the search system 130 to establish communication between any or all of the elements of the system 100.

A user system, a guide system, and/or a resource may be a desktop or mobile PC or Mac®, a mobile phone, a smart phone, a PDA, a server system, a landline phone, a specialized communication terminal, a terminal connected to a mainframe, or any other communication device and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco®, or other networking companies. After being presented with the disclosure herein, one of ordinary skill in the relevant art will immediately realize that any viable computer systems and/or communication devices known in the art may be used as user systems, guide systems, guide tool systems, resources, and/or to implement the search system 130.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of guide system 105 in order to communicate with the search system 130. Multiple communication services may be associated with a guide and may allow a communication session to be established between a guide system such as the guide system 105 and a user system, a resource system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, and/or the search system 130.

When a guide registers with the search system 130, the guide may be associated with one or more keywords, categories, and/or other information. For example, a keyword or category may be selected by a guide, or may be associated with a guide based on a test administered to a guide and/or other information provided during and/or after a registration process. Information associated with a guide may be stored in the database 120 and may be used for purposes such as matching a guide to a user request, determining and/or providing compensation for a guide, communicating with a guide, etc., as will be described further herein below.

A user may be identified by the search system 130. When a user system such as the user system 135 establishes a communication session with the search system 130, an identifier of the user system is determined. An identifier of a user system may be associated with other information regarding a user. A user system may be identified using an email address, a telephone number, an IM credential, a username, or any other identifier which may be used to associate information with a user. Multiple identifiers of a user may be associated with each other. Using information of communication services associated with a user, a communication session may be established between a user system such as the user system 135 and a guide system, a resource system, and/or the search system 130. Information such as a keyword, a category, a user profile, a previous search request, a search result, etc., may be associated with a user. Information of a user may be stored in the database 120.

A resource, which may be a person, an entity, a search engine, a database, a software application, a corpus of one or more types of media such as text or printed information, images, audio, video, etc., or a combination thereof, may be identified by the search system 130. Any source of information may be a resource within the context of the disclosure herein. Information of at least one method of communication is associated with a resource system which allows a communication session to be established between the search system 130, a user system and/or a guide system and a resource system such as the resource systems 145, 150. An identifier of a resource system may be associated with other information regarding a resource. A resource system may be identified using an email address, a telephone number, an IM credential, a resource username, a URL, or other persistent identifier which may be used to associate information with a resource. Multiple identifiers of a resource may be associated with each other. Using the information of communication services associated with a resource, a communication session may be established between a resource system such as the resource system 145 and a user system, a guide system, and/or the search system 130. Information such as a keyword, a category, a profile, or other information may be associated with a resource. Information of a resource may be stored in the database 120.

A resource such as the resources 155, 160, and/or resources accessible via the resource systems 145, 150, may include any system, software, hardware, personnel, and/or other facility which may provide information to a guide, a user, and/or the search system 130. For example, a resource may be a search engine, a database system, a library, a personal hard drive and/or other local storage, printed materials, recordings of any sort, a software program, a person or person, an organization, etc. A resource may be freely accessible to any user and/or guide and/or may be available on a restricted basis. The resource system 145, 150, may include resources which are available on an unrestricted and/or restricted basis. A resource may not be accessible using the network 115, but may be accessible to selected guide. For example, a resource such as the resource 155 may be accessible to one or more guides operating a guide system, such as the guide system 105, using any type of communication. For example, a guide may obtain information of an event to provide a search result. Information in any form, such as printed media, audio and/or visual information, software, hardware, etc., which may be accessible to a guide, a user and/or an operator of a resource system may be a resource.

The search system 130 may establish a communication session between any user systems, guide systems, or resource systems using information indicated in the database 120. For example, the user system 135 may establish a voice communication session with the search system 130, the search system 130 may establish a voice communication session between the user system 135 and the guide system 105, and the search system 130 may establish a voice communication session between the user system 135 and the resource system 145. While a voice communication session is used in this example, any type of communication session using one or more services such as SMS, EMS, MMS, email, IM, chat, web based communication, etc., may be established between any user system, guide system, and/or resource system, and/or the search system 130.

The guide tools server 165 may be used to provide any or all web pages and/or other information associated with a set of guide tools. The guide tools server 165 may provide several benefits. Web pages associated with various categories may be updated, modified, expanded, etc., without the need for making modification to the search system 130 as a whole. The guide tools server 165 may act as a buffer or cache for information provided to a guide, which may improve response time as resources such as the resource system 145 may share information at data rates which may not be suitable for a system such as the guide system 105.

Information associated with a user, a guide, and/or a resource may be obtained in various ways. For example, a registration process may be performed using a web form provided by the search system 130, and/or information may be obtained from an external database, and/or information may be obtained based on analysis of information indicated by a user, a guide, and/or a resource.

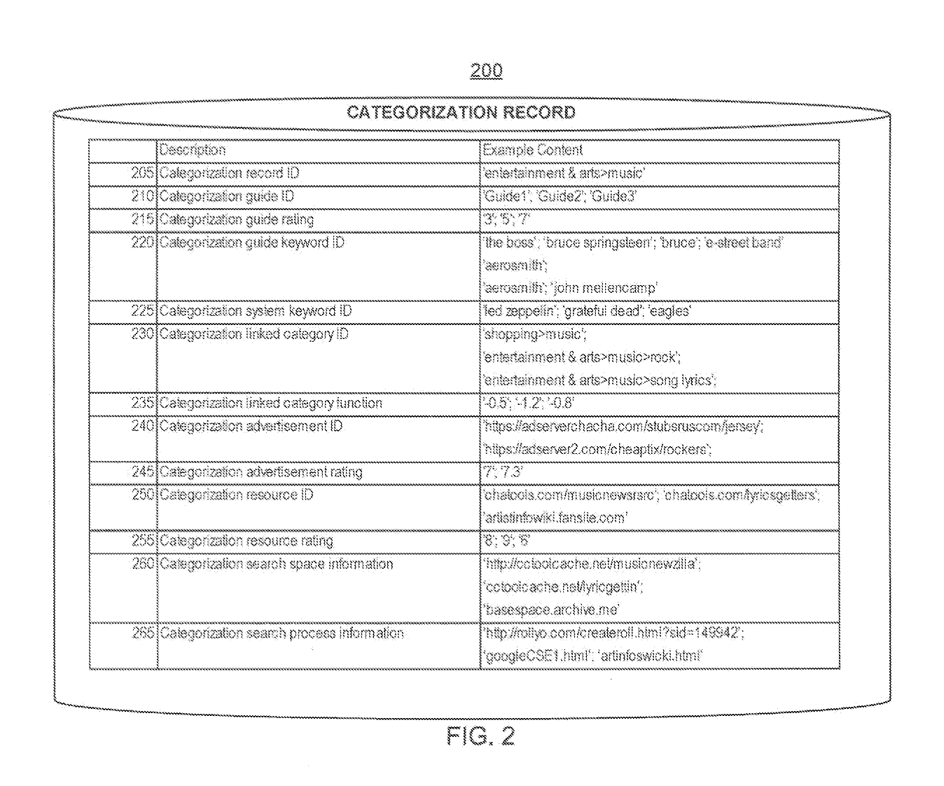

As illustrated in FIG. 2, an exemplary categorization record 200 is provided, of which one or more may be associated with or resident in the database 120 (FIG. 1). The categorization record 200 may include a categorization record ID field 205, a categorization guide ID field 210, a categorization guide rating field 215, a categorization guide keyword ID field 220, a categorization system keyword ID field 225, a categorization linked category ID field 230, a categorization linked category function field 235, a categorization advertisement ID field 240, a categorization advertisement rating field 245, a categorization resource ID field 250, a categorization resource rating field 255, a categorization search space information field 260, and a categorization search process information field 265.

The categorization record ID field 205 contains an identifier of a categorization, which is preferably unique and preferably used consistently. In at least one embodiment, the categorization record ID field 205 can include a randomly generated numerical code and/or a character string indicating a categorization. A categorization record ID serves to distinguish a categorization record associated with a categorization from a categorization record associated with other categorizations. Although particular examples of identifiers are described herein, other types of identifiers uniquely indicating a categorization may be utilized without departing from the spirit and scope of the embodiments herein. A categorization record ID may include a categorization description, a random numeric code, and/or any other information uniquely identifying an element within a data structure. Using the example in FIG. 2, ‘entertainment & arts>music’ is the categorization record ID associated with the categorization record 200.

The categorization guide ID field 210 may include one or more identifiers associated with a guide. The categorization guide ID list 210 may include one or more identifiers of a guide which may be used to obtain further information of a guide using a record such as the guide record 400 (FIG. 4). Using the example in FIG. 2, the guide IDs ‘Guide1’, ‘Guide2’ and ‘Guide3’ have been associated with ‘entertainment & arts>music’. While only a few guide identifiers have been illustrated in FIG. 2, any number of guide identifiers may be associated with a categorization. Association of a guide ID with a categorization may indicate that a guide has registered to respond to requests associated with the categorization, and/or that a guide may associate, review, edit, and/or otherwise associate information with a categorization.

The categorization guide rating field 215 may include information of one or more ratings associated with a guide. For example, the categorization guide rating field 215 may include a rating of a guide based on a result produced by a guide responsive to a request associated with the categorization identified in the categorization record ID field 205. In at least one embodiment, the categorization guide ID field 210 and the categorization guide rating field 215 may be linked by, for example, a pointer. Using the example illustrated in FIG. 2, the rating ‘3’ has been associated with ‘Guide1’, the rating ‘5’ has been associated with ‘Guide2’ and the rating ‘7’ has been associated with ‘Guide3’. This may indicate that the guide ‘Guide3’ has a highest rating and might be selected first to respond to a request associated with the category ‘entertainment & arts>music’. A rating of a guide may be determined based on any information indicated in the database 120 (FIG. 1).

The categorization guide keyword ID field 220 may include information of one or more keywords associated with a guide associated with the categorization indicated in the categorization record ID field 205. The information indicated in the categorization guide keyword ID field 220 may be compared to information indicated in a search request which is associated with the categorization identified in the categorization record ID field 205. A match between information associated with a search request and information indicated in the categorization guide keyword ID field 220 may modify the ranking of a guide when selecting a guide to respond to a search request or request. In at least one embodiment, the categorization guide ID field 210 and the categorization guide keyword ID field 220 may be linked by, for example, a pointer. Using the example illustrated in FIG. 2, the keywords ‘theboss’, ‘bruce springsteen’, ‘bruce’ and ‘e-street band’ have been associated with ‘Guide1’, the keyword ‘aerosmith’ has been associated with ‘Guide2’ and the keywords ‘aerosmith’ and ‘john mellencamp’ have been associated with ‘Guide3’. This may indicate that ‘Guide1’ would be more likely to be selected to respond to a search request associated with the category ‘entertainment & arts>music’ which included the information ‘e-street band’ even though the rating of ‘Guide1’ is lower than the ratings of ‘Guide2’ and ‘Guide3’ when responding to a search request associated with the category ‘entertainment & arts>music’. Continuing with the example in FIG. 2, if a search request categorized as associated with the category ‘entertainment & arts>music’ which contained the keyword ‘aerosmith’ is received, ‘Guide3’ might be selected to respond to the request, as both ‘Guide2’ and ‘Guide3’ are associated with the keyword ‘aerosmith’ and ‘Guide3’ has a higher rating associated with ‘entertainment & arts>music’.

The categorization system keyword ID field 225 may include information of one or more ‘interests’ or keywords associated with the categorization indicated in the categorization record ID field 205. Information indicated in the categorization system keyword ID field 225 may be compared to information indicated in a search request which is associated with the categorization identified in the categorization record ID field 205. Information indicated in the categorization system keyword ID field 225 may be obtained from analysis of a resource and for other information. For example, if a resource is associated with a category, the resource may be indexed and high ranking keywords of the resource may be indicated in the categorization system keyword ID field 225. A match between information associated with a search request and information indicated in the categorization system keyword ID field 225 may modify the ranking of a categorization associated with a request. For example, if a keyword indicated in the categorization system keyword ID field 225 is highly ranked for the categorization, and is present in content of a request, the categorization may be highly ranked for the request. Using the example illustrated in FIG. 2, the keywords ‘led zeppelin’, ‘grateful dead’, and ‘eagles’ have been associated with the category ‘entertainment & arts>music’.

The categorization linked category ID field 230 may include information of categorizations which are associated with a categorization identified in the categorization record ID field 205. The information included in the categorization linked category ID field 230 may be used to identify categorization records which may be associated with a guide and/or information which may be selected responsive to a search request. For example, a list of related categorization record ID's may be used to identify a categorization record which may include information of a guide who may have relevant knowledge regarding a user search request which is associated with the category ‘entertainment & arts>music’. Using the example in FIG. 2, the category IDs ‘shopping>music’, ‘entertainment & arts>music>rock’ and ‘entertainment & arts>music>song lyrics’ have been associated with entertainment & arts>music. This may indicate that a guide and/or information associated with the categorization ‘shopping>music’, ‘entertainment & arts>music>rock’ and ‘entertainment & arts>music>song lyrics’ may be ranked responsive to a search request associated with the categorization ‘entertainment & arts>music’.

Information of the categorization linked category ID field 230 may be determined including based on previous categorizations determined to be accurate by the system 100 (FIG. 1), guide(s), etc. However, categorization linkage may be created and/or adjusted in the categorization linked category ID field 230 based on various criteria.

The categorization linked category function field 235 may include information of a function or other information associated with a linkage between a category listed in the categorization linked category ID field 230 and a category indicated in the categorization record ID field 205. Information indicated in the categorization linked category function field 235 may be used to modify a rating and/or ranking of a guide and/or other items associated with a category indicated in the categorization linked category ID field 230, for example, when selecting a guide or other information to be associated with a search request determined to be associated with a categorization identified in the categorization record ID field 205. In at least one embodiment, the categorization linked category ID field 230 and the categorization linked category function field 235 may be linked by, for example, a pointer. Using the example in FIG. 2, the function ‘−0.5’ has been associated with the categorization ‘shopping>music’. This may indicate that a rating of a guide associated with the categorization ‘shopping>music’ should be reduced by ‘0.5’ when ranking guides to respond to a search request associated with the categorization ‘entertainment & arts>music’. Likewise, the functions ‘−1.2’ and ‘−0.8’ have been associated with the categories ‘entertainment & arts>music>rock” and ‘entertainment & arts>music>song lyrics’, respectively. This may indicate that a rating of a guide associated with the category ‘entertainment & arts>music>rock’ may be reduced by ‘1.2’, and that the rating of a guide associated with the category ‘entertainment & arts>music>song lyrics’ may be reduced by ‘0.8’ when ranking guides to be selected responsive to a search request associated with the categorization ‘entertainment & arts>music’. While only a few categorization IDs are illustrated in FIG. 2, multiple categorization identifiers with various linked category functions may be utilized within the scope of the embodiments herein.

Information indicated in the categorization linked category ID field 230 and the categorization linked category function field 235 may be produced in various ways. In at least one embodiment a human taxonomist may identify linked categorizations, and may assign a strength value. Algorithmic techniques may be used in combination with human judgment to determine linked categorizations. For example, an algorithmic search may identify categorizations which may share index elements, keywords, tags, etc., for consideration by a human taxonomist and/or may automatically add a categorization ID to the categorization linked category ID field 230. Information indicated in the categorization linked category function field 235 may be modified based on rating of a search result provided by a guide selected using the information indicated in a linked category ID field. For example, a higher success rate by a guide associated with a categorization identified in the categorization linked category ID field 230 may decrease a difference in ratings for guides associated with the categorization.

The categorization advertisement ID field 240 may include one or more identifiers associated with an advertisement. The categorization advertisement ID field 240 may include one or more identifiers of an advertisement which may be associated with a categorization. Using the example in FIG. 2, the advertisement IDs <‘https://adserverchacha.com/stubsruscom/jersey’> and <‘https://adserver2.com/cheaptix/rockers’> have been associated with the categorization record 200, which may indicate that the advertisements <‘https://adserverchacha.com/stubsruscom/jersey’> and <‘https://adserver2.com/cheaptix/rockers’> may be presented to a guide and/or a user responsive to a request associated with ‘entertainment & arts>music’. While only a few advertisement identifiers have been illustrated in FIG. 2, any number of advertisement identifiers may be associated with a categorization. Categorization of advertisements may also be implemented based on selection by guide(s), by the system 100 (FIG. 1), by content providers of the advertisements, etc.

The categorization advertisement rating field 245 may include information of one or more ratings associated with an advertisement. For example, the categorization advertisement rating field 245 may include a rating of an advertisement based at least in part on frequency of selection of an advertisement by a guide responsive to search request associated with the categorization identified in the categorization record ID field 205. In at least one embodiment, the categorization advertisement ID field 240 and the categorization advertisement rating field 245 may be linked by, for example, a pointer. Using the example illustrated in FIG. 2, the rating ‘7’ has been associated with the advertisement <‘https://adserverchacha.com/stubsruscom/jersey’> and the rating ‘7.3’ has been associated with the advertisement<‘https://adserver2.com/cheaptix/rockers’>. This may indicate that the advertisement<‘https://adserver2.com/cheaptix/rockers’> has the highest rating and might be more likely to be selected responsive to a search request associated with the category ‘entertainment & arts>music’.

The categorization resource ID field 250 may include one or more identifiers of a resource which may be associated with a categorization. Using the example in FIG. 2, the resource IDs ‘chatools.com/musicnewsrsrc’, ‘chatools.com/lyricsgetters’ and ‘artistinfowiki.fansite.com’ have been associated with the categorization record 200. While only a few resource identifiers have been illustrated in FIG. 2, any number of resource identifiers may be associated with a categorization. In at least one embodiment, a resource ID may be a pointer to a webpage provided by the guide tools server 165 (FIG. 1).

The categorization resource rating field 255 (FIG. 2) may include information of one or more ratings associated with a resource. For example, the categorization resource rating field 255 may include a rating of a resource based at least in part on frequency of use of a resource by a guide responsive to a search request associated with the categorization identified in the categorization record ID field 205. A rating of a resource and/or other item is not required to be based on any particular computations and may be based on any information indicated in the database 120 (FIG. 1). In at least one embodiment, the categorization resource ID field 250 and the categorization resource rating field 255 may be linked by, for example, a pointer. Using the example illustrated in FIG. 2, the rating ‘8’ has been associated with the resource ‘chatools.com/musicnewsrsrc’, the rating ‘9’ has been associated with the resource ‘chatools.com/lyricsgetters’ and the rating ‘6’ has been associated with the resource ‘artistinfowiki.fansite.com’. A ranking of a resource associated with a categorization may affect presentation of the resource. Although numeric ratings have been used for the purposes of illustration, any type of rating information may be included in a rating field such as the categorization resource rating field 255.

The categorization search space information field 260 may include one or more identifiers of resources, media, content, systems, and/or other information which may be associated with a categorization. Using the example in FIG. 2, the search space indicated in ‘http://cctoolcache.net/musicnewzilla’, ‘cctoolcache.net/lyricgettin’ and ‘basespace.archive.me’ have been associated with the categorization record 200. This may indicate that information indicated in ‘http://cctoolcache.net/musicnewzilla’, ‘cctoolcache.net/lyricgettin” and tasespace.archive.me’ may be included in a search space for a query or request associated with the categorization ‘entertainment & arts>music’. While only a few search space identifiers have been illustrated in FIG. 2, any number of search space identifiers may be associated with a categorization. A search space identifier may indicate any type of information and may include information which may allow a guide, user, a resource and/or the search system 130 (FIG. 1) to access information. In at least one embodiment, a search space indicator may be used to access a list of URLs which have been edited by one or more human editors, such as a DMOZ directory list, however information such as a collection of any sort any corpus of documents, images, and/or other media may be indicated in the categorization search space information field 260.

The categorization search process information field 265 may include one or more identifiers of information which may be associated with a categorization, which may be used to define parameters associated with a search process which may be applied to information indicated in a categorization search space info field. For example, search strategy information might indicate that a search be conducted on one or more lists of URL's, and that a number of results from each search be combined, similar to the meta-search concept. Alternately, a search strategy might specify parametric information, which might be used by an algorithmic search such as Google®, which might be applied to any or all information indicated by information in a categorization search space field. In at least one embodiment, the categorization search space info field 260 and the categorization search process information field 265 may be linked by, for example, a pointer. Using the example illustrated in FIG. 2, the URL ‘http://rollyo.com/createroll.html?sid=149942’, the file ‘googleCSE1.html’ and the file ‘artinfoswicki.html’ have been associated with the categorization ‘entertainment & arts>music’. This may indicate that a Rollyo™ search algorithm may be applied to the URLs indicated at ‘http://cctoolcache.net/musicnewzilla’, that a Google® CSE may be applied to the collection ‘cctoolcache.net/lyricgettin’ and that the swicki search ‘artinfoswicki,html’ is to be applied to the collection ‘basespace.archive.me’. Further processes may be indicated in the categorization search process information field 265, such as a weighting, a number of results, a presentation format, and/or any other processing which might be applied to a result obtained from processing of a search. Information of indexing associated with one or more resources may be include in the categorization search process information field 265, which may be utilized to identify, rate and/or rank keywords and/or other information associated with a resource.

As previously noted, herein information associated with categorizations indicated in the categorization linked category ID field 235 may be utilized in order to provide information responsive to a request. In order to enrich a vocabulary associated with an index, it may be desirable to add vocabulary to content of the categorization system keyword ID field 225 associated with a category. Likewise, it may be desirable to determine if a keyword indicated in the categorization guide keyword ID field 220 is located in resources associated with categories in the categorization linked category ID field 230. For example, if the keyword ‘aerosmith’ is highly ranked when associated with the linked categorization, ‘entertainment & arts>music>rock’, ‘aerosmith’ might be added to the categorization system keyword ID field 225 of the categorization ‘entertainment & arts>music>rock’, and resources associated with ‘entertainment & arts>music>rock’ might be indexed to determine keywords associated with ‘entertainment & arts>music’.

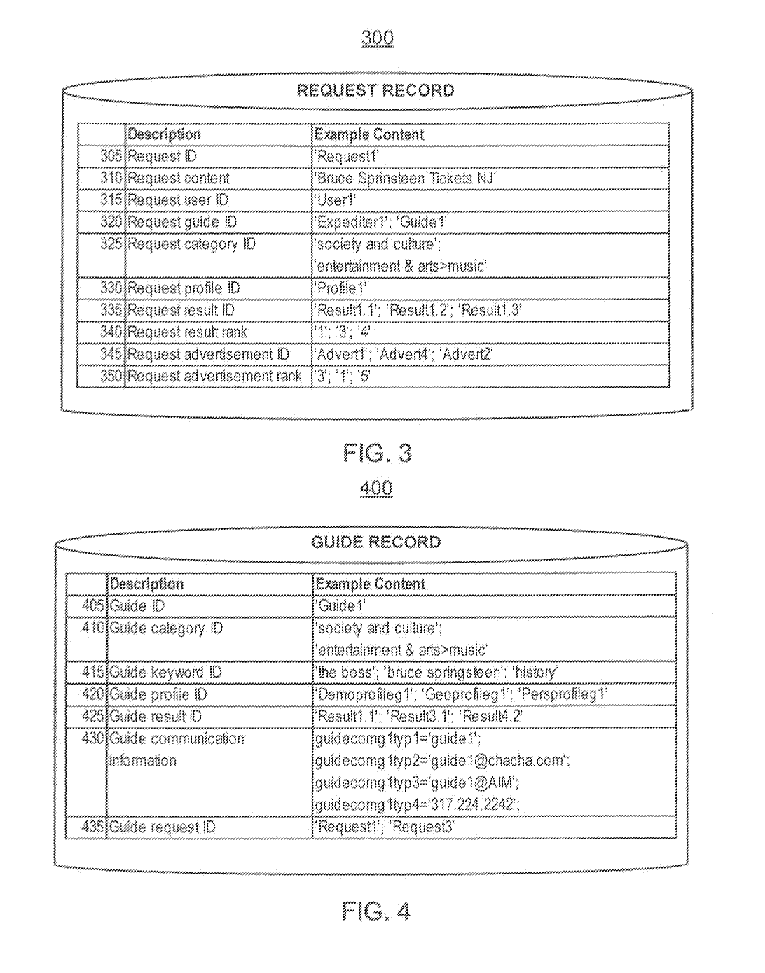

As illustrated in FIG. 3, an exemplary request record 300 is provided, of which one or more may be associated with or resident in the database 120 (FIG. 1). The request record 300 may include a request ID field 305, a request content field 310, a request user ID field 315, a request guide ID field 320, a request category ID field 325, a request profile ID field 330, a request result ID field 335, a request result rank field 340, a request advertisement ID field 345, and a request advertisement rank field 350.

A request record may be created responsive to various activities. For example, a guided search session, an interactive training session, a non-interactive training session, submission of a request by a user, and/or other types of activity may cause a request record to be created and/or modified. A request record may be imported from an external resource, a database, and/or any media accessible to the search system 130. In at least one embodiment, a request record may be created when a request is received from a user by the search system 130.

The request ID field 305 preferably contains a unique identifier of a request, which is preferably used consistently. For example, in at least one embodiment, the request ID field 305 can include a randomly generated numerical code, and/or a text string indicating the content of a request. A request ID serves to distinguish the request record associated with a request from a request record associated with other requests. Other unique identifiers of a request may be utilized without departing from the spirit and scope of the embodiments herein.

A unique identifier may be assigned to a request when it is received. A request may include information that is not explicitly provided by a user. For example, location information, profile information, etc., may be associated with a request which are not explicitly provided by a user. As illustrated in FIG. 3, ‘Request1’ is the request ID associated with the request record 300 (FIG. 3).

The request content field 310 may include information regarding content of a request. For example, text associated with a query submitted by a user may be indicated in the request content field 310. Content of the request content field 310 may be processed in order to associate a keyword and/or category and/or other information with a request. In at least one embodiment, a structured query or succinct query which conforms to a specific context may be indicated in the request content field 310. User requests which are associated with a structured query which may have been submitted by a number of users may be indicated in the request content field 310. Information such as audio recordings, images, video, etc., which are associated with a request may be indicated in the request content field 310. Using the example illustrated in FIG. 3, the query ‘Bruce Sprinsteen Tickets NJ’ is the content associated with ‘Request1’. This may indicate that the query ‘Bruce Sprinsteen Tickets NJ’ may be processed in order to respond to ‘Request1’. Information indicated in the request content field 310 may be used to determine which information associated with an index may be provided responsive to a request. For example, keywords associated with a transcription of the request ‘Bruce Sprinsteen Tickets NJ’ may compared to keywords associated with an index to determine a number of categories associated with the request ‘Request1’. For example, a highest ranked category may be determined based on the association of keywords of a request with keywords of a plurality of categories.

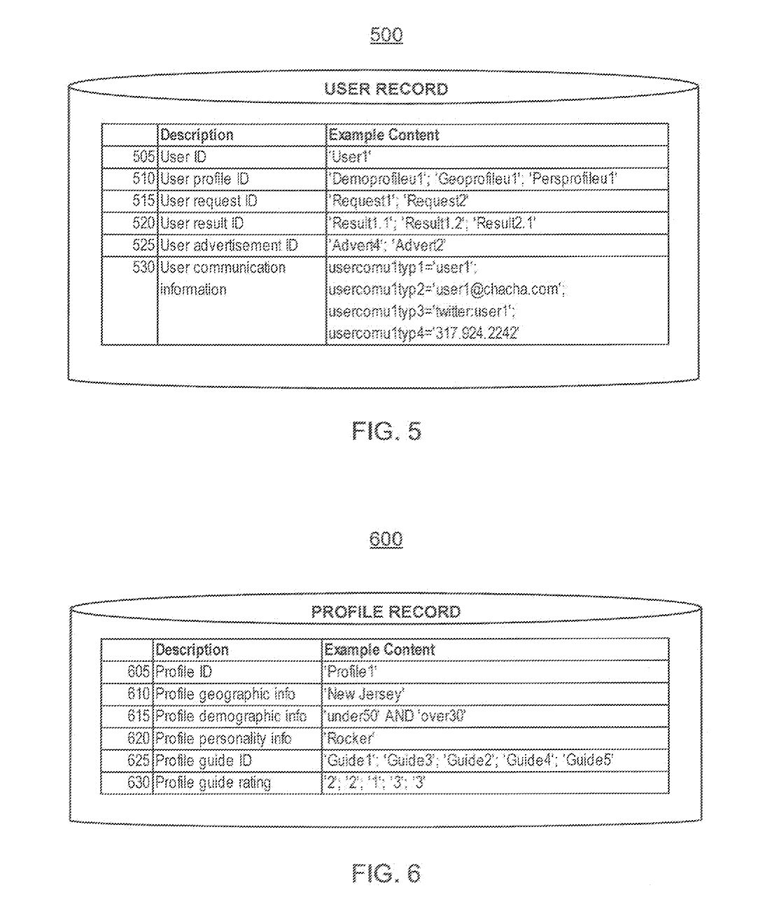

The request user ID field 315 may include information of a user that submitted a query. The request user ID field 315 may be used to associate any number of users with a query. In at least one embodiment, each request is uniquely associated with a single user. In at least one embodiment, if a request submitted by a user is equivalent to a previous request, multiple users may be associated with a request. In at least one embodiment, an individual user may submit a request which is associated with a group of one or more users. A result and/or other item associated with a request may be presented responsive to a request in an order based at least in part on a ranking of the item associated with the request. Information indicated in the request user ID field 315 may be used to obtain information of a user using a record such as the user record 500 (FIG. 5). Using the example illustrated in FIG. 3 ‘User1’ is associated with ‘Request1’.

The request guide ID field 320 may include information of a number of guides associated with a request. For example, if a guide obtains a search result responsive to ‘Request1’, an identifier of the guide may be indicated in the request guide ID field 320. Likewise, if a guide was selected to respond to a request, an identifier of the guide may be indicated in the request guide ID field 320. Information indicated in the request guide ID field 320 may be used to obtain information associated with a guide using a record such as the guide record 400 (FIG. 4). A guide may be associated with a request if the guide has reviewed information associated with a request. For example, a transcriber, an expediter, a translator, and/or a searcher may be associated with a request. Using the example illustrated in FIG. 3, the guides ‘Expediter1’ and ‘Guide1’ have been associated with ‘Request1’. This may, for example, indicate that ‘Expediter1’ has initially received a query, and that ‘Guide1’ has been selected to perform a search responsive to the query.

The request category ID field 325 may include information of a number of categories and/or keywords associated with a request. Content of the request category ID field 325 may be modified by an automated classification of a request. A human may select a category and/or keyword associated with a request. A categorization may be associated with a resource, a guide, an advertisement, training information, etc. An item associated with a category may be presented to a guide and/or a user if a request associated with a category is submitted. An item associated with a category and/or other information may be presented for review by a person. Association of a category with a request may be used to select items such as an advertisement associated with the category to be presented responsive to a request. Association of a category with a request may be used to select a guide associated with the category to vote regarding an item associated with the request. A category may be associated with a request based on any type of information associated with the request. Using the example illustrated in FIG. 3, the categories ‘society and culture’ and ‘entertainment & arts>music’ are associated with ‘Request1’.

The request profile ID field 330 may include information of a number of profiles associated with a request. A profile may be associated with a request based at least in part on a profile associated with a user associated with a request. A geographic profile which is common to a number of users associated with a request may be associated with a request, or a guide such as an expediter may determine that a profile is to be associated with a request based on content and/or subject matter of a request associated with a user, etc. A guide selected to respond to a request such as a specialist may be selected based at least in part on a profile associated with the request. A reviewer may be selected to review an item associated with a request based at least in part on a profile associated with a request. Using the example illustrated in FIG. 3, ‘Profile1’ is associated with ‘Request1’.

The request result ID field 335 may include information of a result which is associated with a request. A search result may be associated with a request when a guide obtains the search result responsive to the request. If a request is submitted to the search system 130 (FIG. 1), a guide may be selected, and the guide may provide a result responsive to the request. Alternately, a result may be associated with a request if the request is submitted to a resource such as a search engine, database or other resource system. A search result may be associated with a request based on matching of a previous request to the request. For example, a ranking of previous results may be performed based on keywords, categories and profiles associated with a request and the previous search results. Any number of search results may be associated with a request. Using the example illustrated in FIG. 3, ‘Result1.1’, ‘Result1.2’, and ‘Result1.3’ have been associated with ‘Request1’.

The request result rank field 340 may include information regarding a ranking of a result associated with a request. In at least one embodiment, the request result ID field 335 and the request result rank field 340 are linked by, for example, a pointer. Using the example illustrated in FIG. 3, ‘Result1.1’ has a ranking of ‘1’, ‘Result1.2’ has a ranking of ‘3’, and ‘Result1.3’ has a ranking of ‘4’. Content of the request result ID field 335 and the request result rank field 340 may be used at least in part to determine an order in which a search result is presented to a user responsive to a request. Using the example illustrated in FIG. 3, ‘Result1.1’ might be preferentially presented to a user responsive to ‘Request1’. A ranking of a result may be determined based on criteria such as keyword ranking, guide ratings, etc., which may include automated and/or human assisted rating and/or ranking.

The request advertisement ID field 345 may include information of an advertisement which is associated with a request. An advertisement may be associated with a request when a guide selects the advertisement to be presented to a user responsive to the request. For example, if a request is submitted to the search system 130 (FIG. 1), a guide may be selected, and the guide may provide an advertisement responsive to the request. An advertisement may be associated with a request automatically such as when a category and/or a keyword is associated with the request. Any number of advertisements may be associated with a request. Using the example illustrated in FIG. 3, ‘Advert1’, ‘Advert4’, and ‘Advert2’ have been associated with ‘Request1’.

The request advertisement rank field 350 may include information regarding a ranking of an advertisement associated with a request. In at least one embodiment, the request advertisement ID field 345 and the request advertisement rank field 350 are linked by, for example, a pointer. Using the example illustrated in FIG. 3, ‘Advert1’ has a ranking of ‘3’, ‘Advert4’ has a ranking of ‘1’, and ‘Advert2’ has a ranking of ‘5’. Content of the request advertisement D field 345 and the request advertisement rank field 350 may be used at least in part to determine an order in which an advertisement is presented responsive to a request. Using the example illustrated in FIG. 3, ‘Advert4’ might be preferentially presented to a user responsive to ‘Request1’.

As illustrated in FIG. 4, an exemplary guide record 400 is provided, of which one or more may be associated with or resident in the database 120 (FIG. 1). The guide record 400 may include a guide ID field 405, a guide category ID field 410, a guide keyword ID field 415, a guide profile ID field 420, a guide result ID field 425, a guide communication information field 430, and a guide request ID field 435.

The guide ID field 405 preferably contains a unique identifier of a guide, which is preferably used consistently. For example, in at least one embodiment, the guide ID field 405 can include a randomly generated numerical code, and/or a text string indicating a name associated with a guide. A guide ID serves to distinguish the guide record associated with a guide from a guide record associated with other guides. Other unique identifiers of a guide may be utilized without departing from the spirit and scope of the embodiments. Using the example illustrated in FIG. 4, ‘Guide1’ is the guide ID associated with the guide record 400.

The guide category ID field 410 may include information of a number of categories associated with a guide. Content of the guide category ID field 410 may be modified based on an action of a guide. A category may be associated with a guide based on one or more types of information processing. For example, the category ‘translate English to Spanish’, or ‘transcribe spoken queries’ or ‘Sports’ might be associated with a guide to indicate a skill or expertise associated with the guide. Such an association may be used in part to rate or rank a guide and/or to select a guide. In at least one embodiment, a guide may be assigned a specific role such as transcriber, translation, etc., which is separate from a category assigned to the guide. A person may select a category and/or keyword which are associated with a guide. A category may be associated with a guide based on testing of a guide. A category may be associated with a guide based on an affiliate group associated with the guide. For example, if a guide has chosen to be affiliated with affiliate groups associated with a type of food, a category associated with the type of food might be associated with the guide. A category may signify any type of skill or expertise which may be used to match a guide to a task. A category associated with a guide may be used to select an item which is to be presented to a guide. A guide may be selected to review an item based on the association of a guide with a category. For example, a guide may be selected to review and/or provide information such as resources, media, search results, etc., based on a category associated with the guide. Using the example illustrated in FIG. 4, ‘society and culture’ and ‘entertainment & arts>music’ are associated with ‘Guide1’.

The guide keyword ID field 415 may include information of a number of keywords associated with a guide. Content of the guide keyword ID field 415 may be modified based on an action of a guide. A person may select a keyword which is associated with a guide. For example, a guide may select a keyword to be associated with the guide during a registration process. A keyword may be associated with a guide based on testing of a guide. For example, a guide may be required to demonstrate knowledge of a category and/or keyword in order to be associated with the keyword. Content of the guide keyword ID field 415 may be compared to content of a request in order to determine a ranking of a guide for responding to a request. For example, if a keyword indicated in the guide keyword ID field 415 is associated with content of a request, the guide may be more likely to be selected to respond to the request. Using the example illustrated in FIG. 4, the keywords ‘the boss’, ‘bruce springsteen’ and ‘history’ are associated with ‘Guide1’. This may indicate that ‘Guide1’ has indicated an interest in ‘the boss’, ‘bruce springsteen’ and ‘history’.

The guide profile ID field 420 may include information of a number of profiles associated with a guide. Content of the guide profile ID field 420 may be modified based on action of a guide. A person may select a profile which is associated with a guide. For example, a guide may select a profile to be associated with the guide during a registration process. A profile may be associated with a guide based on testing of a guide. For example, a guide may be required to demonstrate knowledge relevant to a profile in order to be associated with the profile, or a guide may take a test which is used to generate a profile, or a guide may provide information such as demographic, geographic, personality or other information which may be indicated in a profile associated with the guide. Information indicated in a guide profile may be obtained from an external database. Information indicated in the content of the guide profile ID field 420 may be compared to information indicated in the content of a profile associated with a request in order to determine a ranking of a guide for responding to a request. Likewise, a profile associated with a guide may be used to select and/or rank a guide. Using the example illustrated in FIG. 4, ‘Demoprofileg1’, ‘Geoprofileg1’ and ‘Persprofileg1’ are associated with ‘Guide1’. This may indicate that ‘Guide1’ has indicated and/or generated ‘Demoprofileg1’ which may be a demographic profile, ‘Geoprofileg1’ which may be a geographic profile and ‘Persprofileg1’ which might indicate personality information regarding ‘Guide1’. Any or all information indicated in a profile associated with a guide may be used to determine a rating and/or ranking of a guide.

The guide result ID field 425 may include information of a result associated with a guide. Content of the guide result ID field 425 may be modified based on an action of a guide. If a guide produces a search result responsive to a request, an identifier of the search result may be included in the guide result ID field 425. A rating and/or ranking associated with a search result associated with a guide may affect compensation for a guide. Likewise a usage indicator associated with a search result provided by a guide may affect a rating and/or ranking associated with a guide. Using the example illustrated in FIG. 4, ‘Result1.1’, ‘Result3.1’ and ‘Result4.2’ are associated with ‘Guide1’. This may indicate that ‘Guide1’ has provided and/or reviewed ‘Result1.1’, ‘Result3.1’, and ‘Result4.2’.

The guide communication information field 430 may include information of a device and/or service associated with a guide. Content of the guide communication information field 430 may be modified based on an action of a guide. If a guide establishes communications using a device and/or service, information regarding the device and/or service may be included in the guide communication information field 430. Any type of communication service and/or system may be indicated in the guide communication information field 430. For example, a username and/or password associated with a guide may be indicated in the guide communication information field 430. Communication services such as IM, e-mail, SMS, MMS, EMS, telephone, wireless or wired communication, etc., may be indicated in the guide communication information field 430. A telephone number, an email address, an IM provider and login ID, a keyword associated with a service, etc., may be indicated in the guide communication information field 430. Using the example illustrated in FIG. 4, the login ‘guide1’, the email cguide1@chacha.com', the IM credential ‘guide1@AIM’ and the phone number ‘317.224.2242’ are associated with ‘Guide1’. This may indicate that ‘Guide1’ may be contacted using the login ID ‘guide1’, via email at ‘guide1@chacha.com’, via IM as ‘guide1@AIM’ and/or via voice, text, and/or other services associated with the phone number ‘317.224.2242’.

The guide request ID field 435 may include information of a request associated with a guide. Content of the guide request ID field 435 may be modified based on an action of a guide. If a guide produces a search result responsive to a request, an identifier of the request may be included in the guide request ID field 435. A rating and/or ranking associated with a request associated with a guide may affect compensation for a guide. For example, a quality rating associated with a request might affect compensation for guides responding to the request. Likewise a usage indicator associated with a request and a guide may affect a rating and/or ranking associated with the guide. A request may be associated with a guide based on a vote cast by a guide regarding items associated with the request. For example, if a first guide reviews a request answered by second guide, the first guide may be associated with the request. Using the example illustrated in FIG. 4, ‘Request1’, and ‘Request3’ are associated with ‘Guide1’. This may indicate that ‘Guide1’ has responded to, been selected to respond to, and/or has reviewed one or more items associated with ‘Request1’, and ‘Request3’.

As illustrated in FIG. 5, an exemplary user record 500 is provided, of which one or more may be associated with or resident in the database 120 (FIG. 1). The user record 500 may include a user ID field 505, a user profile ID field 510, a user request ID field 515, a user result ID field 520, a user advertisement ID field 525, and a user communication information field 530.

The user ID field 505 preferably contains a unique identifier of a user, which is preferably used consistently. For example, in at least one embodiment, the user ID field 505 can include a randomly generated numerical code, and/or a text string indicating a name associated with a user. A user ID serves to distinguish a user record associated with a user from a user record associated with other users. Other unique identifiers of a user may be utilized without departing from the spirit and scope of the embodiments. In at least one embodiment, a user ID may include a phone number associated with a user. Using the example illustrated in FIG. 5, ‘User1’ is the user ID associated with the user record 500.

The user profile ID field 510 may include information of a profile associated with a user. Content of the user profile ID field 510 may be modified based on an action of a user. A person may select a profile which is associated with a user. For example, a user may select a profile to be associated with the user during a registration process. A profile may be associated with a user based on testing of a user and/or information from users. For example, a user may be required to demonstrate knowledge relevant to a profile in order to be associated with the profile, or a user may take a test which is used to generate a profile, or a user may provide information such as demographic, geographic, personality or other information which may be indicated in a profile associated with the user. Historical information such as a request and/or result associated with a user may be used to determine profile information. Information indicated in a user profile may be obtained from an external database. A profile associated with a user may be used to select and/or rank a user for voting. Using the example illustrated in FIG. 5, ‘Demoprofileu1’, ‘Geoprofileu1’ and ‘Persprofileu1’ are associated with the user ‘Use1’. This may indicate that ‘User1’ has indicated and/or generated ‘Demoprofileu1’ which may be a demographic profile, ‘Geoprofileu1’ which may be a geographic profile and ‘Persprofileu1’ which might indicate personality information regarding ‘User1’.

The user request ID field 515 may include information of a number of requests associated with a user. Content of the user request ID field 515 may be modified based on an action of a user. If a user submits a request, an identifier of the request may be included in the user request ID field 515. Using the example illustrated in FIG. 5, ‘Request1’ and ‘Request2’ are associated with ‘User1’ which may indicate that ‘User1’ has submitted ‘Request1’ and ‘Request2’.

The user result ID field 520 may include information of a number of results associated with a user. Content of the user result ID field 520 may be modified based on an action of a user and/or a guide. If a user receives a result responsive to a request, an identifier of the result may be included in the user result ID field 520. A usage indicator associated with a result provided to a user may affect a rating and/or ranking associated with a guide. Using the example illustrated in FIG. 5, ‘Result1.1’, ‘Result1.2’ and ‘Result2.1’ are associated with ‘User1’. This may indicate that ‘User1’ has been presented with the results ‘Result1.1’, ‘Result1.2’, and ‘Result2.1’.

The user advertisement ID field 525 may include information of a number of advertisements associated with a user. Content of the user advertisement ID field 525 may be modified based on an action of a user. If a user receives an advertisement, an identifier of the advertisement may be included in the user advertisement ID field 525. A usage indicator associated with an advertisement provided to a user may affect a rating and/or ranking associated with a guide, compensation for a provider of a search system, and/or rating and/or ranking of an advertisement. Using the example illustrated in FIG. 5, ‘Advert4’ and ‘Advert2’ are associated with ‘User1’. This may indicate that ‘User1’ has been presented with ‘Advert4’ and ‘Advert2’.

The user communication information field 530 may include information of a device and/or service associated with a user. Content of the user communication information field 530 may be modified based on an action of a user. If a user establishes communications using a device and/or service, information regarding the device and/or service may be included in the user communication information field 530. Any type of communication service and/or system may be indicated in the user communication information field 530. For example, a username and/or password associated with a user may be indicated in the user communication information field 530. Communication services such as IM, e-mail, SMS, MMS, EMS, telephone, wireless or wired communication, etc., may be indicated in the user communication information field 530. A telephone number, an email address, an IM provider and login ID, a keyword associated with a service, etc. may be indicated in the user communication information field 530. Using the example illustrated in FIG. 5, the login ‘used’, the email ‘user1@chacha.com’, the Twitter™ service account ‘twitteruser1’ and the phone number ‘317.924.2242’ are associated with ‘User1’. This may indicate that ‘User1’ may be contacted using the login ID ‘user1’, via email at ‘user1@chacha.com’, via Twitter as ‘user1’ and/or via voice, text, and/or other service associated with the phone number ‘317.924.2242’.

As illustrated in FIG. 6, an exemplary profile record 600 is provided, of which one or more may be associated with or resident in the database 120 (FIG. 1). The profile record 600 may include a profile ID field 605, a profile geographic info field 610, a profile demographic info field 615, a profile personality info field 620, a profile guide ID field 625, and a profile guide rating field 630.

The profile ID field 605 preferably contains a unique identifier of a profile, which is preferably used consistently. In at least one embodiment, the profile ID field 605 can include a randomly generated numerical code, and/or a text string indicating a name associated with a profile. A profile ID serves to distinguish a profile record associated with a profile from a profile record associated with other profiles. Other unique identifiers of a profile may be utilized without departing from the spirit and scope of the embodiments. In at least one embodiment, a profile ID may include a description associated with a profile. Using the example illustrated in FIG. 6, ‘Profile1’ is the profile ID associated with the profile record 600.

The profile geographic info field 610 may include geographic information associated with a profile. Any type of geographic information may be indicated in the profile geographic info field 610. For example, GPS coordinates, a street address, a neighborhood name, a postal code, a city name, a state name, etc., could be indicated in the profile geographic info field 610. Using the example illustrated in FIG. 6, the geographic information ‘New Jersey’ is associated with ‘Profile1’. This may indicate, for example, that a person with a home address in and/or other profile information associated with geographic information of the state of ‘New Jersey’ may match ‘Profile1’, or may receive a higher rating and/or ranking associated with ‘Profile1’.

The profile demographic info field 615 may include demographic information associated with a profile. Any type of demographic information may be indicated in the profile demographic info field 615. For example, date of birth, sex, race, political affiliation, income, number of children, marital status, membership in organizations, etc., could be indicated in the profile demographic info field 615. Using the example illustrated in FIG. 6, the demographic information ‘under50’ AND ‘over30’ is associated with ‘Profile1’. This may indicate that a person aged greater than thirty years and less than fifty years may receive a higher rating and/or ranking associated with ‘Profile1’.

The profile personality info field 620 may include personality information associated with a profile. Any type of personality information may be indicated in the profile personality info field 620. For example, information of personality traits such as aggressiveness, curiosity, friendliness, intelligence, honesty, food preference, music preference, political affiliation, etc., could be indicated in the profile personality info field 620. Using the example illustrated in FIG. 6, the characteristic ‘Rocker’ is associated with ‘Profile1’. This may indicate that persons with an interest in rock and roll music may receive a higher rating and/or ranking associated with ‘Profile1’.

The profile guide ID field 625 may include information of a number of guides associated with a profile. For example, if a guide elects to receive requests associated with ‘Profile1’, or if profile information of a guide matches ‘Profile1’, an identifier of the guide may be indicated in the profile guide ID field 625. Information indicated in the profile guide ID field 625 may be used to obtain information associated with a guide using a record such as the guide record 400 (FIG. 4). Using the example illustrated in FIG. 6 ‘Guide1’, ‘Guide3’, ‘Guide2’, ‘Guide4’, and ‘Guide5’ have been associated with ‘Profile1’.

The profile guide rating field 630 may include information regarding a rating of a guide associated with a profile. In at least one embodiment, the profile guide ID field 625 and the profile guide rating field 630 are linked by, for example, a pointer. Using the example illustrated in FIG. 6, ‘Guide1’ has a rating of ‘2’, ‘Guide3’ has a rating of ‘2’, ‘Guide2’ has a rating of ‘1’, ‘Guide4’ has a rating of ‘3’ and ‘Guide5’ has a rating of ‘3’. Content of the profile guide ID field 625 and the profile guide rating field 630 may be used at least in part to determine an order in which a guide is notified responsive to a request, a voting activity, a review activity, and/or other types of tasks and/or activities associated with a profile. Using the example illustrated in FIG. 6, ‘Guide2’ might be preferentially notified of a request associated with ‘Profile1’. Any number of guides may be associated with a profile.

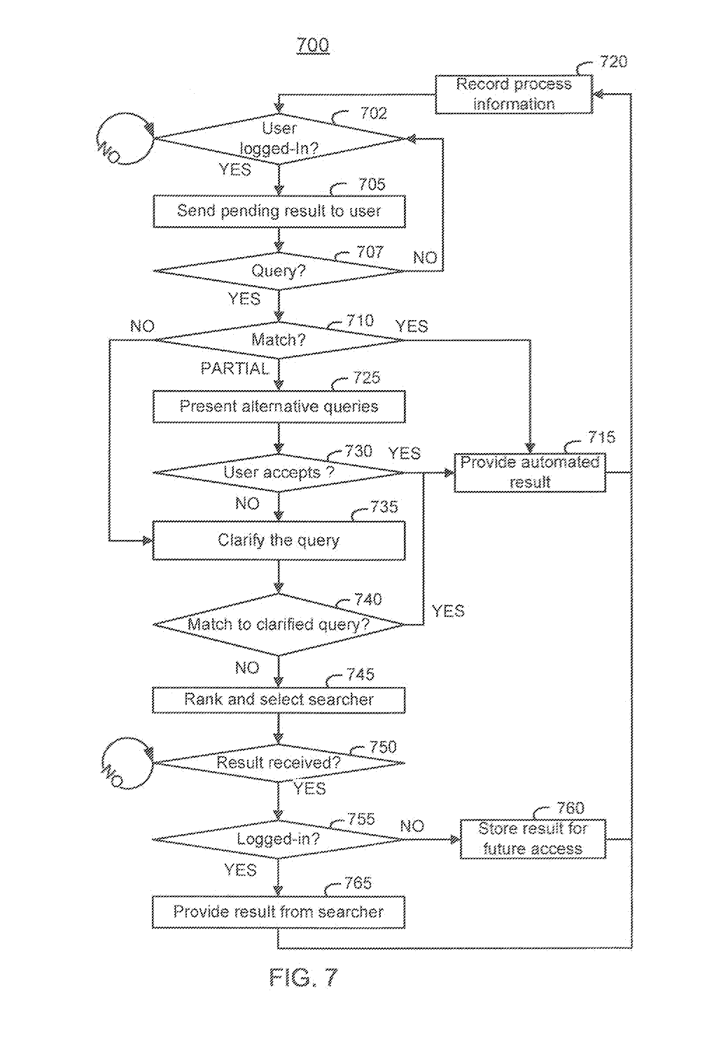

As illustrated in FIG. 7, a process 700 for performing an information search is provided. The process 700 may be operative in whole or in part on any suitable elements of the system 100 (FIG. 1). In at least one embodiment, the process 700 is operative on a server associated with the search system 130 (FIG. 1).

In operation 702 (FIG. 7), a determination is made as to whether a user is logged-in. If it is determined in operation 702 that a user is not logged-in, control remains at operation 702 and process 700 continues to wait. If it is determined in operation 702 that a user is logged-in, control is passed to operation 705 and process 700 continues.

The determination in operation 702 may be made based on various criteria. A user may be determined to be logged-in based on presence information associated with any or all communication services and/or devices of the user. A user may be determined to be logged-in when a device associated with a user is accessible using a communication service such as IM associated with a user. If a user may receive an SMS message, it may be determined that a user is logged-in. If a user connects to the search system 130 using a login ID and password, it may be determined that a user is logged-in.

In operation 705, a pending search result is presented to a user. In operation 705, determination is made as to whether a pending result exists in relation to the user determined to be logged-in in operation 702, and when determining that the pending result exists, the pending result is presented to the user in operation 705. User rating information may be obtained, and the database 120 (FIG. 1) may be updated to reflect information provided to the user, rating information, time information, etc. An advertisement and/or other information may be presented to a user before, during and/or after any or all search results are presented to a user. A user may be presented with information in any format which is suitable for a device associated with a user. A result and/or an advertisement may be presented using one or more devices. The same or different information may be presented to a user at different times, based on conditions such as a device accessible to the user and/or the search system 130. For example, a user may be presented with an SMS message relating to a search result, and may subsequently be presented with a URL associated with a search result when accessing the search system 130 using a browser functionality of a user device. Control is passed to operation 707 and process 700 continues.

In operation 707 (FIG. 7), a determination is made as to whether a request is received. If it is determined in operation 707 that a request is not received, control is passed to operation 702 and process 700 continues. If it is determined in operation 707 that a request is received, control is passed to operation 710 and process 700 continues.

In operation 710, a determination is made as to whether a query (a request) matches an existing request. If it is determined in operation 710 that a query exactly matches an existing query, control is passed to operation 715 and process 700 continues. If it is determined in operation 710 that a partial match is found to an existing query, control is passed to operation 725 and process 700 continues. If it is determined in operation 710 that no match is found to an existing query, control is passed to operation 735 and process 700 continues.

The determination in operation 710 may be made based on various criteria. In at least one embodiment, a query may be compared to a database of existing queries indicated in the database 120 (FIG. 1). For example, semantic analysis, stemming, keyword matching, etc., may be used to determine if a query matches an existing query. Likewise, a query may be compared to templates such as regular expressions (RegEx) in order to determine whether an automated response can be provided to a request.

In operation 715, an automated response is provided to a user. A user ID and/or other information associated with a user entering a query associated with the query. A targeted advertisement may be presented to a user. An order of presentation of a result may be determined based on rating and/or ranking information associated with the search result. Control is passed to operation 720 and process 700 continues.

In operation 720, information of the process 700 is recorded. A rating of a search result may be obtained and stored. Information of items such as a guide, a result, an advertisement, a resource, a succinct query, a user, a category, a keyword, a profile, etc., associated with processing of a request may be stored. In at least one embodiment, information of the process 700 is recorded in the database 120 (FIG. 1). Control is passed to operation 702 and process 700 continues.

In operation 725, an alternative query determined to partially match a query submitted by a user may be presented to the user and/or a guide. Any number of queries and/or search results may be provided. For example, a user may be presented with a closest matching query and a result. Similarly, a guide may be presented with a query and/or a search result, which a guide may select to send to a user. Control is passed to operation 730 and process 700 continues.

In operation 730, a determination is made as to whether a query is accepted. If in operation 730 it is determined that a query is accepted, control is passed to operation 715 and process 700 continues. If in operation 730 it is determined that a query is not accepted, control is passed to operation 735 and process 700 continues.

The determination in operation 730 may be made based on various criteria. For example if a user actively accepts a recommended query by, for example, activating a GUI control associated with the query, it may be determined that a query is accepted. If a guide selects a query, or if a user does not reject a response to a query, it may be determined that a query is accepted.

In operation 735, a query is clarified. A parsing operation may be performed to extract a keyword and/or category associated with the query. In at least one embodiment the parsing and categorization may be done by the search system 130 (FIG. 1). In at least one embodiment the parsing and categorization may be performed by a human guide (i.e., an expediter). Interaction between a guide and an information seeker may occur to clarify the intent of a query. For example, a first guide may respond to a query with a request for clarification, and a second guide may determine a clarified request. In operation 735 (FIG. 7) a categorized and/or rephrased query is preferably obtained and a category and/or keyword may be associated with a query. In a preferred embodiment, a categorization and/or a keyword selected by a human guide are compared to an algorithmic selection by the search system 130 (FIG. 1) to provide feedback to the algorithmic selection system. Control is passed to operation 740 and process 700 continues.

In operation 740, a determination is made as to whether a clarified query matches an existing query. If in operation 740 it is determined that a query matches an existing query, control is passed to operation 715 and process 700 continues. If in operation 740 it is determined that a query does not match an existing query, control is passed to operation 745 and process 700 continues.

The determination in operation 740 may be made using similar criteria to the determination in operation 710. In at least one embodiment, the criteria may be modified based on whether a human assistant has participated in processing a request.

In operation 745, a searcher is ranked and selected. A guide may be selected based on various criteria. In at least one embodiment, a guide is selected based at least in part on a ranking of a guide associated with a category associated with a request. A ranking of a guide may be based on any combination of a category, a profile, a keyword, an affiliation, a user, etc., which is associated with a request. Selection of a guide may be based on ranking, timing, and/or other factors associated with the guide and a request. Control is passed to operation 750 and process 700 continues.

In operation 750, a determination is made as to whether a search result is received. If in operation 750 it is determined that a search result is not received, control remains at operation 750 and process 700 continues. If in operation 750 it is determined that a search result is received, control is passed to operation 755 and process 700 continues.

The determination in operation 750 may be made based on various criteria. In at least one embodiment, if a message is received by the search system 130 from a guide system indicating a search result, it may be determined that a result is received. In at least one embodiment, if a search result is not received within a predetermined time period, a query may be submitted to an automated search resource, and it may be determined that a search result is returned. Any suitable criteria may be used to determine if a search result is returned.

In operation 755, a determination is made as to whether a user is logged-in. If it is determined in operation 755 that a user is not logged-in, control is passed to operation 760 and process 700 continues. If it is determined in operation 755 that a user is logged-in control is passed to operation 765 and process 700 continues.

In operation 765, a search result is provided to a user. User rating information may be obtained and recorded. In at least one embodiment, the database 120 (FIG. 1) is updated with information of a result and a user rating. Control is passed to operation 720 and process 700 continues.

In operation 760, a search result is stored for future access. In at least one embodiment, a result associated with a query and an identifier of the query posted to storage associated with the user. For example, a result may be stored in the database 120 (FIG. 1) with an indicator that a search result for a query is pending transmission to a user. Control is passed to operation 720 and process 700 continues.

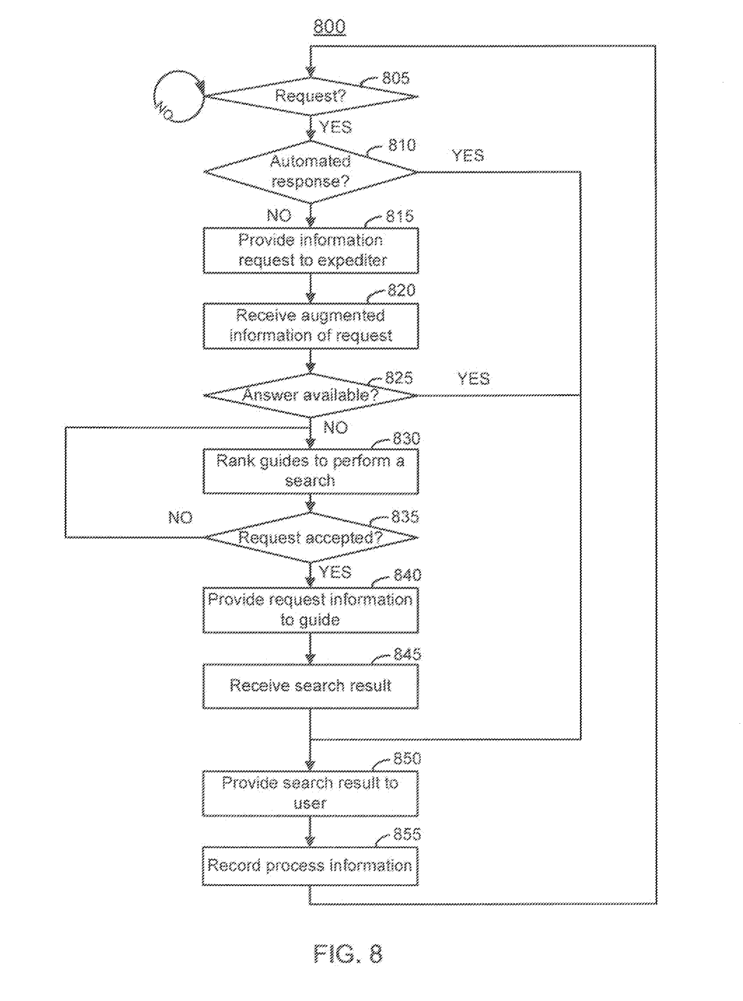

As illustrated in FIG. 8, a process 800 for performing an information search from the perspective of a server associated with the search system 130 (FIG. 1) is provided. In at least one embodiment, the process 800 is operative on the search system 130 (FIG. 1).

In operation 805 (FIG. 8), a determination is made as to whether a request is received. If it is determined in operation 805 that a request is not received control remains at operation 805 and process 800 continues. If it is determined in operation 805 that a request is received control is passed to operation 810 and process 800 continues.

In operation 810, a determination is made as to whether an automated response to a request is found. If it is determined in operation 810 that an automated response to a request is not found, control is passed to operation 815 and process 800 continues. If it is determined in operation 810 that an automated response to a request is found control is passed to operation 850 and process 800 continues. The determination in operation 810 may be made based on various criteria. For example, if content of a request is determined to match a previous request, if a request includes a keyword associated with an automated response, if a pattern matching a request is detected, etc. it may be determined that an automated response to a request is found.

In operation 815, information of a request is provided to an expediter. An expediter is selected to process a request and information of the request is provided. In at least one embodiment, automated processing is performed to associate a category, a profile, a location with a request. A transcription may be performed automatically and/or using the assistance of a human transcriber. A guide may perform any or all processing of a request in operation 815. Control is passed to operation 820 and process 800 continues.

In operation 820, augmented information of a request is received. In at least one embodiment, information of a request is provided from a guide system. In at least one embodiment, a resource may provide information of a request. Automated and/or human assisted resources may provide information of a request. Control is passed to operation 825 and process 800 continues.

In operation 825, a determination is made as to whether an answer to a request is available. If it is determined in operation 825 that an answer to a request is not available, control is passed to operation 830 and process 800 continues. If it is determined in operation 825 that an answer to a request is available control is passed to operation 850 and process 800 continues. The determination in operation 825 may be made based on various criteria. For example, if content of a request is determined to match a previous request, if a guide has indicated a response, if an automated resource indicates that a request may be answered automatically, etc. it may be determined that an answer to a request is available.

In operation 830, guides are ranked. Guides may be ranked based on any information which may be associated with a request. In at least one embodiment, guides may be ranked based on a category, a keyword, and a profile associated with a request. A highest ranking guide may be notified of a request. If a highest ranking guide does not accept a request, a ranking of the guide may be reduced in order to select another guide. In at least one embodiment, guides are notified in rank order until a guide accepts the request. Control is passed to operation 835 and process 800 continues.

In operation 835, a determination is made as to whether a request is accepted. If it is determined in operation 835 that a request is not accepted, control is passed to operation 830 and process 800 continues. If it is determined in operation 835 that a request is accepted, control is passed to operation 840 and process 800 continues. The determination in operation 835 may be made based on various criteria. In at least one embodiment, a response from a guide may be used to determine that a request is accepted. Alternately, expiration of a time interval, notification of a number of guides, a response from a resource, etc. or any combination thereof may be used to determine that a request is accepted.

In operation 840, information of a request is provided to a guide. In at least one embodiment, information of a request may be provided to a browser of a guide system, which may include an extension associated with a search service. Information of a request may be provided to a server such as the guide tool server 165 (FIG. 1). Control is passed to operation 845 (FIG. 8) and process 800 continues.

In operation 845, a result is received. In at least one embodiment, information of a result provided by a guide system is provided to the search system 130 (FIG. 1), which includes text and a reference URL associated with a source of the text. A toolbar or extension associated with a guide system may automatically provide information associated with a search result. Control is passed to operation 850 and process 800 continues.

In operation 850, a result is provided to a user. In at least one embodiment, information of a result provided by a guide system is provided to a user device such as the user system 135 by the search system 130 (FIG. 1), by an SMS message and/or via a web page which may include text and a URL associated with a resource used to obtain the result. An advertisement may be provided to a user based on content of a search result. An automated search result and/or a guide selected result may be provided. For example, a first search result may be provided automatically and a second search result may be provided based on actions of a guide. In such an embodiment, it may be determined that an answer is available, and that an answer is not available at decision points such as operation 810 and operation 825. Control is passed to operation 855 and process 800 continues.

In operation 855, process information is recorded. In at least one embodiment, information of a search result, a user, a guide, a resource, a categorization, a profile, a keyword, and other items tracked by the search system 130 is recorded in the database 120 (FIG. 1). Control is passed to operation 805 and process 800 continues. While the process 800 has been described in the context of obtaining a single search result and selecting a single guide, no limitation is implied thereby. Any number of guides and/or search results may be utilized within the scope and spirit of the embodiments herein.

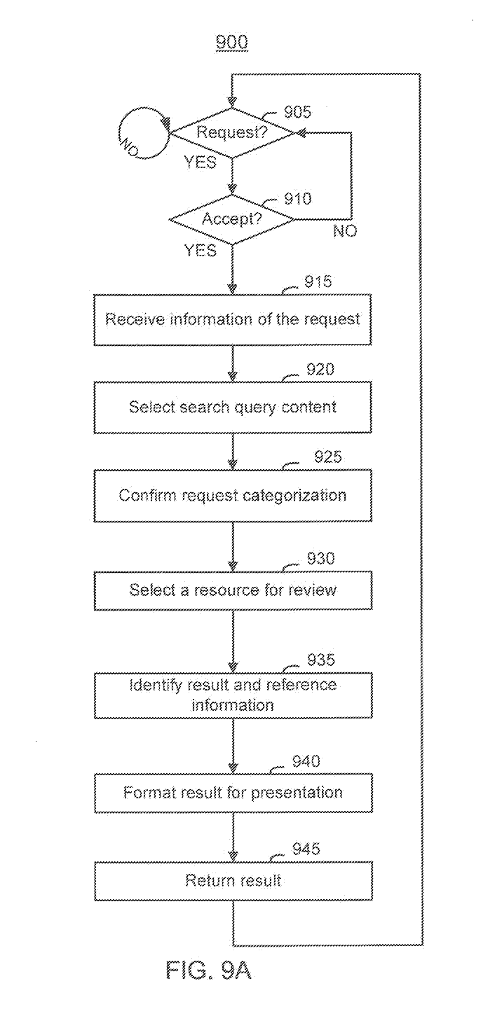

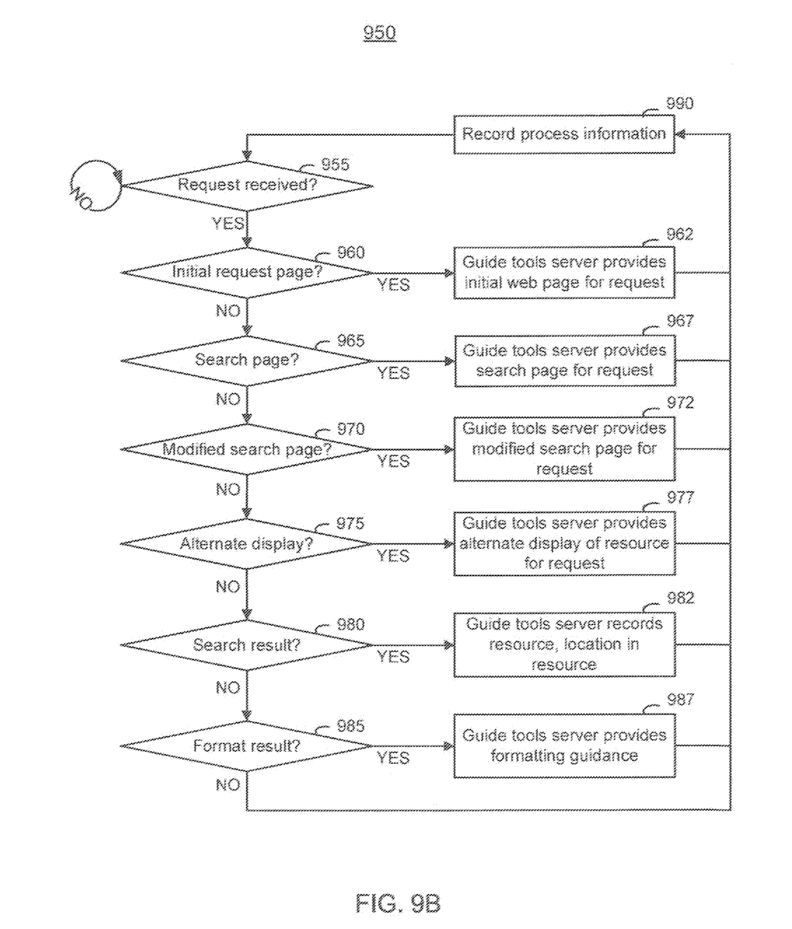

As illustrated in FIG. 9A, a process 900 for performing an information search from a guide system perspective is provided. In at least one embodiment, the process 900 is operative on the guide system 105 (FIG. 1). Actions associated with a system which may supply tools to a guide system are illustrated. In at least one embodiment, the guide tools server 165 provides the relevant information via TCP/IP or other suitable communication protocols to the guide system 105.

In operation 905 (FIG. 9A), a determination is made as to whether a request is received. If it is determined in operation 905 that a request is not received, control remains at operation 905 and process 900 continues. If it is determined in operation 905 that a request is received, control is passed to operation 910 and process 900 continues.

A guide system may determine whether a request is received using various criteria. In at least one embodiment, if a guide is logged-in to the search system 130 (FIG. 1), a message which indicates a request is available may be provided to a guide system. Any communication service associated with a guide system may be used to determine if a request is received. For example, a GSM device associated with a guide might receive an SMS message notifying the guide of a request, which might include a link which would direct a browser of the user device to information of a request when activated.

In operation 910 (FIG. 9A), a determination is made as to whether a request is accepted. If it is determined in operation 905 that a request is not accepted, control is passed to operation 905 and process 900 continues. If it is determined in operation 910 that a request is accepted control is passed to operation 915 and process 900 continues. The determination in operation 910 may be made based on various criteria. For example, a response from the search system 130, an acknowledgement by a user system, an acknowledgement by the search tools server 165 (FIG. 1), etc. may be used to determine that a request is accepted. In at least one embodiment, a message from a guide system to the search system 130 may be used to determine that a request is accepted.

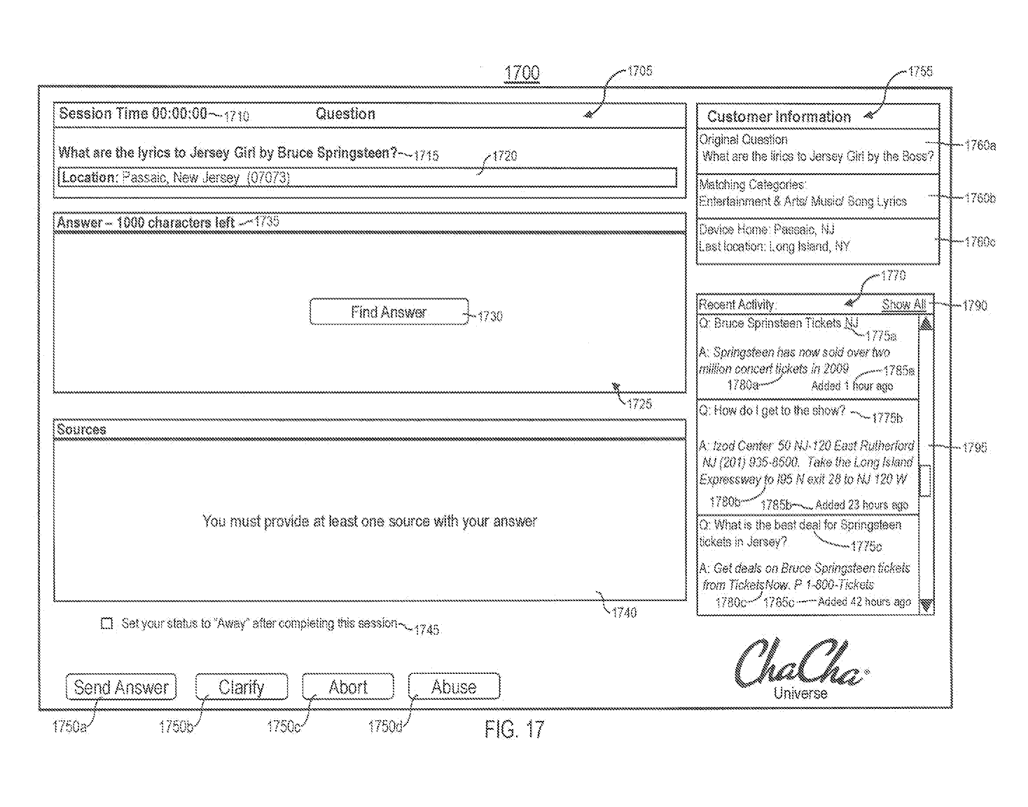

In operation 915, information of a request is received. In at least one embodiment, a web page provided by the guide tools server 165 (FIG. 1) may be provided. A guide system may receive information which may cause a GUI such as the GUI 1700 (FIG. 17) to be presented. Information of a request may include a categorization, content of a request, a profile, historical information, search resources, search results, and/or other information as further described herein. Control is passed to operation 920 and process 900 continues.

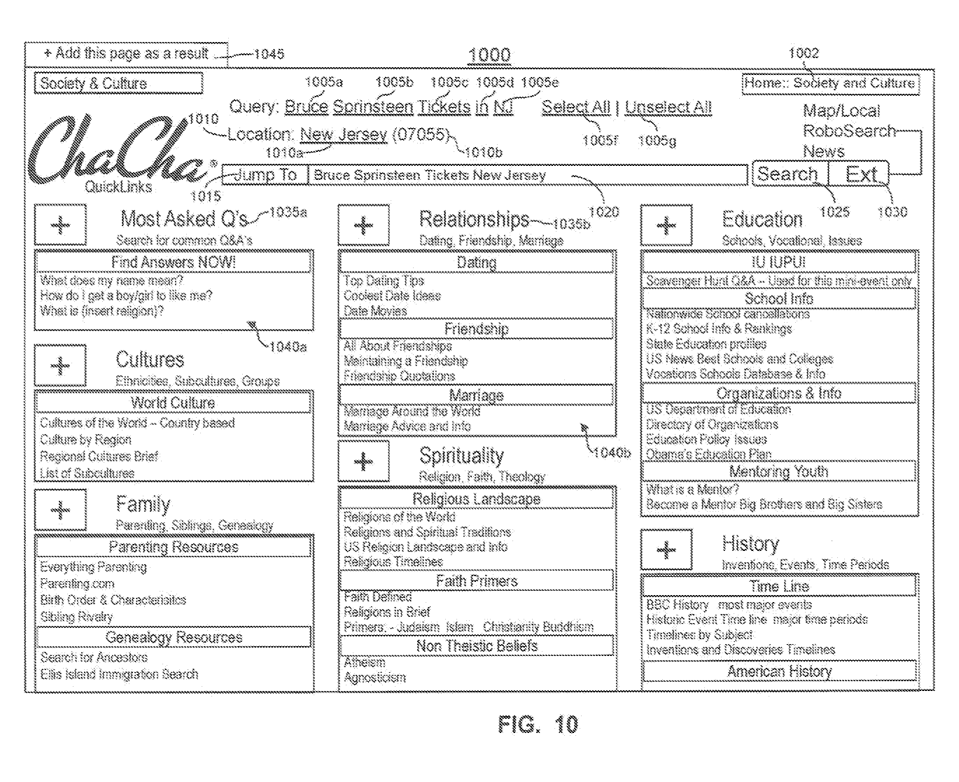

In operation 920 search query content is selected. In at least one embodiment, a guide may select elements of a request such as text, audio, profile information, historical query and/or answer information, etc. Query content may be selected using, for example, the GUI 1000 (FIG. 10). Control is passed to operation 925 and process 900 continues.

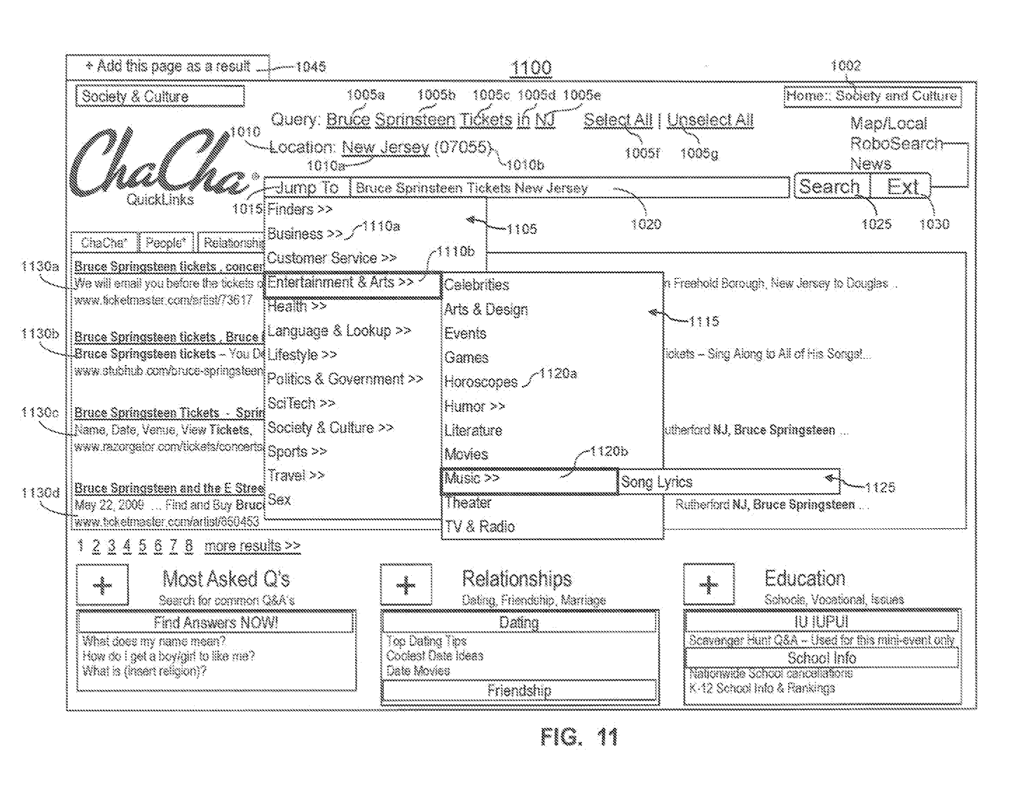

In operation 925, a categorization associated with a request is confirmed. In at least one embodiment, a guide may modify a categorization associated with a request using a GUI such as the GUI 1100 (FIG. 11). A guide may, for example, obtain information of an element of a request to confirm a categorization associated with a request. In at least one embodiment the guide tools server 165 (FIG. 1) may provide a web page associated with a request to a guide system, and may generate search requests responsive to information provided by a guide system. Control is passed to operation 930 (FIG. 9A) and process 900 continues.

In operation 930, a resource is selected by a guide for review. In at least one embodiment, a guide may select a resource which is rendered in a format selected by the guide tools server 165 (FIG. 1) and/or a guide system. A web page provided per a selection by a guide may be rendered with some types of features suppressed and/or enhanced, which may assist a guide in more rapidly locating a search result. For example, content of a web page such as graphics, and/or other media which may not be delivered as an answer to a user device may be suppressed. In at least one embodiment, an extension resident in a browser application of a guide system may alter the presentation of content from a resource. Control is passed to operation 935 and process 900 continues.

In operation 935, a result is identified and reference information is obtained. In at least one embodiment, a guide may select text from a web page, and a URL associated with the page from which the text is found may be recorded by a toolbar extension of a browser. A guide may select a result using guide tools which may process information of a resource selected in operation 930. In at least one embodiment, a URL may be generated by the guide tools server 165 (FIG. 1) which may locate attention of a browser at a portion of text selected by a guide when activated. Control is passed to operation 940 (FIG. 9A) and process 900 continues.

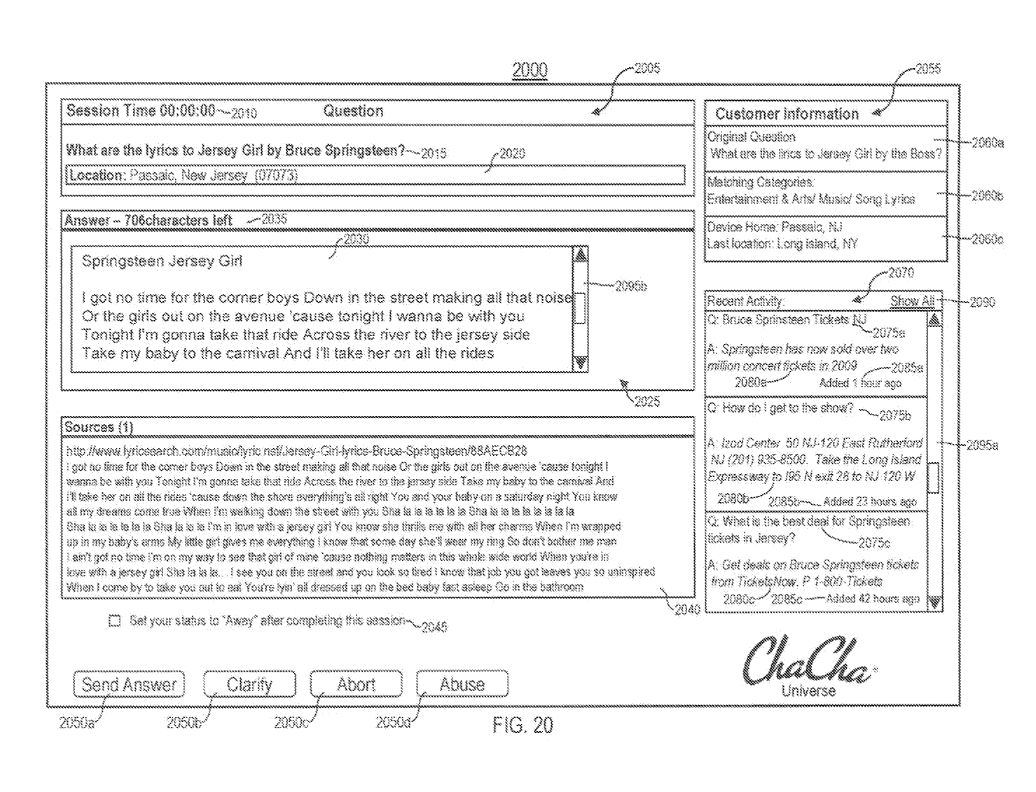

In operation 940, a result is formatted for presentation. In at least one embodiment, text selected by a guide may be formatted to conform to limitations of an SMS message using a GUI such as the GUI 2000 (FIG. 20). Any type of message formatting may be performed. The guide tools server 165 (FIG. 1) may provide guidance information such as remaining space, jargon or abbreviations, device information of a user, etc. Control is passed to operation 945 (FIG. 9A) and process 900 continues.

In operation 945, a result is returned. In at least one embodiment, a guide may indicate completion of a search using a control in a GUI such as the GUI 2000 (FIG. 20), which may transmit a message to the search system 130 (FIG. 1). Control is passed to operation 905 (FIG. 9A) and process 900 continues.

As described herein, search tools may be provided to a human searcher performing a search. In at least one embodiment, the guide tools server 165 (FIG. 1) may provide information and/or tools to a browser and/or other application operative on a guide system (e.g., the guide system 105). The guide tools server 165 may assist a searcher performing a search during a process such as the process 900 (FIG. 9A). A process 950 for providing tools to a searcher from a guide tools server perspective is illustrated in FIG. 9B. The process 950 may be operative on any suitable elements of the system 100 (FIG. 1).

In operation 955 (FIG. 9B) a determination is made as to whether a request is received. If it is determined in operation 955 that a request is not received, control remains at operation 955 and process 950 continues. If it is determined in operation 955 that a request is received, control is passed to operation 960 and process 950 continues. The determination in operation 955 may be made based on various criteria. For example, a message such as an Instant Message, an SMS, MMS, EMS, email, Internet Protocol, etc. may be received at a server associated with the guide tools server 165 (FIG. 1). In at least one embodiment, a URL may be received at a server associated with the guide tools server from a browser of a guide system.

In operation 960 (FIG. 9B) a determination is made as to whether an initial request page is requested. If it is determined in operation 960 that an initial request page is requested, control is passed to operation 962 and process 950 continues. If it is determined in operation 960 that an initial request page is not requested, control is passed to operation 965 and process 950 continues. The determination in operation 960 may be made using various criteria. In at least one embodiment, content of a message such as a URL may be examined to determine whether an initial request page is to be provided. A search tools server may track a state associated with a searcher system, and may determine whether an initial request page is requested based on a current state associated with a searcher and/or a searcher system. Content of a message, time information, searcher information, user information, and/or any information associated with a request may be used to determine whether an initial request page is requested.

In operation 962 a guide tools server provides an initial web page associated with a request. A guide tools server may provide an initial request web page using any communication services available. For example, IM, SMS, TCP/IP, wireless, etc. may be used to provide information to a system which has submitted a request. In at least one embodiment, a user may submit a request to a guide tools server. An initial web page may be a GUI such as the GUI 1700 (FIG. 17). Control is passed to operation 990 (FIG. 9B) and process 950 continues.

In operation 965 a determination is made as to whether a search page is requested. If it is determined in operation 965 that a search page is requested, control is passed to operation 967 and process 950 continues. If it is determined in operation 965 that a search page is not requested, control is passed to operation 970 and process 950 continues. The determination in operation 965 may be made using various criteria. In at least one embodiment, content of a message such as a URL may be examined to determine whether a search page is to be provided. A state associated with a searcher and/or a searcher system may be maintained or traced or tracked, and may determine whether a search page is requested based on a state associated with a searcher and/or a searcher system. Content of a message, time information, searcher information, user information, and/or any information associated with a request may be used to determine whether a search page is requested.

In operation 967 a guide tools server provides a search page associated with a request. A search page may include search results obtained responsive to submission of a query to a plurality of resources associated with a category of the query. A guide tools server may create a web page as a tool to be provided to a guide. A guide tools server may provide a search page using any communication services available. For example, IM, SMS, TCP/IP, wireless, etc. may be used to provide information to a system which has submitted a request. In at least one embodiment, a user may submit a request to a guide tools server. A search page may be a GUI such as the GUI 1000 (FIG. 10). Control is passed to operation 990 (FIG. 9B) and process 950 continues.

In operation 970 a determination is made as to whether a modified search page is requested. If it is determined in operation 970 that a modified search page is requested, control is passed to operation 972 and process 950 continues. If it is determined in operation 970 that a modified search page is not requested, control is passed to operation 975 and process 950 continues. The determination in operation 970 may be made using various criteria. In at least one embodiment, content of a message such as a URL may be examined to determine whether a modified search page is to be provided. A state associated with a searcher system may be tracked, and may determine whether a modified search page is requested based on a state associated with a searcher and/or a searcher system. Content of a message, time information, searcher information, user information, and/or any information associated with a request may be used to determine whether a modified search page is requested.

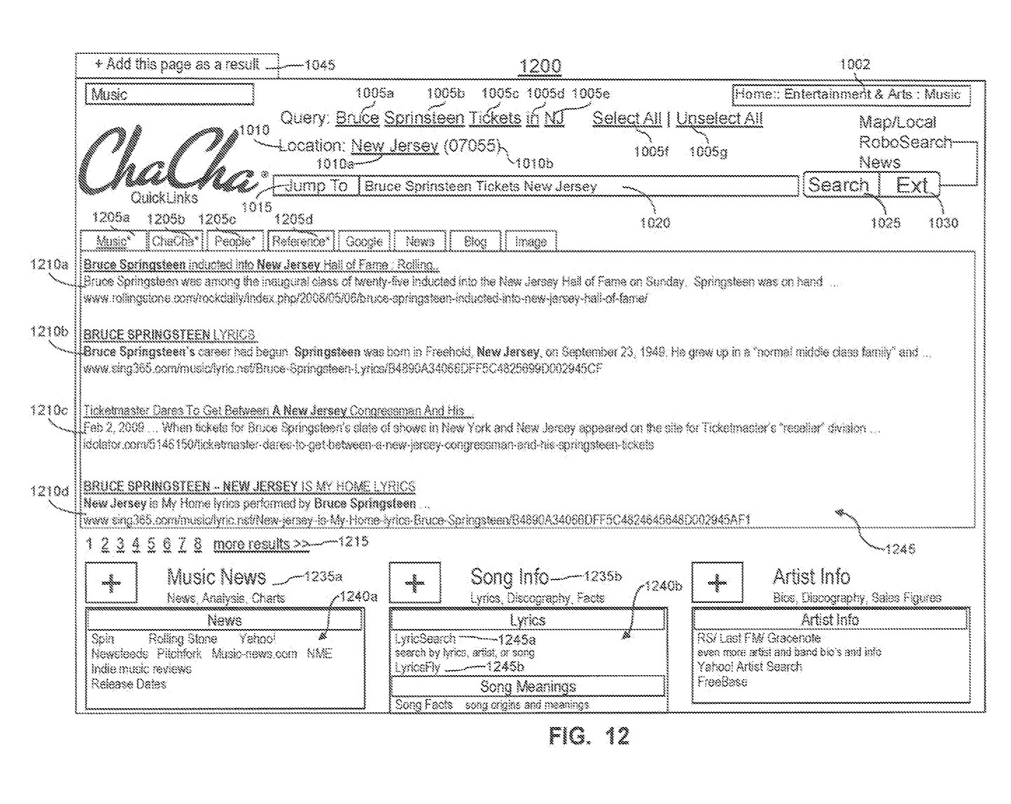

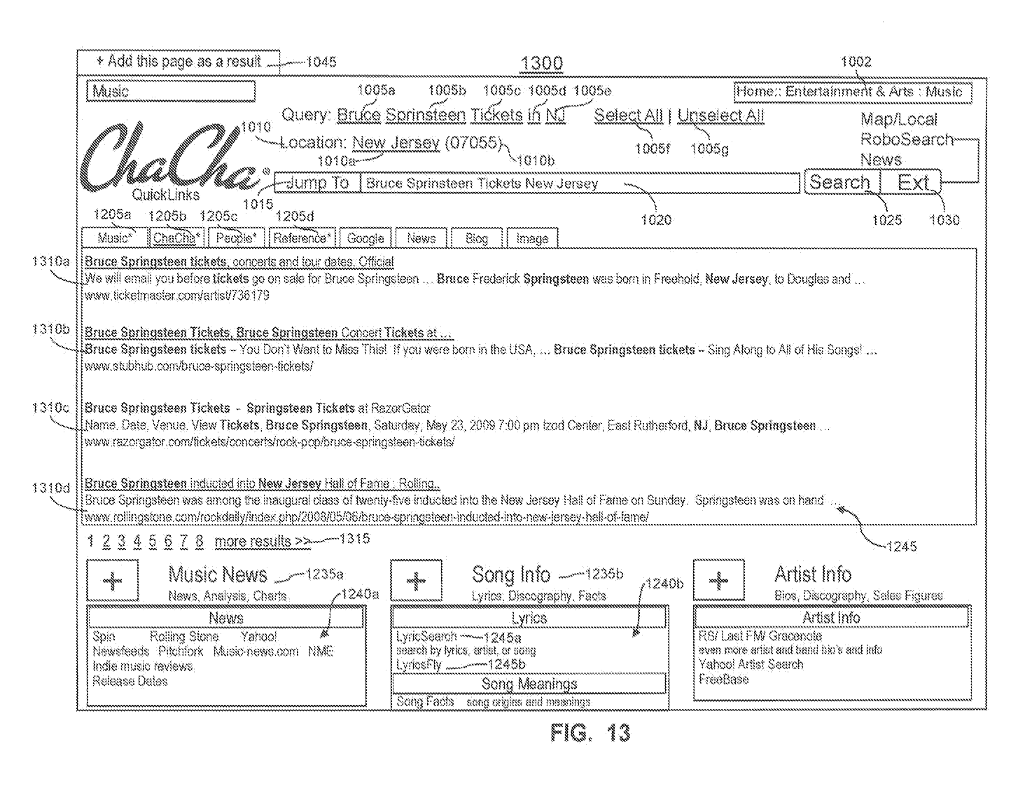

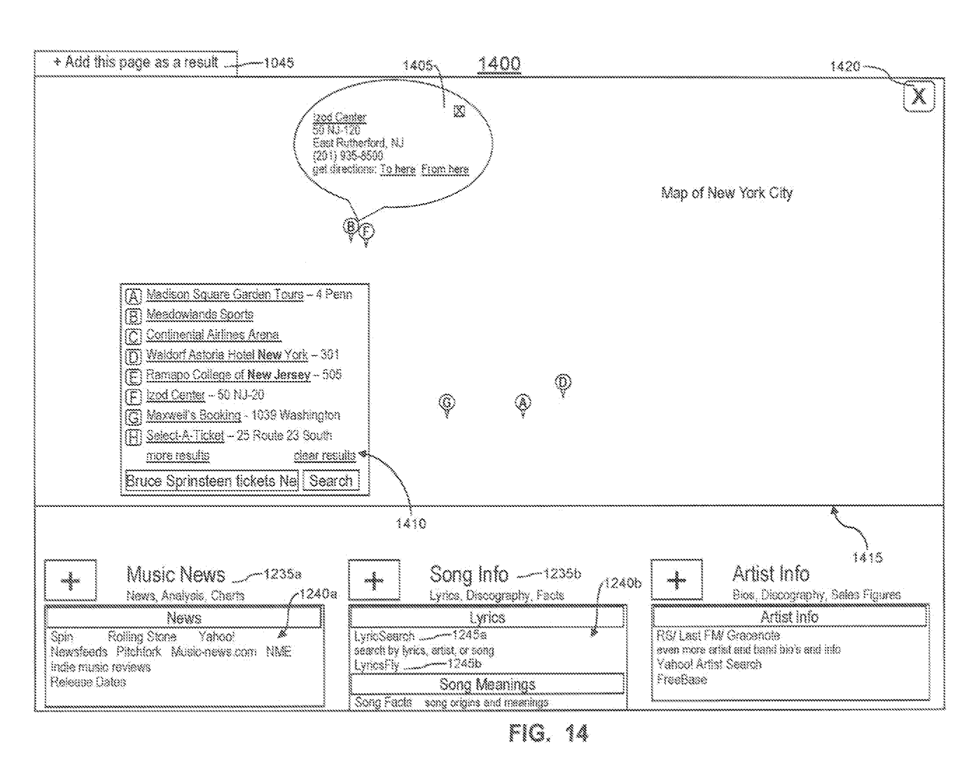

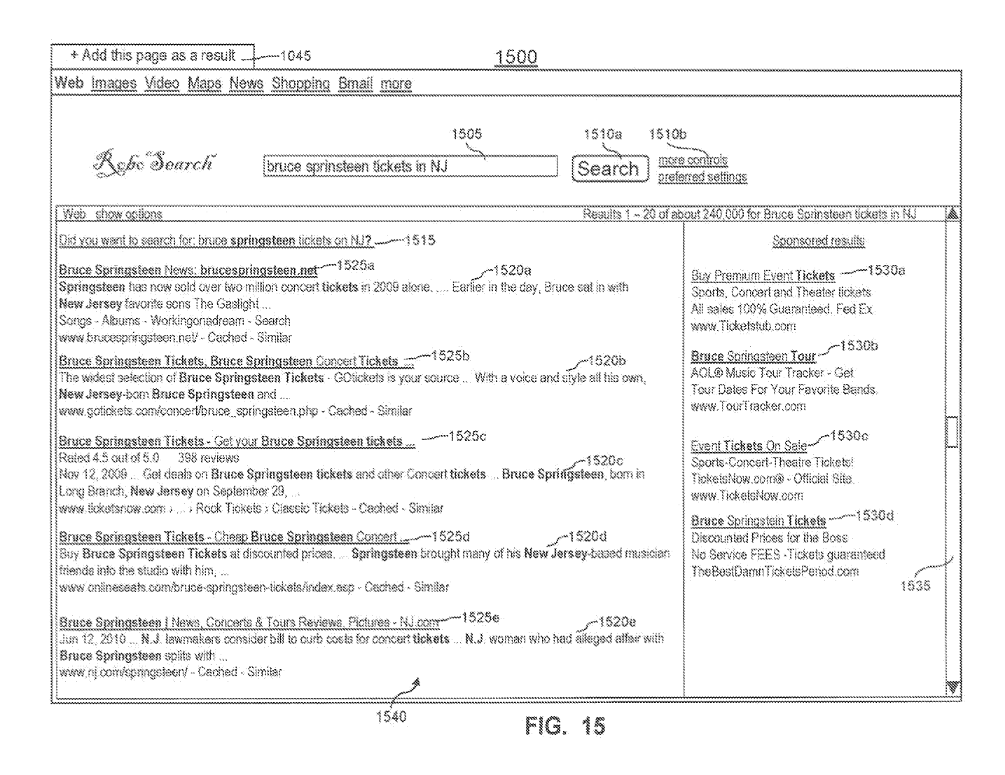

In operation 972 a guide tools server provides a modified search page associated with a request. A modified search page may be provided to a reformulated, re-categorized, or otherwise modified request. A modified search page may be modified based on historical information. A modified search page may be generated based on alternate resources, a modified search query, a modified search algorithm, etc. as described herein. A guide tools server may provide a modified search page using any communication services available. For example, IM, SMS, TCP/IP, wireless, etc. may be used to provide information to a system which has submitted a request. In at least one embodiment, a user may submit a request to a guide tools server. A modified search page may be a GUI such as the GUI 1200 (FIG. 12), the GUI 1300 (FIG. 13), the GUI 1400 (FIG. 14), and/or the GUI 1500 (FIG. 15). Control is passed to operation 990 (FIG. 9B) and process 950 continues.

In operation 975 a determination is made as to whether an alternate display is requested. If it is determined in operation 975 that an alternate display is requested, control is passed to operation 977 and process 950 continues. If it is determined in operation 975 that an alternate display is not requested, control is passed to operation 980 and process 950 continues. The determination in operation 975 may be made using various criteria. In at least one embodiment, content of a message such as a URL may be examined to determine whether an alternate display is to be provided. A modified display may be provided based on preferences associated with a searcher, a profile, and/or a searcher system. A state associated with a searcher system may be tracked, and may determine whether a modified display is requested based on the state associated with a searcher and/or a searcher system. An extension associated with a browser of a system submitting a request may provide information regarding whether an alternate display is requested. Content of a message, time information, searcher information, user information, and/or any information associated with a request may be used to determine whether an alternate display is requested.

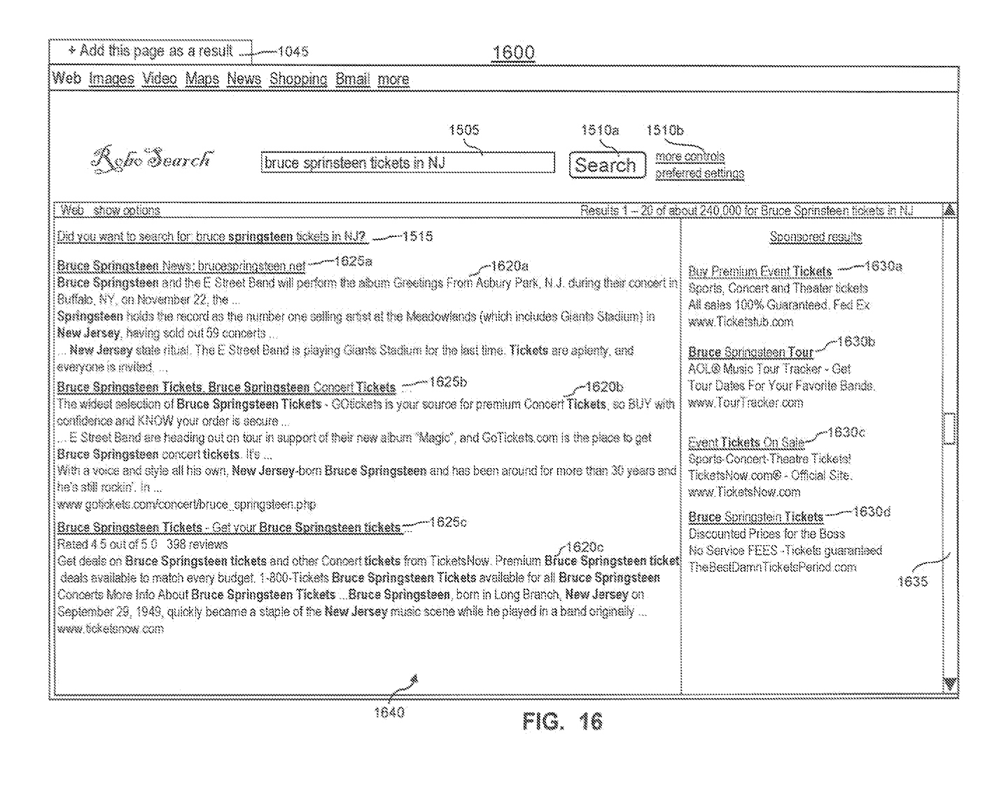

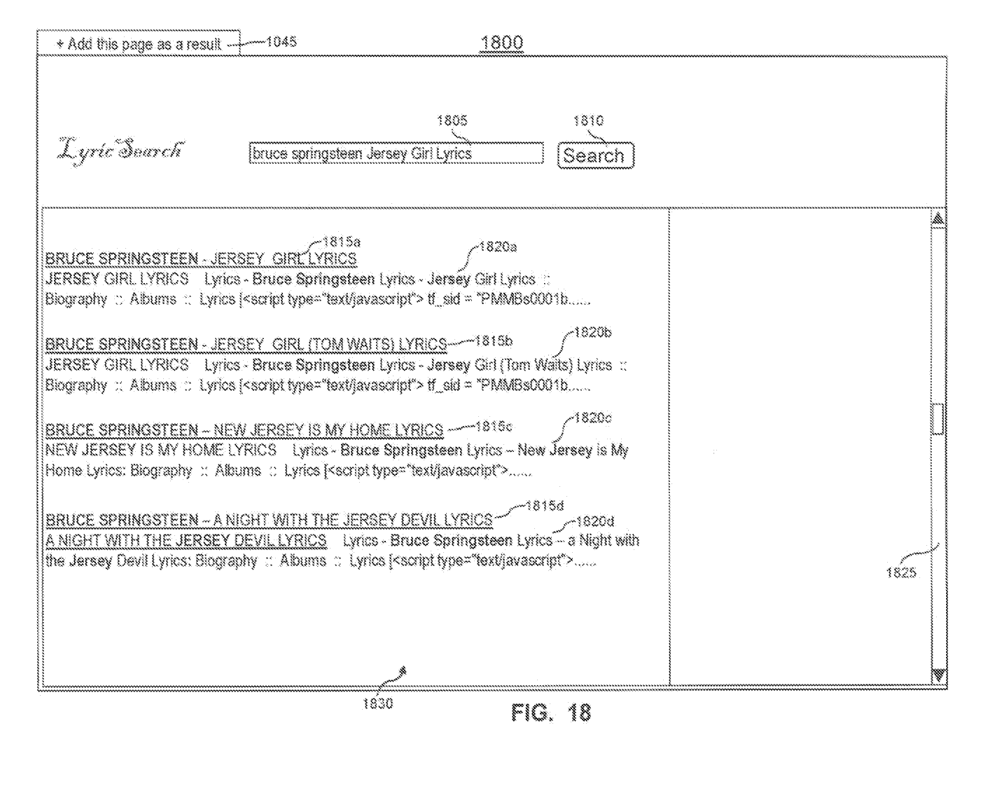

In operation 977 a guide tools server provides an alternate display of a resource for a search associated with a request. An alternate display may be provided for any information which is requested by a searcher and/or other source of a request. An alternate display may be applied to any or all resources. For example, results from a search engine, a web page provided by a resource, a blog page, a dynamically generated web page, media, etc. may be alternately displayed. A guide tools server may provide an alternate display using any communication services available. For example, IM, SMS, TCP/IP, wireless, etc. may be used to provide information to a system which has submitted a request. In at least one embodiment, a user may submit a request to a guide tools server. An alternate display of a resource may be a GUI such as the GUI 1600 (FIG. 16), and/or the GUI 1800 (FIG. 18). Control is passed to operation 990 (FIG. 9B) and process 950 continues.

In operation 980 a determination is made as to whether a search result is designated. If it is determined in operation 980 that a search result is designated, control is passed to operation 982 and process 950 continues. If it is determined in operation 980 that a search result is not designated, control is passed to operation 985 and process 950 continues. The determination in operation 980 may be made using various criteria. In at least one embodiment, content of a message such as a URL may be examined to determine whether a search result has been selected. In at least one embodiment, selection of the toolbar control 1045 (FIG. 10) may cause a message to be provided indicating that a search result has been designated. Content of a message, time information, searcher information, user information, and/or any information associated with a request may be used to determine whether a modified search page is requested.

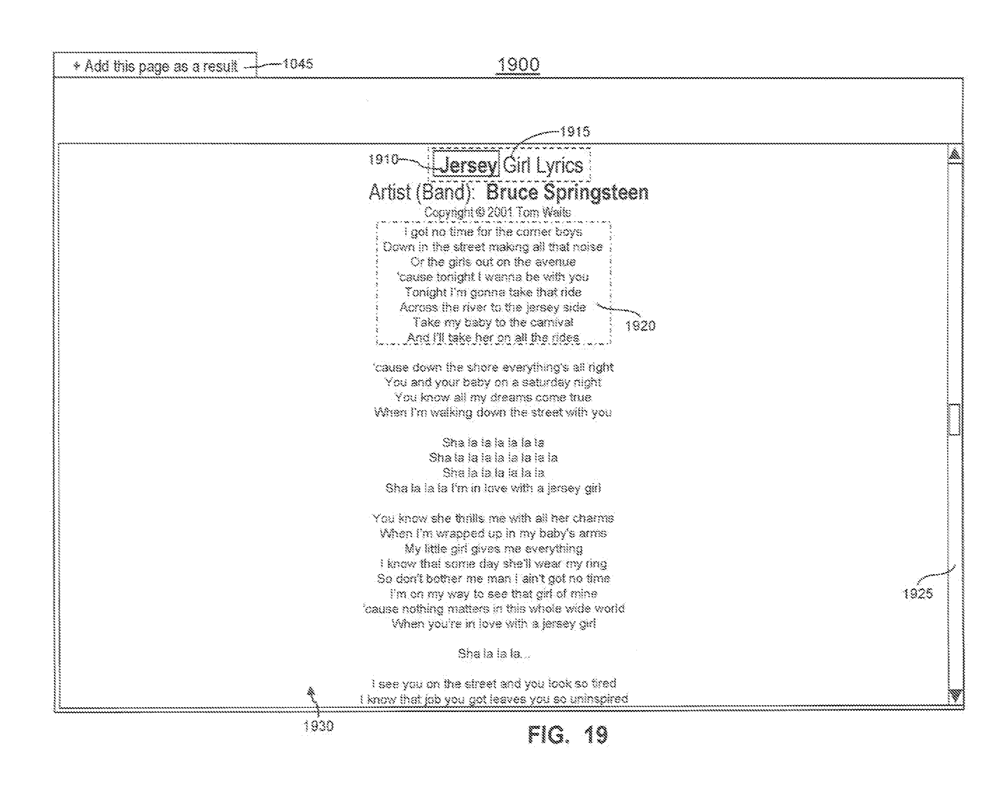

In operation 982 (FIG. 9B) a guide tools server records a resource, and a location of a search result. A resource location may be recorded as a URL associated with the GUI 1900 (FIG. 19), a location of features such as selected response indicator 1920, graphics, code, and/or any content provided by the resource, etc., which may be provided as a search result and/or provided responsive to a request. Control is passed to operation 990 (FIG. 9B) and process 950 continues.

In operation 985 a determination is made as to whether a formatting tool is requested. If it is determined in operation 985 that a formatting tool is requested, control is passed to operation 987 and process 950 continues. If it is determined in operation 985 that a formatting tool is not requested, control is passed to operation 990 and process 950 continues. The determination in operation 985 may be made using various criteria. In at least one embodiment, content of a message such as a URL may be examined to determine whether a formatting tool is requested. In at least one embodiment, selection of the toolbar control 1045 (FIG. 10) may cause a message to be provided indicating that a formatting tool is requested. A state associated with a searcher and/or a searcher system may be evaluated or tracked to determine whether a formatting tool is requested. Content of a message, time information, searcher information, user information, and/or any information associated with a request may be used to determine whether a modified search page is requested.

In operation 987 (FIG. 9B) a guide tools server provides formatting guidance. Information associated with a designated search result may be provided responsive to a request for formatting guidance. In at least one embodiment, the GUI 2000 (FIG. 20) is provided to as formatting guidance. Assistance may be provided to convert a response from one form to another, such as translation, transcription, text to speech, etc. Control is passed to operation 990 (FIG. 9B) and process 950 continues.

In operation 990 process information is recorded. Information associated with a system submitting a request, a type of request, a response provided, a modification history, time, resources used, resources selected, search results provided, designated, rejected, etc., a user, a guide, an advertisement, a display, a modification to a search result, etc. may be recorded. In at least one embodiment, information of the process 950 may be recorded in the database 120 (FIG. 1). Control is passed to operation 955 (FIG. 9B) and process 950 continues.

A GUI 1000 of an exemplary guide tool is illustrated in FIG. 10. The GUI 1000 may be provided to a guide system if a request is accepted. The GUI 1000 may include a category indicator 1002, query controls 1005, location indicators 1010, a category change control 1015, a query box 1020, a search control 1025, a Quick Pass control 1030, resource group indicators 1035, resource group windows 1040, and a toolbar control 1045

The category indicator 1002 may be used to indicate a category currently associated with a query and resources provided. As illustrated in FIG. 10, the category ‘Society and Culture’ is associated with the request ‘Bruce Springsteen Tickets in NJ’ as indicated in the query controls 1005. A category indicated by the category indicator 1002 may be selected based on various criteria including but not limited to by the search system 130 (FIG. 1), by a user submitting a request, by an expediter who initially receives the request for redirecting the request to a pertinent destination for handling, etc. In at least one embodiment, a category associated with a query is determined automatically. The query controls 1005 may be used to select any or all elements of a query. For example activation of the query controls 1005a and 1005b may transfer ‘Bruce’ and ‘Sprinsteen’ to the query box 1020. The query control 1005f may transfer all of a query to the query box 1020. The query controls 1005g may clear the query box 1020. The location indicators 1010 may be used to transfer location information to the query box 1020. The location indicator 1010a transfers ‘New Jersey’, and the location indicator 1010b transfers “07055’ to query box 1020.

The category change control 1015 may be used to change a category associated with a query. The search control 1025 may be used to provide information of search results obtained from resources associated with a category using information provided using the GUI 1000. The query box 1020 indicates information of a current query which may be passed to resources using the GUI 1000. The Quick Pass control 1030 may be used to direct a search query indicated in the query box 1020 to a number of external resources, as further explained herein. The resource group indicators 1035 may indicate a topic or subcategory associated with resources provided in the resource group windows 1040. As shown in FIG. 10, a GUI 1000 is presented to correspond to the request ‘Bruce Sprinsteen Tickets in NJ’ which may be additionally customized as shown in FIGS. 12 and 13 as category identified in association therewith changes.

Further, the probability that a category will be associated with a query may be modified over time based on search history information or other condition(s). For example, if the search system 130 (FIG. 1) determines that a particular categorization of a subject matter of a request has previously resulted in returning of an optimal result, the search system 130 may modify a category associated with request(s) of the subject matter.

A GUI 1100 for use of the category change control 1015 is illustrated in FIG. 11. Activation of the category change control 1015 may cause the category selection window 1105 to be provided in order to view available categorizations. For example, if the query ‘Bruce Sprinsteen Tickets New Jersey’ might be better classified the ‘Jump’ control 1015 may be activated. A top level category may be selected. For example a ‘Business’ category indicator 1110a or a ‘Entertainment & Arts’ category indicator 1110b might be selected. Selection of the ‘Entertainment &Arts’ category indicator 1110b may cause a subcategory selection menu 1115 to be provided. The subcategory selection menu 1115 associated with ‘Entertainment & Arts’ may provide a ‘Horoscopes’ subcategory indicator 1120a and a ‘Music’ subcategory indicator 1120b to be provided. Selection of the ‘Music’ subcategory indicator 1120b may cause a subsubcategory selection menu 1125 to be provided. Selection of the ‘Music’ subcategory indicator 1120b may cause the query indicated in the query box 1020 to be transmitted to resources associated with the new category ‘Entertainment & Arts: Music’. If the search control 1025 has not been activated, the search result indicators 1130 may continue to provide information of results associated with ‘Society and Culture’. In a preferred embodiment, the GUI 1100 is updated immediately when a new category and/or subcategory is selected.

A GUI 1200 for processing of a request is illustrated in FIG. 12. The GUI 1200 may be provided if the search control 1025 is activated responsive to selection of a new category using the GUI 1100. Activation of the search control 1025 may cause custom search results tabs 1205 to be displayed or suppressed. The custom search tabs 1205 may include custom search result indicators 1210. Any number of custom search tabs 1205 may be provided. Content of the custom search tabs 1205 may be determined based on information associated with a categorization as further described herein above with respect to FIG. 2. The ‘Music’ custom search result tab 1205a may display search results obtained by submitting the query in the query box 1520 to a ‘Music’ Custom Search Engine (CSE). The CSE tab 1205b may provide information of results from a ‘ChaCha’ CSE. The CSE tab 1205c may provide information of results from a ‘People’ CSE, etc. A selected custom search tab 1205 may be indicated in any suitable manner. For example, the underlining in FIG. 12 indicates that the ‘Music*’ custom search result tab 1205a is active.

The custom search result indicator 1210a indicates ‘New Jersey Hall of Frame’. The custom search result indicator 1210b indicates ‘LYRICS’. The custom search result indicator 1210c indicates ‘New Jersey Congressman’, etc. The additional results control 1215 may be used to review additional search results from a CSE associated with an active custom search result tab 1205. It is important to note that the search results indicated in the custom search result indicators 1210 are different from the search results indicated in the search result indicators 1130 (FIG. 11). Further the order of the CSE tabs 1205 may vary based on a category and/or query selected.

Selection of the ‘ChaCha’ CSE tab 1205b may cause a GUI 1300 illustrated in FIG. 13 to be provided. The search results indicated in the CSE search result indicators 1310 indicate results obtained from the ‘ChaCha’ CSE, which may be different from those obtained from the ‘Music’ CSE. The custom search result indicator 1310a indicates ‘Bruce Springsteen tickets’. The custom search result indicator 1310b indicates ‘Concert tickets’. The custom search result indicator 1310c indicates ‘Razor Gator’, etc. The additional results control 1315 may be used to review additional search results from the ‘ChaCha’ CSE. As illustrated, the different focus of each CSE produces different results, which may allow a guide to rapidly view multiple results from different types of algorithmic searches of different resources without needing to submit the same query to each resource.

Activation of the Quick Pass control 1030 may cause a query to be passed to a mapping resource and may cause a GUI 1400 illustrated in FIG. 14 to be provided. The GUI 1400 allows a guide to obtain location information and/or a search result associated with a location. For example a guide may directly pass a query to a mapping resource, or may pass a location associated with a query to a mapping resource to obtain further information associated with a request. The mapping GUI 1400 may include a map window 1415 which may show typical types of map information such as is provided by Google or AOL. A location indictor 1405 may provide a location and links which may be used by a guide to access information of a search result. A locations pick list 1410 may be used to select alternate locations. A closure control 1420 may be used to close the GUI 1400 and return to a previous GUI.

Activation of the Quick Pass control 1030 (FIG. 10) may cause a query in the search box 1020 to be passed to an external resource. This may cause the GUI 1500 illustrated in FIG. 15 to be provided. For example, the query ‘Bruce Sprinsteen New Jersey’ is directly passed to the ‘RoboSearch’ search engine as indicated in a query box 1505. A search control 1510a has already been activated as indicated by the presence of a query suggestion indicator 1515. Search result indicators 1525 provide hyperlinks to search results, search text snippets 1520 indicate text associated with a search result, sponsored link indicators 1530 indicate sponsored search results. For example, the guide tools server 165 (FIG. 1) might create a URL including the query string which is passed to a server associated with the ‘RoboSearch’ search engine. The search controls 1510b might be used to customize search parameters associated with the ‘RoboSearch’ search engine. In at least one embodiment, the search system 130 and/or the search tools server 165 may store settings selected by a guide associated with customization of a search resource which may persist when a guide uses the resource for future search activities. Navigation controls 1535 may be used to navigate within the content of the search results window 1540.

If a guide has established a set of preferences associated with a search resource, when a query is submitted to the resource content of the resource may be rendered according to the preferences of the guide. For example, if a guide has selected that extended descriptive text associated with search results is to be provided, a GUI 1600 (FIG. 16) may be provided responsive to selection of the Quick Pass control 1030 and the ‘RoboSearch’ option. As illustrated, the content of the query box 1505 and the query suggestion indicator are identical. Likewise, expanded search result indicators 1625 point to the same search result as the corresponding search result indicators 1525 (FIG. 15). However, expanded search text snippets 1620 may include additional information, which may allow a human searcher to obtain a search result more rapidly. In at least one embodiment, a guide may elect to suppress sponsored result indicators 1630, graphics, or other features in a search result window 1640 associated with a web page provided by a resource. Navigation controls 1635 may be used to navigate within the content of the search result window 1640. While exemplary GUIs are described herein as being destination to a request, the present invention in not limited to any particular interface in association with any request.

An exemplary GUI 1700 for providing information of a request to a searcher is illustrated in FIG. 17. The GUI 1700 may include a query window 1705, a session timer 1710, a query indicator 1715, a location indicator 1720, an answer window 1725, a search start control 1730, a response format indicator 1735, a source indicator 1740, a status selector 1745, action controls 1750, a customer information window 1755, request indicators 1760, customer history window 1770, historical query indicators 1775, historical answer indicators 1780, time stamp indicators 1785, a history viewing control 1790, and navigation controls 1795.

The query window 1705 may include information of a processed query. The session time 1710 may indicate time spent in a query session. The query indicator 1715 may include content of a user query which has been processed. The location indicator 1720 may indicate information of a location which has been associated with the query indicated in the query indicator 1715. The answer window 1725 may be used to indicate information of a response formulated by a searcher. The response format indicator 1735 may be used to provide formatting cues to a searcher. The search start control 1730 may cause a query indicated in the query indicator 1715 to be submitted to a resource indicated by the category request indicator 1760b. The source indicator 1740 may be used to indicate a number of URL's or other information associated with a search result. The status selector 1745 may be used to indicate that a status of “Away” or unavailable is to be associated with the user of the GUI 1700 after completion of the current task.

The action controls 1750 may be used to take various actions associated with the content of the GUI 1700. The ‘Send Answer’ action control 1750a may be used to indicate that a task is complete and that a search result is to be sent. The ‘Clarify’ control 1750b may be used to indicate that a query is unclear and requires user input and terminate the search activity. The ‘Abort’ control 1750c may be used to indicate that a searcher has elected to terminate a search. The ‘Abuse’ control 1750d may be used to indicate that a query is abusive, and to terminate a search.

The customer information window 1755 may include the request indicators 1760. The original question request indicator 1760a may indicate a query as submitted. The matching categories request indicator 1760b may indicate a category which is associated with a query. The location request indicator 1760b may indicate a home location of a user, a last location known for the user, etc. The customer history window 1770 may include the historical query indicators 1775, the historical answer indicators 1780, and the time stamp indicators 1785. The historical query indicators 1775 may indicate previous queries. The historical answer indicators 1780 may indicate previous answers. The time stamp indicators 1785 may indicate time information associated with previous queries. The history viewing controls 1790 may be used to selectively display and hide historical query information. While a toggle has been used for purposes of illustration any sort of filtering might be selected. For example, queries might be selected based on keywords, categories, and/or other information. The navigation controls 1795 may be used to navigate within the content of the customer history window 1770.

Activation of the ‘Find Answer’ control 1730 (FIG. 17) may cause a search query to be submitted directly to a resource. If a query is submitted to the resource, a GUI such as the GUI 1800 may be provided. The GUI 1800 may include a query box 1805, a search control 1810, search result indicators 1815, search result snippets 1820, navigation controls 1825 and a search result window 1830.

The query box 1805 may indicate a query submitted to the resource by the search tools server, and may be used to provide information of a search query. The search control 1810 may be used to submit a query indicated in the query box 1805 for a search. The search result indicators 1815 may indicate a link to a web page selected by a resource. For example, activation of the search result indicator 1815a may cause a web page such as that illustrated in FIG. 19 to be rendered. The search result text snippets 1820 may be used indicate information associated with a search result indicated in the corresponding search result indicator 1815. For example, keywords matching a search query may be highlighted in the search result text snippets 1820. The navigation controls 1825 may be used to navigate within the content of the search result window 1830.

Activation of the search result indicators 1815 may cause a GUI such as the GUI 1900 illustrated in FIG. 19 to be provided. The GUI 1900 may include a dominant keyword indicator 1910, a dominant key phrase indicator 1915, a selected response indicator 1920, navigation controls 1925, and a web page rendering window 1930. The dominant keyword indicator 1910 may indicate a primary keyword of a query. For example, the solid box around the keyword ‘Jersey’ indicates it is the dominant keyword for the query. The dominant key phrase indicator 1915 may indicate a highest ranking key phrase associated with a request. For example the dashed line around the phrase “Jersey Girl Lyrics” may indicate it is the least commonly used, highest ranked key phrase in a query. The selected response indicator 1920 may be used to indicate a response which a guide has determined is suitable as a search result. For example, a guide might highlight or otherwise select text which is to be copied to the answer window 1725 (FIG. 17). The navigation controls 1925 may be used to navigate within the web page rendering window 1930. In at least one embodiment a guide may automatically add text in the selected response indicator 1920 and a URL associated with the page rendered to the answer window 1725 and the source indicator 1740 by activation of the toolbar control 1045. In at least one embodiment, the toolbar control 1045 may include a control for selecting and searching for keywords of a query within content of a current page of a browser.

Activation of the toolbar control 1045 may cause the response GUI 2000 illustrated in FIG. 20 to be provided. The response GUI 2000 may include may include a query window 2005, a session timer 2010, a query indicator 2015, a location indicator 2020, an answer window 2025, a response composition window 2030, a response format indicator 2035, a source window 2040, a status selector 2045, action controls 2050, a customer information window 2055, request indicators 2060, customer history window 2070, historical query indicators 2075, historical answer indicators 2080, time stamp indicators 2085, a history viewing control 2090, and navigation controls 2095.

The query window 2005 may include information of a processed query. The session time 2010 may indicate time spent in a query session. The query indicator 2015 may include content of a user query which has been processed. The location indicator 2020 may indicate information of a location which has been associated with the query indicated in the query indicator 2015. The answer window 2025 may be used to indicate information of a response formulated by a searcher. The response composition window 2030 may be used to compose a response using information selected by a searcher. As illustrated in FIG. 20, the selected text from the selected response indicator 1920 of the GUI 1900 (FIG. 1) has been pasted into the response composition window 2030, and may be edited. The response format indicator 2035 may be used to provide formatting cues to a searcher. As illustrated in FIG. 20, a number of remaining characters which may be provided in a message to a user is indicated in the response format indicator 2035. The source indicator 2040 may be used to indicate a number of URL's or other information associated with a search result. As illustrated, a URL associated with a source of the response (i.e., <http://www.lyricsearch.com/musicilyric.nst/Jersery-Girl-lyrics-Bruce-Springsteen/88AECB28>) and surrounding text from that web page is copied to the source indicator 2040. The status selector 2045 may be used to indicate that a status of “Away” or unavailable is to be associated with the user of the GUI 2000 after completion of the current task.

The action controls 2050 may be used to take various actions associated with the content of the GUI 2000. The ‘Send Answer’ action control 2050a may be used to indicate that a task is complete and that a search result is to be sent. The ‘Clarify’ control 2050b may be used to indicate that a query is unclear and requires user input and terminate the search activity. The ‘Abort’ control 2050c may be used to indicate that a searcher has elected to terminate a search. The ‘Abuse’ control 2050d may be used to indicate that a query is abusive, and to terminate a search.

The customer information window 2055 may include the request indicators 2060. The original question request indicator 2060a may indicate a query as submitted. The matching categories request indicator 2060b may indicate a category which is associated with a query. The location request indicator 2060b may indicate a home location of a user, a last location known for the user, etc. The customer history window 2070 may include the historical query indicators 2075, the historical answer indicators 2080, and the time stamp indicators 2085. The historical query indicators 2075 may indicate previous queries. The historical answer indicators 2080 may indicate previous answers. The time stamp indicators 2085 may indicate time information associated with previous queries. The history viewing controls 2090 may be used to selectively display and hide historical query information. While a toggle has been used for purposes of illustration any sort of filtering might be selected. For example, queries might be selected based on keywords, categories, and/or other information. The navigation controls 2095 may be used to navigate within the content of the customer history window 2070.

In at least one embodiment, a toolbar or extension may allow a guide to select to provide any or all of a user query to features of any rendered page using a drop down list, a right click, or other similar features. For example, if a guide selects a resource which is not known to the search system 130 (FIG. 1), rather than needing to refer to a web page provided by the search tool server 165, the toolbar may allow the guide to quickly refer to elements of a query being searched. As the toolbar is an extension, the functionality may be provided to any application which allows extensions such as a photo processing software, a browser, a word processor, etc.

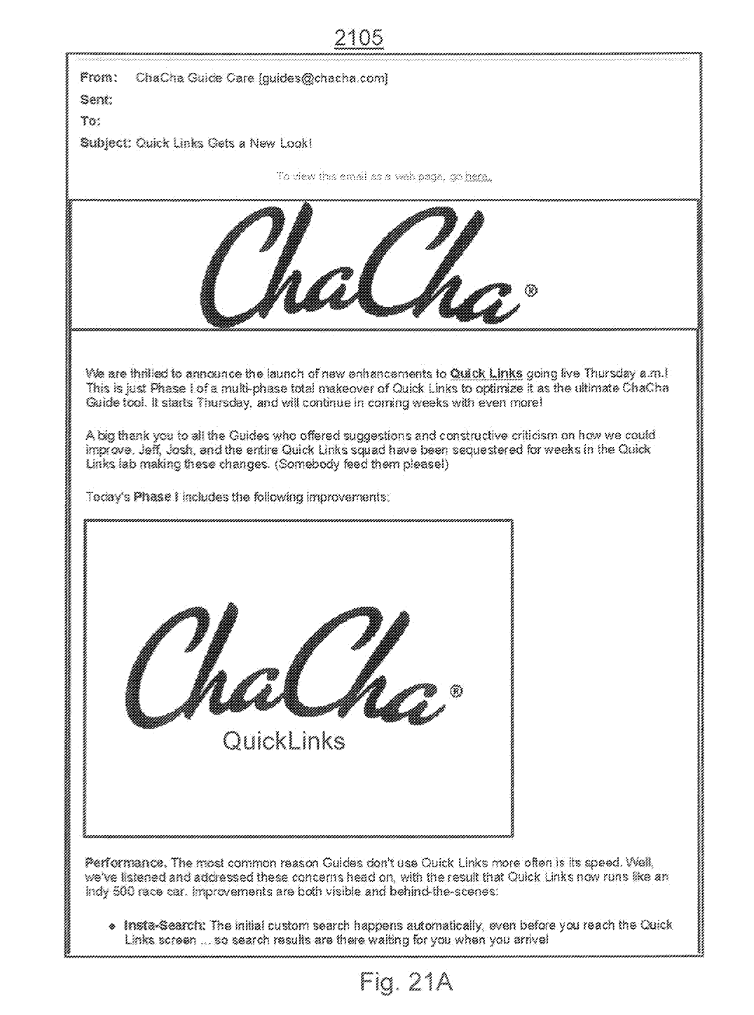

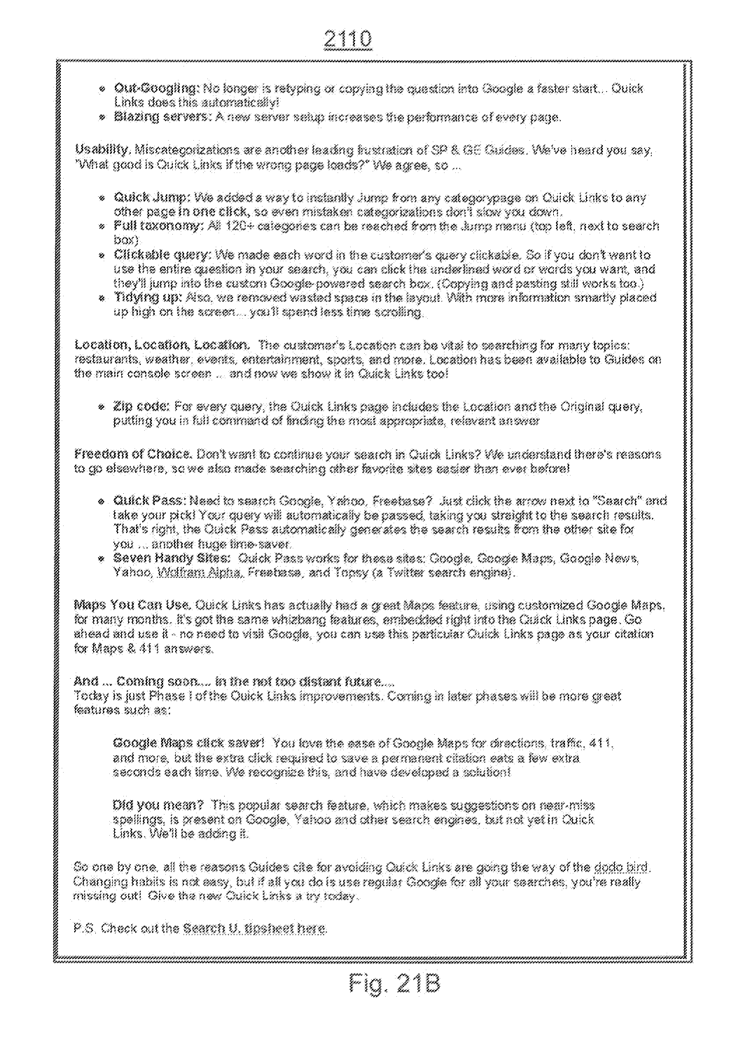

A brief description of some of the features of the user-facing portion of the system is illustrated in FIG. 21A and FIG. 21B. The instructions and descriptions of the functionality highlight the various features and functionalities of the search tool(s) which may aid a specialist or generalist searcher in locating a search result. As noted, the system is enhanced to solve problems typically encountered by guides performing searches. Several complaints and needs may be addressed by the new features. Functionalities previously unavailable such as a tools server, which may respond rapidly to actions of a searcher, or a categorization control, may enhance the experience of a searcher and/or a user.

Any of the GUI's described herein may be provided on any suitable display systems associated with the system 100 (FIG. 1). In at least one embodiment, the GUI's are provided to a guide operating a guide system such as the guide system 105 (FIG. 1). While the database records described herein include specific fields and information, other fields and arrangements of information within a database which are equivalent to accomplish the functionality described are within the spirit and the scope of the embodiments disclosed herein. Any of the fields in any records described herein may be blank.

A system is described whereby a search request is received, categorized and provided to a guide to obtain a search result. A guide is provided with tools which allow the guide rapidly query multiple resources, build a query, access diverse types of resources, review content in optimized formats, locate a result, associate the result with a source, and provide the result to a search service and/or a user. Providing the ability to rapidly submit a search query to multiple resources, and locate alternate search results from a preselected vertical search space an inexperienced searcher may be made more efficient. Providing the ability to, quickly copy a result and an associated reference, search within a rendered search result, and modify a categorization of a request much of the house keeping and formatting tasks needed to provide a high quality response are automated and may reduce the effort required for a guide to provide a result. Allowing a guide to view and manipulate previous search information and profile information of a request, less clarification of a request may be required which may improve a user experience and may reduce guide fatigue.

A guide tools server may allow for a faster response time when providing search results, customization of results provided to a guide, efficient storage and maintenance of a corpus of resources to be indexed, algorithms for performing the indexing, and maintenance of preferences for a guide. Reducing a number of actions required for locating, selecting, and formatting a response to a query may improve guide efficiency and lower cost for a request. While a generalized toolset has been described, the method and systems herein may be practiced in any environment wherein information is sought by persons responding to customer requests.

A request may request various types of information. A system employing human searchers may provide a response to virtually any query. A response may include advertising delivered to a user. In at least one embodiment, a user may request an accommodation from a provider of products or services. A search service may meet such a request in various ways.

It is common for various forms of advertising to provide discounts to persons who receive the advertisement. For example, a newspaper advertisement may include a coupon which may be redeemed by a merchant when a customer bearing the coupon makes a purchase. However such systems have the weakness that a user must collect the coupons and must be in possession of the coupons when a purchase is made. This may result in frustration for the user and loss of revenue for the advertiser sponsoring the coupon if, for example, a user cannot find a printer to print the coupons or forgets them at home. Further, many coupons may be distributed while only a small fraction are redeemed, resulting in waste of resources and expense.

In the case of electronic commerce on the internet, coupons may be offered in various ways. For example, a URL which directs a user to a merchant's website may include information which indicates that a particular accommodation is to be provided to the user. However, if a user does not make a purchase during the particular session which is related to the redirection URL, the discount may not be applied, and the referring website may not receive credit for the purchase, etc.

Some advertisers have chosen to publish promotional codes, or ‘promo codes’, or ‘e-coupons’, which may allow a user to receive a discount when making a purchase. The use of a promo code allows a user to obtain a discount electronically, and the code may indicate a type of offer, as well as the origination of the offer. However, a promo code has the weakness that a user must record the promo code and may not recall the associated offer and/or merchant. Additionally, promo codes are restricted to internet or electronic commerce. In particular, it is difficult for small businesses which conduct transactions at a Point of Sale (POS) device, which may be little more than an automated cash register to process such transactions.

In the case of mobile commerce and advertising, coupon delivery is equally challenging. A promo code may be delivered to a user by messaging technologies such as Short Messaging Service (SMS) based on an offer by an advertiser. However, use of the promo code may be complicated by user behavior. If a user is required to show a promo message to a merchant, there may be resistance to giving up control, even briefly, of a personal communication device. Further an advertiser may have difficulty to verify and track such electronic discounts. For example, an unsophisticated POS device might have difficulty to automatically process a discount code, or an employee might apply a discount even if a customer did not provide a correct promo code. A business may prefer to use paper coupons for accounting purposes.

Due to these and other problems, what is needed is a method and system whereby a coupon code may be delivered to a user electronically, and converted to a printed form for use at a merchant.

A system is provided which includes a user device submitting requests and receiving a response, an SMS messaging service, which may include a wireless service provider and/or a messaging aggregator, an advertiser system providing coupons, a publisher system delivering coupons, controlling messaging between the other components of the system, a merchant system providing products and printing coupons and a database storing information used to select and communicate.

A request is originated from a user device requesting information, which may include a discount offer. A message, which may indicate a response message which may allow a user to cause a coupon to be printed, is provided to a user preferably as an SMS message. A user may elect to respond with a message including the response message. A publisher system may determine that a response message has been received. A publisher system may establish a connection with a merchant device identified in the response message. A message from a publisher system may cause a merchant device to print a coupon. A coupon may include various types of information which may be used to verify identity of a user requesting to use the coupon. A merchant device may be used to provide a confirmation message of a request of a user. If a confirmation message is provided, a publisher system may route the message to a user. A printed coupon may be managed by a merchant and/or an advertiser using well known technology.

A system is provided whereby a user or information seeker may submit a request for information regarding any topic. For example, a search engine and/or other information provider may receive requests from a user. A user device which may be used to submit a request is associated with a unique identifier of a user, which may be used to validate usage of a coupon delivered to a user. A network is provided which allows a user device to communicate with a publisher system which may provide information responsive to a user request, which may include advertisements. A wireless communication service allows a user to communicate with a publisher system using communication services such as WiFi, GPRS, GSM, WiMax, and other wireless communication services. A messaging service such as SMS is enabled by a wireless service provider, which may allow communication between any compatible elements of the system.

A database is provided which includes records associated with various items. Information indicated in a database may be used to allow various elements of a system to communicate. Information in a database may be used to allow exchange of coupons which may provide economic benefit to users, advertisers, merchants and others associated with distribution of coupons. An advertiser system connected to a network is provided, which may be used to provide information of offers associated with a product and/or service. A printing device connected to a network is provided which may be addressable and may be located at a point-of-sale. A publisher system is provided which may provide distribution of advertising from multiple advertisers which advertising is selectively delivered to a user.

A request is originated from a user device requesting information, which may include a discount offer. A message, which may indicate a response message which may allow a user to cause a coupon to be printed, is provided to a user preferably as an SMS message. A user may elect to respond with a message including the response message. A publisher system may determine that a response message has been received. A publisher system may establish a connection with a merchant device identified in a response message. A message from a publisher system may cause a merchant device to print a coupon. A coupon may include various types of information which may be used to verify identity of a user requesting to use the coupon. A merchant device may be used to provide a confirmation message of a request of a user. If a confirmation message is provided, a publisher system may route the message to a user.

In at least one embodiment, a merchant device is equipped with a cellular phone transceiver capability, which may allow a messaging service to enable communication with the merchant device. Such a capability may ease integration with a merchant's existing POS systems, as a paper coupon is nearly universally used. As each merchant device is individually addressable, a coupon may be delivered responsive to an easily remembered code such as the last 4 digits of a phone number, etc. A merchant device may include a keypad which may allow a merchant to provide a message responsive to a user. For example, if a coupon is for a restaurant, or other merchant which may respond to a user with confirmation and/or a request for additional information, a merchant may communicate with a user anonymously.

While a dedicated coupon printing merchant device is described, various types of coupon devices might be implemented utilizing various communication services. For example, a WiFi enabled device might act as a merchant device, which might communicate via web-based services such as email, IM, a web service, etc. Any services which may be accessed by a publisher system may be used to communicate with a merchant device. A printed coupon might be a simple human readable paper coupon or might include barcodes, etc., depending on the capability of a merchant device.

As used herein, a “request” means a request for information, products, and/or services. A request or search request or query may include various types of media, and may be provided by any user system which may establish communication with a server and/or other device associated with a publishing service.

A “user” is a person who submits a request and may receive any type of information responsive to a request. A “provider” is a person and/or entity which may obtain a service and/or product for a user. A provider may be a direct supplier of a product and/or service or “merchant”, and/or may be an intermediary who may conduct a transaction on behalf of a user.

An “advertiser” is any person and/or entity which may provide promotional information or “advertisements” to be delivered to a user. An advertisement may take various forms and/or may include media of any sort which can be delivered to a user device. A “result” or “search result” is any information which has been determined to be a response to a request. A result may include an advertisement. A “coupon printing device” is any device which can produce a printed copy of an offer responsive to a request delivered to the device.

The terms voice and speech are used interchangeably herein. A user, an advertiser, and/or a coupon device may establish a communication session using a voice service, a messaging service such as Short Messaging Service (SMS), Enhanced Messaging Service (EMS), Multi-media Messaging Service (MMS), Instant Messaging (IM), email, an internet portal or web page, regular mail and/or any other type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, or any other communication device might be used to establish a communication session.

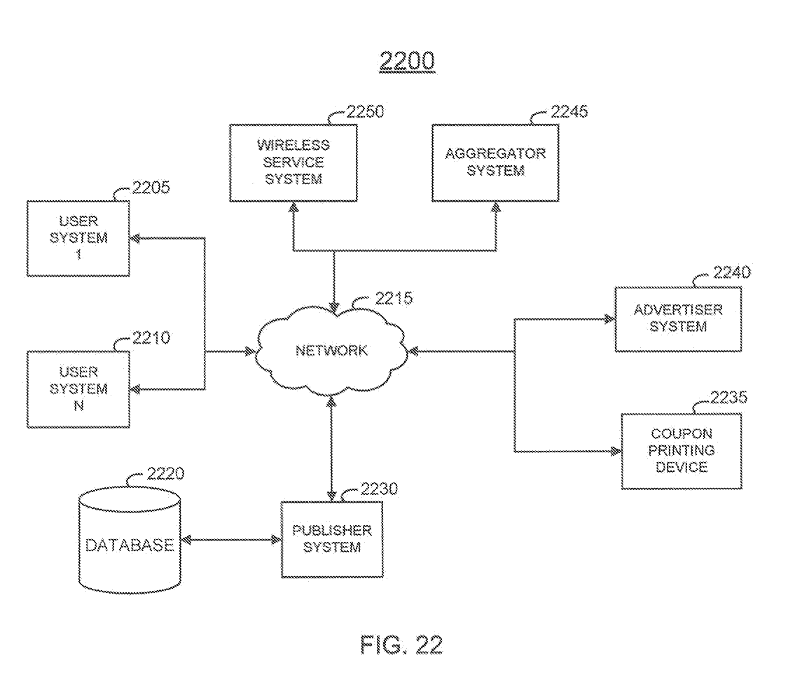

Communication between a user, an advertiser, a coupon device, and/or a publisher system may include conversion of text to speech and speech to text. Any type of conversion and/or other processing of information which may facilitate communication between a user, an advertiser, a coupon device and/or a publisher system may be performed by any element of the system 2200 (FIG. 22). Any type of media which can be sent and/or received using a communication system may be part of a communication session. A communication session may be conducted using any or all communication services associated with a user, an advertiser, a coupon device and/or a publisher system. Any communication session may include communication via multiple services and/or devices. For example, a request may be submitted as a voice query, which might indicate an image located on a resource accessible to a user, the voice query might be converted to a text message, the image might be processed in order to associate a tag and/or other images with the image, and a response might be provided as a spoken reply to a mobile phone associated with a user, and a video presentation which is accessible via a high-speed connection, which might be delivered to a browser functionality of a different user device.

An advertisement may be transmitted including during any or all communication sessions. A merchant, a user and/or an advertisement may be rated. Rating information may be obtained from a user, an advertiser, a merchant, and/or a publisher. Rating information may be used to select a user, an advertisement, a merchant, a communication service, and/or any item based on information associated with an item indicated in a database. A publishing service may be compensated by advertising revenue. Advertising and/or content may be delivered to a user, an advertiser, a merchant, and/or a coupon device using any service associated with a user, a merchant, an advertiser and/or a coupon device.

As illustrated in FIG. 22, a system 2200 includes user systems 2205, 2210, a network 2215 such as the Internet, a publisher system 2230, a coupon printing device 2235, an advertiser system 2240, a database 2220 which may comprise various records, an aggregator system 2245, and a wireless service system 2250.

While only a single system associated with a user, advertiser, coupon printing device, aggregator, wireless service, and a publisher system are depicted in FIG. 22, it is within the scope of the disclosure for multiple systems for user, advertiser, coupon printing device, aggregator, wireless service, and publisher systems to be utilized. In particular, it is envisioned that many user, advertiser, publisher, and coupon printing device systems may be implemented. Further, it is expected that multiple aggregator and wireless carrier services and providers may be utilized. A publisher system may be a composed of many components as described further herein.

Any user system (e.g. the user system 2205) can be used to submit a request to the publisher system 2230 and/or receive a result and/or other information. Any advertiser system may be used to provide information of offers. For example, a merchant may request an advertiser to develop and provide advertising information which may include some sort of accommodation offer to potential customers. An advertiser may select various forms of distribution of advertisements, which may include publishing via a system such as the publisher system 2230.

The network 2215 may be a global public network of networks (i.e., the Internet) and/or may consist in whole or in part of one or more private networks and communicatively couples the user systems 2205, 2210, the coupon printing device 2235, the advertiser system 2240, the aggregator system 2245, and the wireless service system 2250 with the other components of the system such as the publisher system 2230, and the database 2220. The network 2215 may include one or more wireless networks which may enable wireless communication between the various elements of the system 2200. For example, the wireless service system 2250 may receive messages from the aggregator system 2245 which may be routed via a wireless network controlled by the wireless service system to the user systems 2205, 2210. The wireless service system 2250 may receive messages from the user system 2210 via a wireless network, which is a part of the network 2215, and provide the messages to the wireless messaging aggregator system 2245 via an internet connection which is part of the network 2215. The aggregator system 2245 may provide user messages to the publisher system 2230 via an Internet Protocol (IP) connection using the network 2215. The same routing might be used in reverse in order that the publisher system 2230 may provide a message to the user system 2210 using the network 2215. Similarly a voice communication via wired and/or wireless communication might be established between any elements of the system 2200 using the network 2215 and the wireless service system 2250. Similarly, a wireless message might be provided to and/or received from the coupon printing device 2235, and/or the advertiser system 2240.

The publisher system 2230 allows interaction to occur among the user systems 2205, 2210, the coupon printing device 2235, the advertiser system 2240, the aggregator system 2245, and the wireless service system 2250. For example, a request can be transmitted from the user system 2205 to the publisher system 2230, which may provide information obtained from the database 2220, which may include an advertisement provided by the advertiser system 2240 to the user system 2205. Similarly, a response from a merchant operating the coupon printing device 2235 might be routed to the publisher system 2230, which might process the response and provide a message to the user system 2210. An advertisement might be obtained from the advertiser system 2240 and transmitted to the user system 2205 as an SMS or MMS message using the wireless service system 2250 and/or the aggregator system 2245. Any type of communication between a user, an advertiser, a merchant, a wireless service system, and an aggregator may be mediated and/or facilitated by the publisher system 2230, and/or other elements of the system 2200.

The publisher system 2230 is communicatively coupled with the database 2220. As will be described herein in further detail below, the database 2220 includes data that is processed in association with operation of the embodiments. Although FIG. 22 illustrates the database 2220 as a separate component of the system, the database 2220 may be integrated with the publisher system 2230. Further, the records maintained in the database 2220 may be stored in any typical manner, including in a Network Attached Storage (NAS), a Storage Area Network (SAN), etc., using any typical or proprietary database software such as DB2®, Informix®, Microsoft® SQLServer™, MySQL®, Oracle®, etc., and may also be a distributed database on more than one server. Elements of the database 2220 may reside in any suitable elements of the system 2200. Any or all elements of the system 2200 may include any or all elements of the database 2220.

The user systems 2205, 2210, the coupon printing device 2235, the advertiser system 2240, the publisher system 2230, the aggregator system 2245, and the wireless service system 2250 may include equipment, software, systems, and personnel required to send and/or receive messages between a user system, an advertiser system, a coupon printing device, a wireless service system, an aggregator system, and/or the publisher system 2230 using the network 2215. The database 2220 includes information which may allow the publisher system 2230 to establish communication between any or all of the elements of the system 2200.

A user system, an advertiser system, and/or a coupon printing device may be a desktop or portable PC or Mac®, a mobile phone, a smart phone, a PDA, a server system, a landline phone, a specialized communication terminal, a terminal connected to a mainframe, or any other communication device and/or system. The publisher system 2230, the aggregator system 2245, and the wireless service system 2250 may include one or more servers, computers, etc. For example, servers such as the PowerEdge® 2900 by Dell, or the BladeCenterJS22 by IBM, or equivalent systems might be used to implement elements of the publisher system 2230. The publisher system 2230, the aggregator system 2245, and the wireless service system 2250 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, provider systems, advertiser systems, aggregator systems, wireless service systems, and/or to implement the publisher system 2230.

An advertiser may be required to register with the publisher system 2230. As part of a registration process, at least one communication method is associated with an advertiser. In at least one embodiment, an advertiser may register with the publisher system 2230 and establish a username and password which are associated with the advertiser. An advertiser may login to the publisher system 2230 using a web browser functionality of the advertiser system 2240 in order to communicate with the publisher system 2230. Multiple communication services may be associated with an advertiser and may allow a communication session to be established between an advertiser system such as the advertiser system 2240 and a user system, a coupon printing device and/or the publisher system 2230. Multiple identifiers of an advertiser may be associated with each other. Information such as IM credentials, an email address, a phone number, a URL, a username, etc., of an advertiser may be identified which may allow the publisher system 2230 to establish a communication session between an advertiser system and a user system, a coupon printing device and/or the publisher system 2230.

When an advertiser registers with the publisher system 2230 the advertiser may be associated with one or more keywords, categories, and/or other information. For example a keyword or category may be selected by an advertiser, or may be associated with an advertiser based on a test administered to an advertiser and/or other information provided during and/or after a registration process. Information associated with an advertiser may be stored in the database 2220 and may be used for purposes such as matching an advertiser to a user request, determining and/or providing compensation for an advertiser, communicating with an advertiser, etc., as will be described further herein below.

A user may be identified by the publisher system 2230. When a user system such as the user system 2205 establishes a communication session with the publisher system 2230, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 2205 and an advertiser system, a coupon printing device and/or the publisher system 2230. Information such as a keyword, a category, a user profile, a previous search request, a search result etc., may be associated with a user. Information of a user may be stored in the database 2220.

An advertiser system may provide information of any type of content and/or other information which may be associated with sponsorship information. For example, audio, video, web pages, interactive games, software, etc., which might be sponsored by an advertiser, may be provided by an advertiser system such as the advertiser system 2240.

A merchant may be required to register with the publisher system 2230. As part of a registration process, at least one communication method is associated with a merchant. In at least one embodiment, a merchant may register with the publisher system 2230 and establish a username and password which are associated with the merchant. A merchant may login to the publisher system 2230 using a web browser functionality of the coupon printing device 2235 or other device associated with the merchant in order to communicate with the publisher system 2230. Multiple communication services may be associated with a merchant and may allow a communication session to be established between a merchant system such as the coupon printing device 2235 and a user system, an advertiser system 2240, and/or the publisher system 2230. Multiple identifiers of a merchant may be associated with each other. Information such as IM credentials, an email address, a phone number, a URL, a username, etc., of a merchant may be identified which may allow the publisher system 2230 to establish a communication session between a merchant system and a user system, an advertiser system, and/or the publisher system 2230. In at least one embodiment, an identifier associated with a merchant may be obtained without use of electronic communication, and may be associated with an identifier of a coupon printing device such as the coupon printing device 2235.

When a merchant registers with the publisher system 2230, the merchant may be associated with one or more keywords, categories, and/or other information. Such information may be used to associate a merchant with an advertisement and/or an advertiser.

The publisher system 2230 may establish a communication session between any user system, advertiser system and/or coupon printing device using information indicated in the database 2220. For example, the user system 2210 may establish a voice communication session with the publisher system 2230, the publisher system 2230 may establish an IP communication with the advertiser system 2240, and the publisher system 2230 may establish a voice communication session between the user system 2210 and the coupon printing device 2235. While a voice communication session is used in this example, any type of communication session using one or more services such as SMS, EMS, MMS, email, IM, chat, web based communication, etc., may be established between any user system, advertiser system and/or coupon printing device and/or the publisher system 2230.

Information associated with a user, an advertiser, and/or a coupon printing device may be obtained in various ways. For example, a registration process may be performed using a web form provided by the publisher system 2230, and/or information may be obtained from an external database, and/or information may be obtained based on analysis of information indicated by a user, an advertiser, and/or a merchant. A ‘profile’ is one or more characteristics which may be associated with one or more individuals. A profile may include geographic data such as a street address, latitude and longitude, etc., may include demographic information such as age, gender, race, income, family size, political affiliations, etc., may include personality information such as results of psychometric testing, subjective evaluations of an individual, etc., may include affiliation information such as employment, club, activity, societal membership information, information of a device, service, transaction and/or any information which might be associated with a user, a merchant, a coupon printing device, and/or an advertiser.

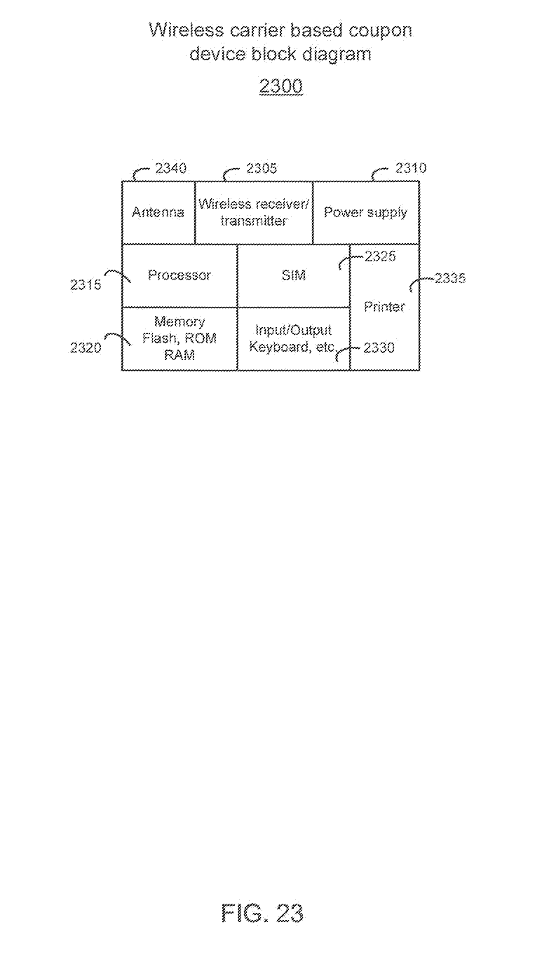

The coupon printing device 2235 may be implemented in various embodiments. A block diagram of a simplified coupon printing device is illustrated in FIG. 23. Exemplary hardware and software elements which may be used to implement a coupon printing device according to an embodiment are illustrated in FIGS. 31, 32, 33 and 34. In at least one embodiment, the coupon printing device may send and/or receive Short Messaging Service (SMS) messages via a wireless telephone network system such as a GSM network. While a specific example of an embodiment is provided for the purposes of illustration, no limitation is implied thereby and no particular embodiment is required except to fulfill the required functionalities as described herein.

An exemplary block diagram of a wireless carrier based coupon printing device 2300 is illustrated in FIG. 23. The wireless carrier based coupon printing device 2300 may include a wireless receiver/transmitter 2305, a power supply 2310, a processor 2315, memory 2320, a subscriber identity module (SIM) 2325, an input/output port 2330, a printer 2335, and an antenna module 2340. While a particular device is illustrated in FIG. 23, the present invention is not limited thereto. Any device, special purpose computer, specialized apparatus, etc. may be used to implement operations of the device illustrated in FIG. 23.

The wireless receiver/transmitter 2305 allows the coupon device 2300 to receive and send commands via a wireless network. For example, a GSM network interface may be implemented which may enable use of low bandwidth messaging technologies such as SMS, and/or higher bandwidth technologies such as GPRS, etc. The power supply section 2310 provides regulated, stabilized power to the various elements of the coupon device 2300. In a preferred embodiment, the coupon device 2300 is powered from a main power connection from the electrical grid. However, a battery powered device may also be implemented without loss of generality. Power to a coupon device may be supplied in various ways which are well known in the art.

The processor 2315 may be any general purpose computing device such as an Intel® 8742, or a Freescale® 68HC908JL8 microcontroller. The processor 2315 may receive commands from the wireless receiver/transmitter 2305 and take needed actions such as controlling the printer 2335. The processor 2315 may obtain information from subsystems of the coupon device 2300 such as the memory 2320, the input/output port 2330, the SIM, and the printer 2335, and may control the subsystems according to instructions which may be stored in the memory 2320, and/or provided via the wireless receiver/transmitter 2305. The memory 2320 may include Flash memory, ROM, RAM, and/or other types of memory as may be required to provide the functionality of the coupon device 2300. The SIM 2325 allows a unique address to be assigned to the coupon device 2300 for the wireless network. For example, a wireless phone number, or an IP address, etc. of the coupon device 2320 may be determined by the SIM 2325. The input/output port 2330 allows the coupon device 2300 to receive inputs from user controls such as a keypad, and to control indicators such as LED's, LCD's, etc. The printer 2335 allows the coupon device 2300 to produce printed materials. For example, a thermal, impact, inkjet or other type of printing apparatus which is well known in the art may be used to produce a printed coupon. The antenna 2340 is attached to the coupon printing device 2300 to provide signal gain and increase the ability of the coupon printing device to receive a wireless signal. This is particularly useful if a coupon printing device is located in a noisy or indoor environment where shielding such as surface coatings of windows, metallic structures, etc. may be present or wherein electromagnetic interference from other electronic devices may affect the ability of the transceiver 2305 to properly receive a wireless signal.

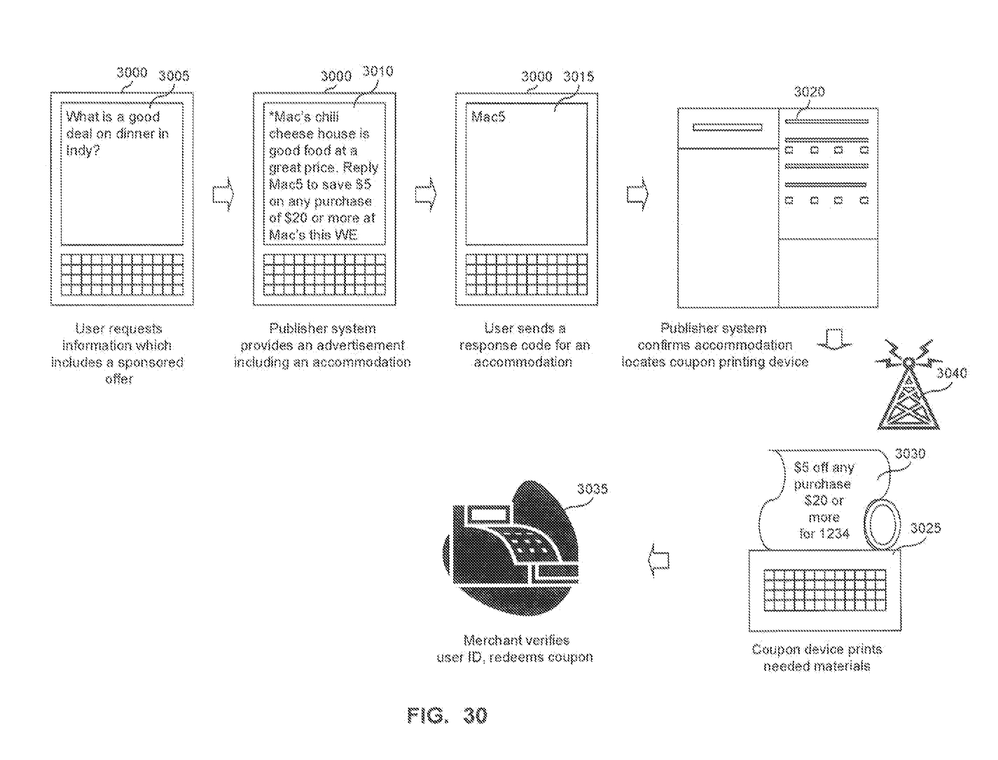

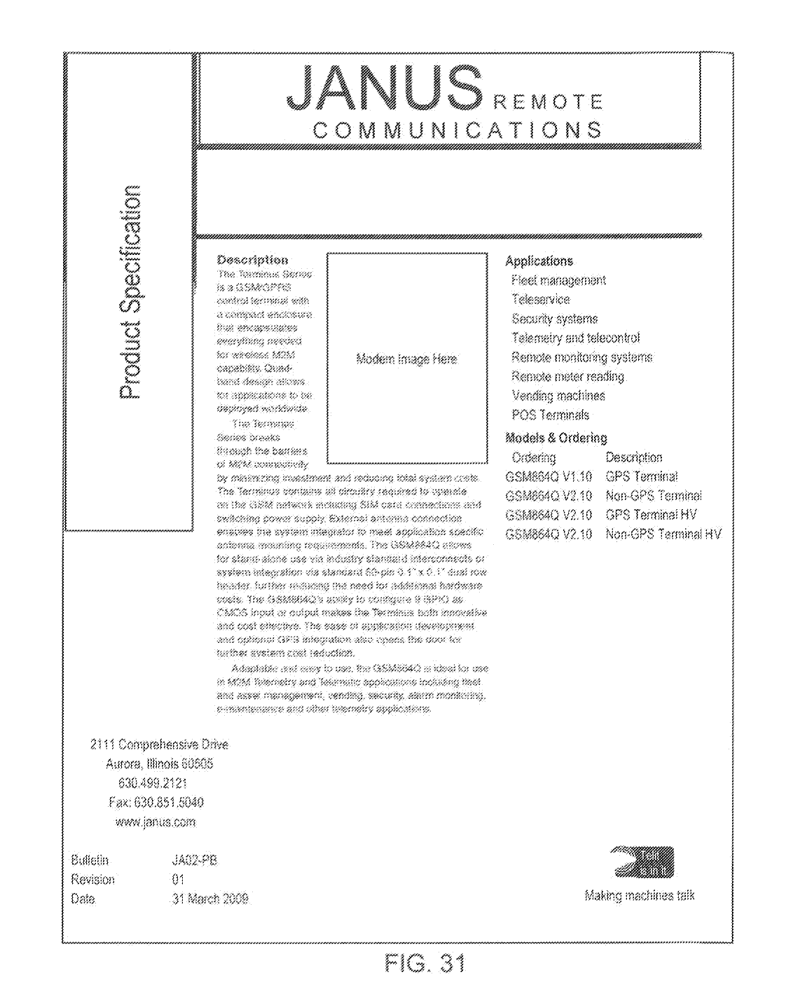

The processor 2315 may execute instructions for managing the behavior of the coupon printing device 2300. For example, it may be desirable that standardized elements of a printed coupon as illustrated in FIG. 30 are fixed in order to reduce an amount of information which must be provided to the coupon printing device 2315 when a coupon is to be printed. In such an instance a command set may be implemented to allow the coupon printing device 2315 to accept messages modifying these elements. In at least one embodiment, the coupon printing device 2315 may determine whether to accept to execute a command based on an originating phone number or short code associated with a message including the command. The coupon printing device 2315 may be unable to respond to a command for various reasons. For example, a hardware fault may exist or a power connection might be lost, etc. In such an instance it may be desirable to be able to request status information from the coupon printing device 2315. If a message is received at the coupon printing device, it may respond with a status message. Any status of the coupon printing device 2315 such as firmware status, usage, hardware information (ink, paper, controls) etc. may be requested and provided using wireless communication via GSM such as SMS and/or GPRS.

In at least one embodiment, a printed coupon may include a barcode which may be scanned by a merchant. In at least one embodiment, controls of the coupon device may be used to send an SMS or other message from the coupon device 2300 via a wireless network. A merchant may, for example, use a keypad to confirm a reservation, indicate if an item is in stock, etc. Such information may be transmitted to the publisher system 2230 (FIG. 22) and may be provided to a user, an advertiser, etc.

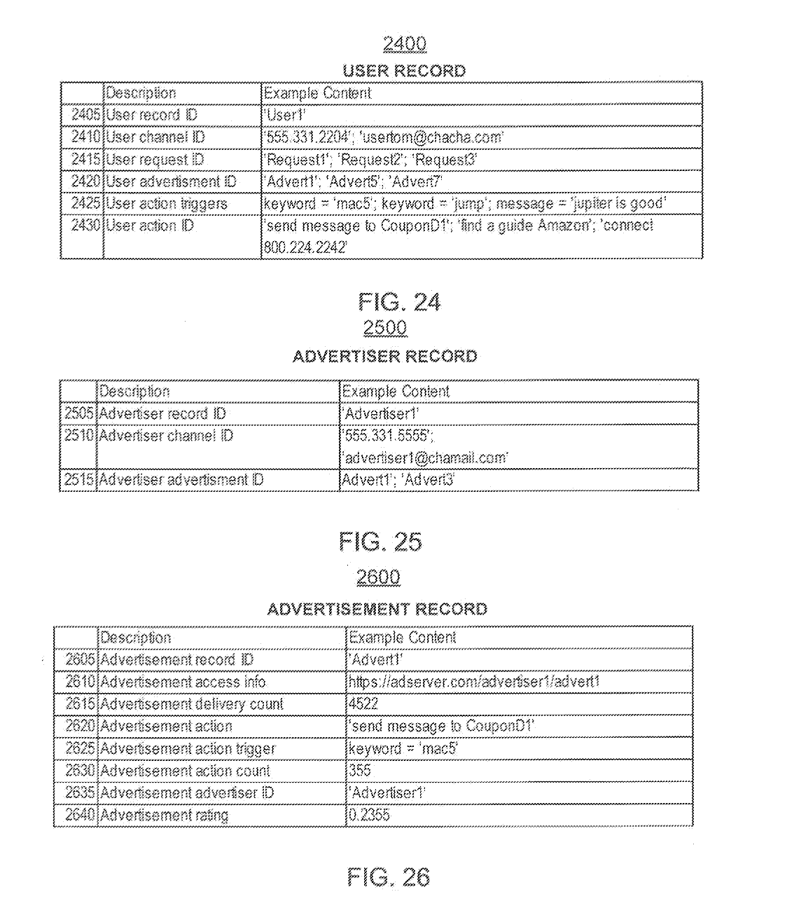

As illustrated in FIG. 24, an exemplary user record 2400 of which one or more may be associated with or resident in the database 2220 (FIG. 22) is provided. The user record may include a user record ID field 2405, a user channel ID field 2410, a user request ID field 2415, a user advertisement ID field 2420, a user action triggers field 2425, and a user action ID field 2430.

The user record ID field 2405 includes an identifier of a user which is preferably unique and is preferably used consistently. The user record ID serves to distinguish a user record associated with a user from a user record associated with a different user. Any number of characters, numbers, and/or other indicators may be used to indicate a user record ID. In at least one embodiment, a username associated with a user is included in the user record ID field 2405. In at least one embodiment, a phone number associated with a user device is indicated in the user record ID field. Using the example in FIG. 24, ‘User1’ is the user record ID associated with the user record 2400.

The user channel ID field 2410 includes information of a number of communication services associated with a user. Any information which may be used to establish communication with a user may be indicated in the user channel ID field 2410. For example, a telephone number, an email address, an IM credential, a URL, a username, a password, and/or other communication information may be indicated in the user channel ID field 2410. Using the example in FIG. 24, the phone number ‘555.331.2204’ and the email ‘usertom@chacha.com’ are associated with ‘User1’.

The user request ID field 2415 includes information of a number of requests associated with a user. A user request ID may be, for example, a pointer to a request record associated with a request submitted to the publisher system 2230 (FIG. 22) by a user. If a user submits a request to the publisher system 2230, a request ID may be added to the user request ID field 2415. Using the example illustrated in FIG. 24, ‘Request1’, ‘Request2’ and ‘Request3’ are associated with ‘User1’. This may indicate that ‘Used’ has submitted three requests for information to the publisher system 2230 (FIG. 22).

The user advertisement ID field 2420 (FIG. 24) includes information of a number of advertisements associated with a user. A user advertisement ID may be, for example, a pointer to an advertisement record associated with an advertisement submitted to the publisher system 2230 (FIG. 22) by an advertiser. If an advertisement is provided to a user an advertisement ID of the advertisement may be added to the user advertisement ID field 2420 (FIG. 24). Using the example illustrated in FIG. 24, ‘Advert1’, ‘Advert5’ and ‘Advert7’ are associated with ‘User1’. This may indicate that ‘User1’ has been presented with ‘Advert1’, ‘Advert5’ and ‘Advert7’, for example, responsive to ‘Request1’, ‘Request2’ and ‘Request3’.

The user action triggers field 2425 may include information of a number of trigger events associated with a user. If a user takes an action which is indicated in the user action triggers field 2425, an associated response indicated in the user action ID field 2430 may be performed. An action may be added to and/or removed from the user action triggers field 2425 based on various criteria. For example, if a user receives a particular advertising message, an action trigger may be associated with the user as further described in the related U.S. patent application Ser. No. 12/568,293, previously mentioned. Using the example in FIG. 24, the triggers keyword=‘mac5’, keyword=‘jump’ and message=‘jupiter is good’ are the trigger actions associated with ‘User1’.

The user action ID field 2430 may include information of an action to be taken responsive to a trigger identified in the user action triggers field 2425. Any sort of action may be initiated responsive to an action identified in the user action triggers field 2425. In at least one embodiment, a detection of a trigger event may cause a corresponding action to be initiated by the publisher system 2230 (FIG. 22). Using the example in FIG. 24, detection of the keyword ‘mac5’ in a message received from the phone number ‘555.331.2204’ may cause a message to be sent to a coupon printer device which may cause a coupon to be printed by ‘CouponD1’.

As illustrated in FIG. 25, an exemplary advertiser record 2500, of which one or more may be associated with or resident in the database 2220 (FIG. 22), is provided. The advertiser record 2500 may include an advertiser record ID field 2505 (FIG. 25), an advertiser channel ID field 2510, and an advertiser advertisement ID field 2515.

The advertiser record ID field 2505 includes an identifier of an advertiser which is preferably unique and is preferably used consistently. An advertiser record ID serves to distinguish an advertiser record associated with an advertiser from an advertiser record associated with a different advertiser. Any number of characters, numbers, and/or other indicators may be used to indicate an advertiser record ID. In at least one embodiment, a username associated with an advertiser is included in the advertiser record ID field 2505. In at least one embodiment, a phone number associated with an advertiser device may be indicated in the advertiser record ID field. Using the example in FIG. 25, ‘Advertiser1’ is the advertiser record ID associated with the advertiser record 2500.

The advertiser channel ID field 2510 includes information a number of communication services associated with an advertiser. Any information which may be used to establish communication with an advertiser may be indicated in the user channel ID field 2510. For example, a telephone number, an email address, an IM credential, a URL, a username, a password, and/or other communication information may be indicated in the advertiser channel ID field 2510. Using the example in FIG. 25, the phone number ‘555.331.5555’ and the email ‘advertised @chamail.com’ are associated with ‘Advertiser1’. Communication information associated with an advertiser may be used to obtain payment from, provide information to and/or otherwise communicate with an advertiser.

The advertiser advertisement ID field 2515 includes information of a number of advertisements associated with an advertiser. An advertiser advertisement ID may be, for example, a pointer to an advertisement record such as the advertisement record 2600 (FIG. 26). An advertisement may be provided by a merchant, by an advertising agency or service, etc. Using the example in FIG. 25, ‘Advert1’ and ‘Advert3’ are associated with ‘Advertiser1’.

As illustrated in FIG. 26, an exemplary advertisement record 2600 of which one or more may be associated with or resident in the database 2220 (FIG. 22) is provided. The advertisement record 2600 may include an advertisement record ID field 2605, an advertisement access information field 2610, an advertisement delivery count field 2615, an advertisement action field 2620, an advertisement action trigger field 2625, an advertisement action count field 2630, an advertisement advertiser ID field 2635, and an advertisement rating field 2640.

The advertisement record ID field 2605 includes an identifier of an advertisement which is preferably unique and is preferably used consistently. An advertisement record ID serves to distinguish an advertisement record associated with an advertisement from an advertisement record associated with a different advertisement. Any number of characters, numbers, and/or other indicators may be used to indicate an advertisement record ID. In at least one embodiment, a name selected by an advertiser associated with an advertisement is included in the advertisement record ID field 2605. Using the example in FIG. 26, ‘Advert1’ is the advertisement record ID associated with the advertisement record 2600.

The advertisement access information field 2610 includes information regarding how an advertisement may be accessed. For example, the advertisement access information may indicate a server, URL, password, etc., which may be used to obtain information of an advertisement. Using the example in FIG. 26, the URL <‘https://adserver.com/advertiser1/advert1’> is associated with ‘Advert1’, which may indicate a server location from which content associated with ‘Advert)’ may be obtained.

The advertisement delivery count field 2615 includes information of a number of times an advertisement has been provided to a user. Using the example illustrated in FIG. 26, the content of the advertisement delivery count field 2615 indicates that ‘Advert)’ may have been delivered four thousand five hundred twenty-two times.

The advertisement action ID field 2620 may include information of an action which is to be associated with a user responsive to an advertisement being provided to the user. Using the example illustrated in FIG. 26, if the advertisement ‘Advert1’ is presented to a user, the action ‘send message to CouponD1’ may be executed responsive to a message from the user including the keyword ‘mac5’. While a static action is used for the purposes of illustration in FIG. 24 and FIG. 26, no limitation is implied. For example, ‘message’ might be a pointer to a dynamically defined message which might cause a different offer coupon or other message to be printed, or ‘CouponD1’ might be a pointer to a dynamically defined address such as a merchant identified by a location associated with a user device.

The advertisement action trigger field 2625 may include information of a response or trigger associated with an advertisement. For example, if an advertisement includes a keyword which may be used to trigger an action responsive to a message including the keyword, the keyword may be indicated in the advertisement action trigger field 2625. Using the example in FIG. 26, the keyword ‘mac5’ is associated with the advertisement ‘Advert1’.

The advertisement action count field 2630 may include information of a number of times that an action trigger has been received and an action associated with an advertisement has been executed. Using the example in FIG. 26, the action ‘send message to CouponD1’ may have been executed three hundred fifty-five times.

The advertisement advertiser ID field 2635 may include information of an advertiser associated with an advertisement. For example, the advertisement advertiser ID field 2635 may include a pointer to a number of advertiser records such as the advertiser record 2500. Using the example in FIG. 26, ‘Advertised’ is associated with the advertisement ‘Advert1’. Association of an advertiser with an advertisement may affect compensation associated with an advertiser and/or the publisher system 2230 (FIG. 22). For example, an advertiser may compensate the publisher system 2230 based on a content of the advertisement action count field 2630 (FIG. 26).

The advertisement rating field 2640 may include information of a rating associated with an advertisement. A rating associated with an advertisement may be used to select an advertisement which is to be provided to a user. For example, if an advertisement has a high rating associated with a profile of a user, the advertisement may be more likely to be presented to the user than an advertisement with a low rating associated with the user profile. A rating and/or ranking of an advertisement may be determined using any suitable criteria. In at least one embodiment, a rating of an advertisement may be based on a number of actions and a number of times an advertisement has been provided to a user. Using the example in FIG. 26, the advertisement rating field 2640 is the ratio of the advertisement action count to the advertisement delivery count.

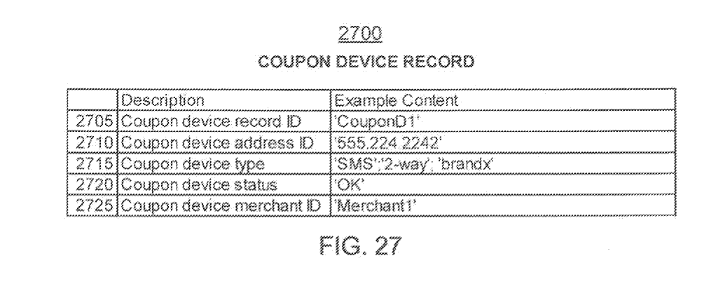

As illustrated in FIG. 27, an exemplary coupon device record 2700 of which one or more may be associated with or resident in the database 2220 (FIG. 22) is provided. The coupon device record 2700 may include a coupon device record ID field 2705, a coupon device address ID field 2710, a coupon device type field 2715, a coupon device status field 2720, and a coupon device merchant ID field 2725.

The coupon device record ID field 2705 includes an identifier of a coupon device which is preferably unique and is preferably used consistently. A coupon device record ID serves to distinguish a coupon device record associated with a coupon device from a coupon device record associated with a different coupon device. Any number of characters, numbers, and/or other indicators may be used to indicate a coupon device record ID. In at least one embodiment, a hardware identifier is included in the coupon device record ID field 2705. Using the example in FIG. 27, ‘CouponD1’ is the coupon device record ID associated with the coupon device record 2700.

The coupon device address ID field 2710 includes an identifier of an address associated with a coupon device. Content of the coupon device address ID field 2710 may be used to establish communication with a coupon printing device. For example, an IP address, a telephone number, an email, an IM credential, etc., may be included in the coupon device address ID field 2710. In at least one embodiment, a coupon device address ID is a telephone number associated with a SIM. Using the example in FIG. 27, the telephone number ‘555.224.2242’ is associated with ‘CouponD1’.

The coupon device type field 2715 includes an identifier of a type of device associated with a coupon device. For example, a coupon printing device might be a stand-alone device such as the wireless coupon device 2300 (FIG. 23), might be a printing device associated with a computer system, might be a Wi-Fi enabled printer, etc. Information indicated in the coupon device type field 2715 may be used, for example, to determine how a command to print a coupon is to be formatted, how a response from a coupon printing device is to be interpreted, etc. Using the example in FIG. 27, the types ‘SMS’, ‘2-way’, and ‘brandx’ are associated with ‘CouponD1’ which may indicate a communication type, directionality, and manufacturer associated with ‘CouponD1’.

The coupon device status field 2720 includes information status of a coupon device. For example, if a coupon device is capable of bidirectional communication, information of the operational status of the coupon printing device may be obtained periodically. Using the example in FIG. 27, ‘CouponD1’ has the status ‘OK’.

The coupon device merchant ID field 2725 may include information of a merchant associated with a coupon printing device. If a merchant is registered with the publisher system 2230 (FIG. 22), an identifier of the merchant may be indicated in the coupon device merchant ID field 2725 (FIG. 27). As a merchant may provide products and/or services which may be associated with multiple advertisers, a coupon device may be associated with a unique merchant who may or may not be an advertiser. Compensation for a merchant may be based at least in part on a number of coupons distributed and/or redeemed which were provided by a coupon device associated with a merchant. For example, if an advertiser is providing manufacturer's coupons, a merchant may be compensated based on a number of coupons redeemed along with written documentation of a purchase. Use of a printed coupon may enhance traceability of such coupons. Using the example in FIG. 27, ‘Merchant1’ is the merchant associated with ‘CouponD1’.

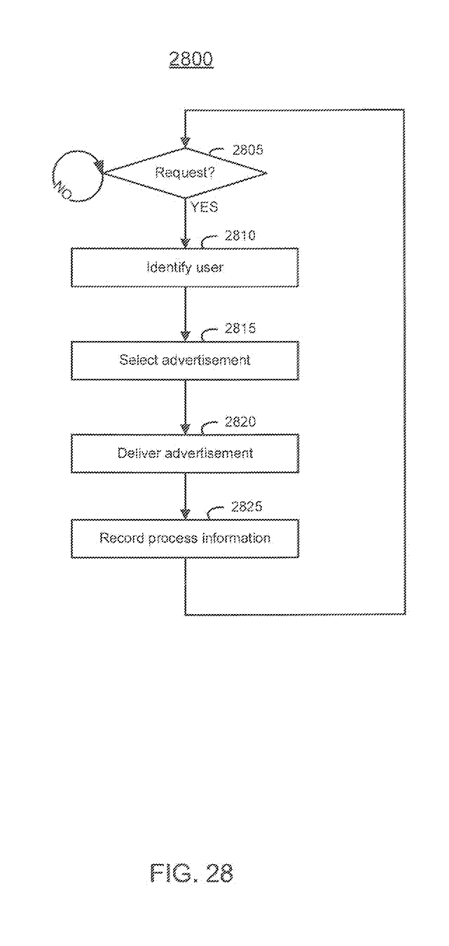

As illustrated in FIG. 28, a process 2800 for processing a request is provided. The process 2800 may be performed in whole or in part by any suitable element of the system 2200 (FIG. 22). In at least one embodiment, the process 2800 is operative on a server associated with the publisher system 2230.

In operation 2805 (FIG. 28) a determination is made as to whether a request is received. If it is determined in operation 2805 that a request is not received, control remains at operation 2805 and process 2800 continues. If it is determined in operation 2805 that a request is received, control is passed to operation 2810 and process 2800 continues.

The determination in operation 2805 may be made using various criteria. In at least one embodiment, if a message is received at a server associated with the publisher system 2830, it may be determined that a request is received. For example, if an email message, an SMS, EMS, and/or MMS message, an IM, an IP message, and/or a voice message is received at an address associated with the publisher system 2230 (FIG. 22) it may be determined that a request is received.

In operation 2810 (FIG. 28), a user is identified. An ID of a user may be obtained in any suitable way. For example, a login ID, an email, an IM credential, a phone number, etc., associated with a user may be used to identify a user. Control is passed to operation 2815 and process 2800 continues.

In operation 2815, an advertisement is selected. In at least one embodiment, an advertisement may include information of an offer or coupon which may be utilized by a user. An advertisement may be selected based on a request of a user. For example, if the publisher system 2230 (FIG. 22) is a search service, an advertisement may be selected at least in part on content of a user query which may be used to rank the advertisement. Similarly, a profile of a user submitting a request may be used to select an advertisement. A user request may indicate a specific advertisement or coupon or offer. An advertisement may be selected based on a trigger condition which may cause a request to be received. For example, if a user device is found to be in proximity to a location associated with a coupon printing device, a request for a coupon may be submitted. Control is passed to operation 2820 (FIG. 28) and process 2800 continues.

In operation 2820, an advertisement is delivered to a user. An advertisement may be delivered to a user via any suitable communication service associated with the user. In at least one embodiment, an advertisement is delivered as an SMS message to a user device. An advertisement may include information of an offer and/or an action code which may cause a coupon to be printed. An advertisement may include any number of messages, which may be provided in any order. Control is passed to operation 2825 and process 2800 continues.

In operation 2825, information of the process 2800 is recorded. In at least one embodiment, the database 2220 (FIG. 22) is updated with information of a request, an advertisement delivered, a trigger action associated with a user, an offer associated with an advertisement, a rating of an advertisement, etc. Control is passed to operation 2805 (FIG. 28) and process 2800 continues.

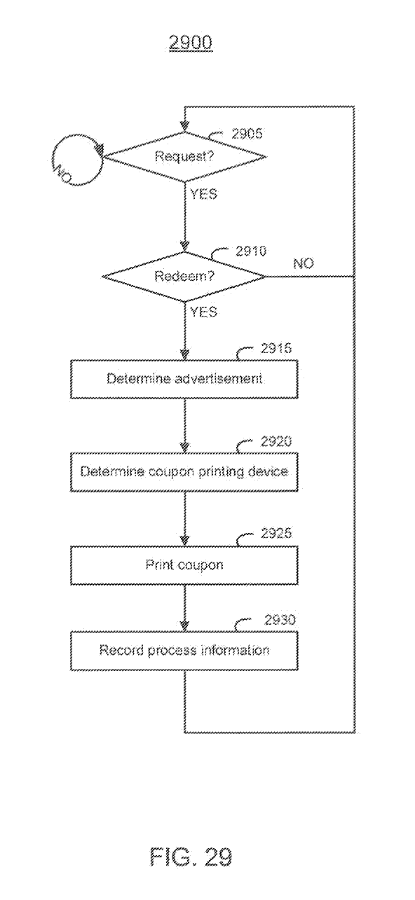

As illustrated in FIG. 29, a process 2900 for processing a request for a printed coupon is provided. The process 2900 may be performed in whole or in part by any suitable elements of the system 2200 (FIG. 22). In at least one embodiment, the process 2900 is operative on a server associated with the publisher system 2230.

In operation 2905 (FIG. 29), a determination is made as to whether a request is received. If it is determined in operation 2905 that a request is not received, control remains at operation 2905 and process 2900 continues. If it is determined in operation 2905 that a request is received, control is passed to operation 2910 and process 2900 continues.

The determination in operation 2905 may be made using various criteria. In at least one embodiment, if a message is received at a server associated with the publisher system 2230, it may be determined that a request is received. For example, if an email message, an SMS, EMS, and/or MMS message, an IM, an IP message, and/or a voice message is received at an address associated with the publisher system 2230 (FIG. 22), it may be determined that a request is received.

In operation 2910 (FIG. 29) a determination is made as to whether a printed coupon is requested. If it is determined in operation 2910 that a printed coupon is not requested, control is passed to operation 2905 and process 2900 continues. If it is determined in operation 2910 that a printed coupon is requested, control is passed to operation 2915 and process 2900 continues.

The determination in operation 2910 may be made based on various criteria. In at least one embodiment, content of a text message received from a user system is compared to a list of templates associated with the user to determine whether a printed coupon is requested. This may allow content of a text message to, for example, initiate a coupon printing action by a coupon printing device.

In operation 2915, an advertisement is identified. In at least one embodiment, an advertisement may be identified based at least in part on content of a message received in operation 2905. Using an identifier of a user associated with a request, and a trigger action associated with a request, an advertisement associated with the user and the trigger action may be uniquely identified. Compensation of an advertiser and/or a publisher system may be determined based on an advertisement associated with a coupon printing request. Control is passed to operation 2920 and process 2900 continues.

In operation 2920, a coupon printing device is identified. In order to determine an address associated with a coupon printing device, various factors may be considered. In at least one embodiment, an explicit address may be associated with an advertisement. In at least one embodiment, a number of coupon printing devices may be available at a merchant associated with a coupon. In such an instance, a user may be requested to provide location information, or location information of a user device and a coupon printing device may be used to determine a most likely coupon printing device. Alternately, a request to print a coupon may include a location associated with a coupon printing device. Similarly, a user might provide an identifier of the user using a coupon printing device. Control is passed to operation 2925 and process 2900 continues.

In operation 2925, a coupon is printed. A printed coupon may include any information which may be used to indicate that an accommodation is to be provided to a user. A coupon may include verification information, may include machine readable information, and/or may include any features which may be provided by the coupon printing device. Control is passed to operation 2930 and process 2900 continues.

In operation 2930, information of the process 2900 is recorded. In at least one embodiment, the database 2220 (FIG. 22) is updated to include information of an advertisement, an advertiser, a user, a merchant, a coupon printing device, and/or ratings of an item. For example, a rating of a user may be adjusted based on usage of a coupon, etc. In at least one embodiment, information of use of a coupon may be provided by a merchant to measure efficacy and ‘breakage’ or unredeemed coupons which were printed but not actually redeemed. Control is passed to operation 2905 and process 2900 continues.

An exemplary sequence of messages which may cause a coupon to be printed responsive to a request from a mobile device is illustrated in FIG. 30. While a specific example of text or SMS messaging is used for the purposes of illustration, no limitation is implied thereby. Any type of communication service may be used to deliver an advertisement and cause a coupon to be printed.

A user device 3000 may transmit an information request message 3005. The information request message 3005 may be routed via a wireless carrier system 3040 to a publisher system 3020. The publisher system 3020 may respond with an advertising message 3010. The advertising message 3010 may include an indicator regarding how a printed coupon for an accommodation may be obtained. For example, the keyword ‘mac5’ may be provided in a coupon print request message 3015 to indicate the desire to print a coupon. The user device 3000 may subsequently respond with the coupon print request message 3015. The publisher system 3020 may confirm the accommodation, and may identify a coupon device 3025 which may be associated with a merchant 3035 who may redeem a printed coupon 3030. The publisher system 3020 may transmit a message to the coupon device 3025, which may respond by producing the printed coupon 3030. The printed coupon 3030 may be provided to a merchant 3035 who may provide an accommodation to a user associated with the user device 3000. In at least one embodiment, a user may be able to provide verification information to a merchant, such as the last 4 digits of a phone number in order that a coupon may be redeemed. In at least one embodiment, a message is transmitted to the user device 3000 which includes a verification code which may be used to verify ownership of a coupon by a user associated with the user device 3000.

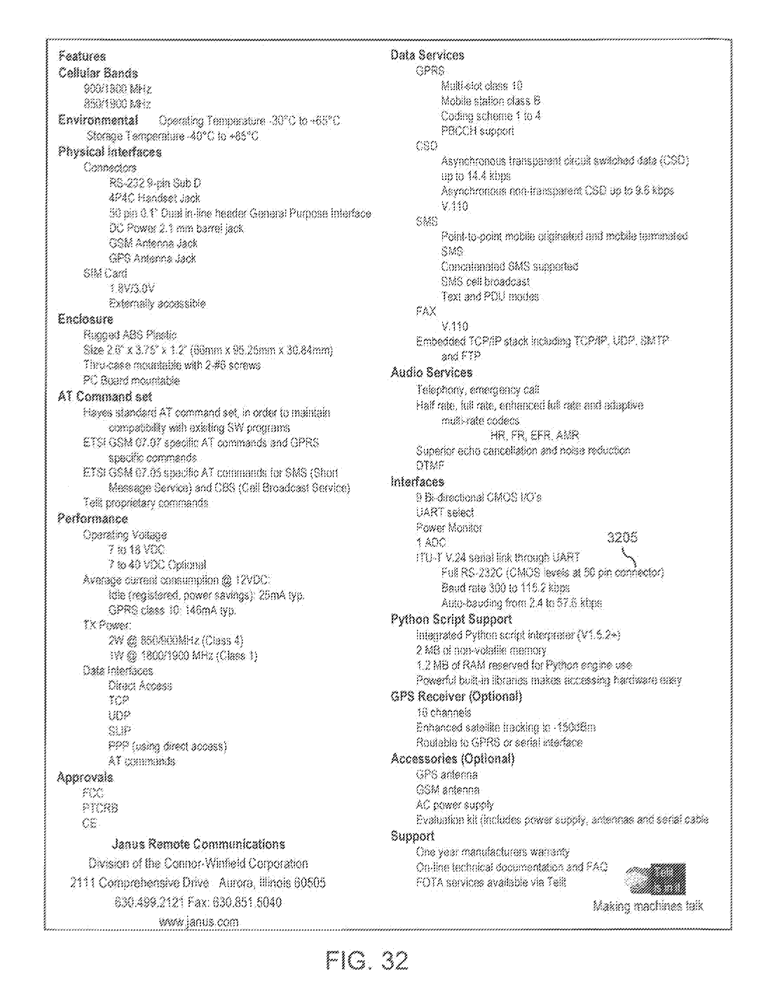

A specification sheet for a typical wireless GSM terminal modem (Telit model GSM 864Q) is provided in FIG. 31 and FIG. 32. As described with respect to FIG. 23, a terminal modem includes a GSM antenna, receiver transmitter, processor, etc. In addition, the terminal modem includes a software stack or group of software routines which allow access to the various hardware features of the device. In particular, the software is able to implement functions such as sending and receiving SMS messages as well as data (e.g., GPRS) using the wireless interface. A terminal modem may operate in a standardized OS such as the Microsoft Windows® operating system which may allow portability of application software to other devices.

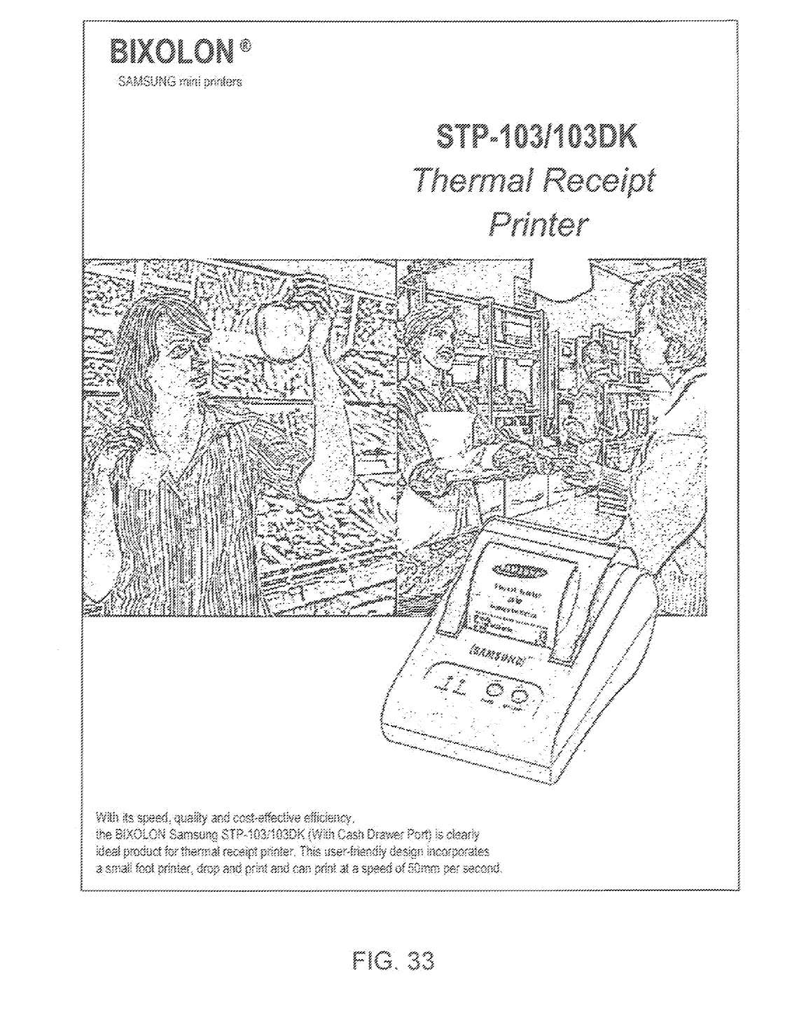

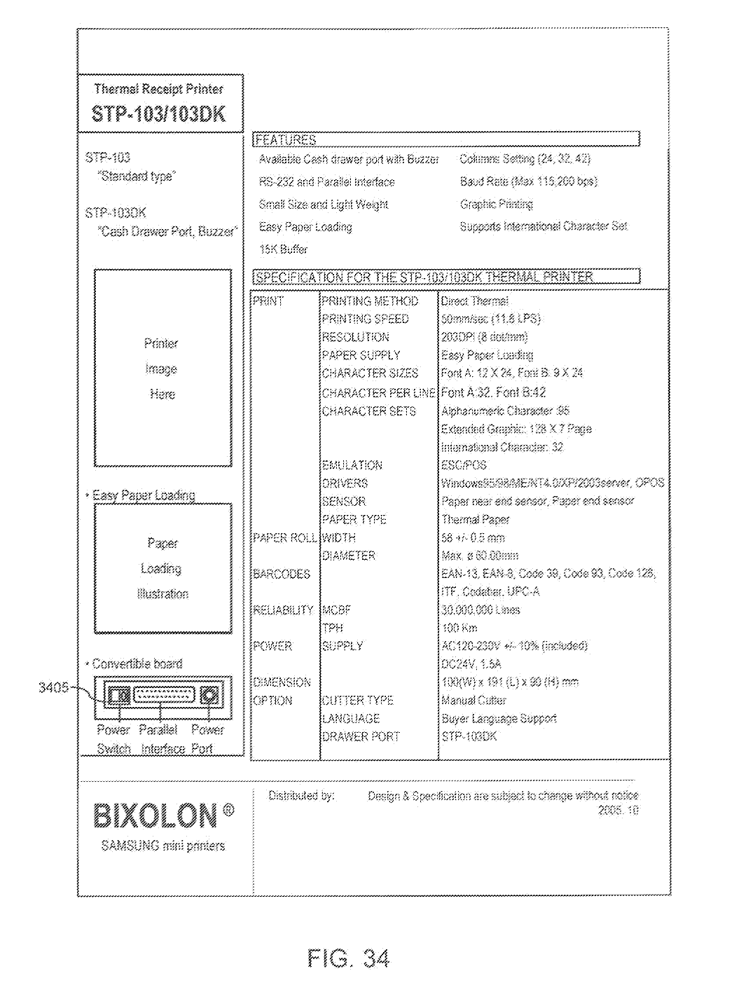

A specification for a stand-alone RS232 compatible receipt sized printer (Samsung model STP-103PG) is provided in FIG. 33 and FIG. 34. The receipt printer is able to produce coupons via an RS232C command from the terminal modem. A simple hardware connection is established using a 50pin connection output 3205 (FIG. 32) from the GSM terminal to a convertible board 3405 (FIG. 34) of the printer. As previously noted, the printer is able to print various barcode formats which may be useful to a merchant. As the coupon printing device is a stand alone unit, there is no system integration required for a merchant to adopt the coupon distribution system. Printed coupons or other information from the coupon printing device may be used in the same manner as similar materials which are delivered by conventional print media without requiring a user or a merchant to take any new actions.

In at least one embodiment, behavior of the coupon printing device 2235 (FIG. 22) may be modified based on commands received from a wireless and/or wired connection. A command requesting a modification may be sent by SMS formatted messages, and/or by GPRS or IP connection. In at least one embodiment, the coupon printing device may obtain and/or receive information from a server associated with the search system 2230. Use of SMS messaging may allow behavior of the coupon printing device 2235 to be modified using a few lines of text. For example, it may be possible to send an SMS message using a wireless device such as the user system 2205 in order to perform a variety of operations. Commands might be implemented to check that power is on, perform a device reset, clear and/or read error messages, change a format of a printed message and/or offer, modify content of a stored document, obtain location information, determine remaining credit in a SIM card, etc.

A list of exemplary commands and command formats is attached hereto as Appendix A.

The coupon printing device 2235 may include security features. For example, an originating phone number obtained from caller ID (CID) information may be used to determine whether a command received is to be executed. A password may be required in order to modify content of a coupon and/or other document, or execute other commands. In at least one embodiment, different access rights may be associated with different originating addresses. The coupon printing device 2235 may include user controls, which may be used to provide response information. For example, a keypad, touchpad, scanner, camera, etc., might be used as an input device. A response may be used for purposes such as security, fraud prevention, etc. Further, while specific elements are described herein, the present invention is not limited to any specific type of device or elements of a device. For example, any device that is configured to process information received from a user and identify product/service offered by a business in association with the user may be used.

Using the method and systems disclosed herein, a mobile coupon distribution system may be realized. A coupon may be provided in a paper format using a printing device which is located at place of business of a merchant that has agreed to accept the coupon. A user may request a coupon using a mobile device, and/or other user device. Information regarding how a coupon may be obtained may be received and/or stored in a user device. If a user elects to redeem a coupon, the user may send a message to a publisher system, which may respond by causing a coupon printing device to print a coupon. As a printed coupon is provided, existing infrastructure of a merchant for processing an accommodation associated with a coupon may be utilized with limited disruption.

While electronic coupons have received acceptance in a transaction system based on electronic purchasing, such ‘virtual’ coupons have met with limited acceptance by users and merchants due to various factors such as traceability and ease of use. The methods and systems described herein overcome these limitations. A coupon may be provided with the immediacy of an electronic coupon, but with the convenience, traceability and ease of processing for a merchant which are associated with conventional printed coupons.

A merchant receives the benefits of greater revenue, increased adoption of a new service or product, and minimal investment in new equipment to utilize the system. An advertiser is able to increase distribution of advertising, improve traceability and measurement of advertising materials, and avoid wasted resources and expense on coupons which are distributed, but not utilized.

A method and system are provided herein to implement an operation including analyzing a request, providing a search tool selected from among available tools to a human, searcher registered for a category of the request, and conducting a search by the human search via the search tool provided.

Any or all of the operations described herein may be implemented via one or more hardware components. However, the present invention is not limited to any specific implementation of an operation. For example, one or more operations discussed herein may be implemented via software executed on a device while others may be executed via a specific hardware device.

The present invention may be implemented using a program stored, for example, in a persistent computer-readable storage medium such as a CD-ROM, etc., or using one or more specialized terminals, devices or systems that is enabled to execute operation(s) described herein. The storage or recording medium used in an embodiment can be selected from among various computer-readable media including, a disk, a DVD, an internal storage device (memory such as RAM or ROM) in a computer, etc.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

### APPENDIX A

### Firmware User Interface Definition

Note: The space character between information units in the command format must be included

### 1. Format for Messages

MSG xxxx nnnn 02-01 other message . . .

MSG: header for the message (case insensitive)

xxxx: is the four-digit coupon ID to indicate different type of coupons from store

nnnn: is the four-digit user ID (last four digits of the phone number of an authorized user), which will be shown on the coupon

02-01: 02=total pages for this message, 01=the index for this page. 01-01 must be used, if there is only one SMS message for the coupon

Note: The SMS message must be separated manually if the message is long. The total number of characters, including the format information for the message, must be less than 160.

### 2. Format for Commands

CMD:username: pwd: command:parameter

CMD: header for command (case insensitive)

username: user name (case sensitive)

pwd: password (case sensitive)

Command: command to send

Parameter: parameter for the command if it is necessary.

Note: the symbol“:” must be used to separate the different information units in a command message.

### Available Commands:

a) Ping

Usage:

Cmd:chacha:chacha:ping

Description

Ping the device. A message will be sent back to the sender by the device

Return message:

DeviceName: the phone number for the SIM of the device

### Status: on

Note: no message will be returned if the device is off

### b) Set

Usage:

Cmd:chacha:chacha:set:xxxx=mmmm
xxxx: is the parameter to be set. (parameters which may be set are: line1, line2, line3, splitter1, splitter2, splitter3, splitter4, disclaimer)
mmmm: is the value of the parameter

Example

Cmd:chacha:chacha:set:line1=Hello world
This will change the value of the text for the first line of the coupon printed to ‘Hello world’
Return message: N/A

What is claimed is:

1. A method of responding to a request, comprising:
receiving a request;
providing a search tool associated with a category of the request to a human searcher registered for the category;
performing a search of a resource selected for the category responsive to activation of the search tool; and
automatically formatting a response chosen by the human searcher from the resource.

2. The method of claim 1, comprising:
performing the search of the resource prior to the providing.

3. The method of claim 1, comprising:
determining a type of said formatting for the response based on the category; and
selecting by the human searcher an address to receive a search query.

4. The method of claim 1, comprising:
modifying the category by the human searcher; and
updating the search tool based on the modified category.

5. The method of claim 1, comprising:
providing an indicator of an item associated with the request; and
transferring content of the request associated with the indicator to a query submission feature responsive to activation of the indicator.

6. The method of claim 1, comprising:
providing in the search tool an indicator which displays a search result obtained by application of an alternate search algorithm to the resource when activated.

7. The method of claim 1, comprising:
selecting a plurality of search engines; and
providing an action control which submits a query to a plurality of search engines simultaneously when activated.

8. The method of claim 1, comprising:
providing to the human searcher information received responsive to a search query in a custom format defined by the human searcher.

9. The method of claim 1, comprising:
receiving from the human searcher an indication of a search result; and
storing a modified version of the content including the search result including a pointer to the indicated result.

10. The method of claim 1, comprising:
performing a search of the resource prior to the providing;
determining a type of said formatting for the response based on the category;
modifying by the human searcher the category for the request;
updating the search tool based on the modified category;
providing an indicator of an item associated with the request;
transferring content of the request associated with the indicator to a query submission feature responsive to activation of the indicator;
providing in the search tool an indicator which displays a search result obtained by application of an alternate search algorithm to the resource when activated;
selecting a plurality of search engines;
providing an action control which submits a query to a plurality of search engines simultaneously when activated;
searching for the item in content displayed in the search tool responsive to activation of the indicator;
receiving from the human searcher a selection of the resource; and
selectively removing elements of content received from the resource when rendering the content for the human searcher.

11. A search assistance system, comprising:
a search system receiving information of a request, selecting a human assistant, delivering an interface to the assistant, and providing a response;
a user system submitting the request;
a searcher system selecting a search result; and
a search tool system performing a search using selected resources and providing search results to the searcher system.

12. The system of claim 11, comprising:
an interface provided to the searcher system including a control activating a search of a resource among said selected resources using a plurality of search algorithms simultaneously; and
an extension to an application operative on the searcher system providing access to information of the request and a user.

13. A persistent computer readable medium storing therein a program for causing a computer to execute an operation including providing assistance to a searcher responding to a request, comprising:
receiving a query;
automatically assigning a class to the query;
submitting the query to a resource identified by the class; and
providing a response from the resource to a guide registered for the class.

14. The computer readable medium of claim 13, comprising:
ranking the resource for the class; and
providing the response when the resource ranking is higher than a predetermined value.

15. The computer readable medium of claim 13, comprising:
associating a search algorithm with a viewing control;
associating the search algorithm with the class;
executing the search algorithm when the class is associated with the query; and
displaying a result of the search algorithm when the viewing control is active.

16. The computer readable medium of claim 15, comprising:
grouping a search algorithm with a viewing control;
associating the search algorithm with the class;
executing the search algorithm when the class is associated with the query; and
presenting a result of the search algorithm when the viewing control is active.

17. The computer readable medium of claim 13, comprising:
linking a presentation format with the guide; and
modifying the response based on the presentation format.

18. The computer readable medium of claim 13, comprising:
receiving from the guide a selection of media indicated in the response;
determining a location associated with the media; and
providing the media and the location as a search result.

19. The computer readable medium of claim 13, comprising:
connecting a location with the query;
including a map in the response based on the location; and
adapting the query in accordance with the class and the location.

20. The computer readable medium of claim 13, comprising:
selecting an offer to be delivered responsive to the query;
delivering the offer to a user submitting the query;
choosing a printing device associated with the offer;
creating a verification code for the user; and
producing by the printing device a hard copy of the offer when the verification code is provided.
